(19) United States
(12) Patent Application Publication
(10) Pub. No.: US 2026/0166815 A1
(43) Pub. Date: Jun. 18, 2026

(54) System and Method of Automated Product Geometric Quality Qualification in 3D Printing

(71) Applicant: University of Southern California, Los Angeles, CA (US)

(72) Inventors: Weizhi Lin, Los Angeles, CA (US); Qiang Huang, Los Angeles, CA (US)

(21) Appl. No.: 19/363,635

(22) Filed: Oct. 20, 2025

Related U.S. Application Data
(60) Provisional application No. 63/709,157, filed on Oct. 18, 2024.
(60) Provisional application No. 63/709,170, filed on Oct. 18, 2024.

(51) Int. Cl. B29C 64/386; B33Y 50/00; G06F 30/20; G06F 113/10

(52) U.S. Cl. CPC B29C 64/386; B33Y 50/00; G06F 30/20; G06F 2113/10

(57) ABSTRACT

To enhance shape accuracy qualification, an Automated Intrinsic Non-rigid Registration method places high-curvature regions within segments. A curvature-informed surface point clustering technique allows for automated segmentation. A Teichmuller map is adopted to achieve the segment-wise non-rigid registration, determining the uniquely optimal and intrinsic transformation between surface points. The methodology has been validated through simulations and case studies.

### CROSS REFERENCE TO RELATED APPLICATIONS

This application claims priority to and incorporates by reference U.S. Provisional Patent Application Ser. No. 63/709,157 filed on Oct. 18, 2025 and U.S. Provisional Patent Application Ser. No. 63/709,170 also filed on Oct. 18, 2025.

### STATEMENT OF GOVERNMENT INTEREST

None

### BACKGROUND

The qualification of geometric quality of three-dimensional (3D) products is critical to ensure product functionality and proper fit (Ge et al., 1992; Zhao and del Castillo, 2021; Scimone et al., 2022). It is typically achieved by identifying the discrepancy or similarity between the actual product geometry SA and its intended design SD and assessing compliance with design specifications. The discrepancy between SD and SA can be modeled by a function (Biasotti et al., 2016) shown as Formula 1, FIG. 15, where a region of interest or a physical portion of SD,A will first be selected through PSD,A=SD,A I {sEUiPi} (Zhang et al., 2004), and quality characteristics of the selected region PSD,A will be extracted through representation function R(·). The discrepancy function d(·) measures the deviation of the quality characteristics from their target values.

A selected region PSDA with context-dependent semantic meaning is commonly referred to as geometric feature (Shah and Mantyla, 1995). The frequently encountered features such as cylinder, hole, and protrusion constitute a feature library for solid modelling and 3D object representation (Sunil and Pande, 2008). R (.) usually extracts dimensional or form characteristics of geometric features (Shah and Mantyla, 1995; Savio et al., 2007).

The feature quality is assessed by comparing the discrepancy d (R(PSD), R(PSA)) to the geometric dimensioning and tolerancing (GD&T) requirements, as illustrated in FIG. 3 (top row). The feature-based representation and extraction approach lacks the descriptive capability for complex freeform geometries such as custom medical implants or products with ergonomic and aesthetic considerations (Bermano et al., 2017). An infinite number of geometric features or feature groups are required to capture shape complexity.

To accommodate complex geometries, surface patches have been utilized for region PSD,A selection and representation (Zhang et al., 2004; Savio et al., 2007). Patches are typically identified in design stage for their fit or functionality, often on a case-by-case basis, e.g., turbine blade airfoil. Rather than simple dimensional or form characteristics used for geometric features, R(·) for surface patches PSD,A has to use patch profiles as quality characteristics for qualification. Patch profiles can adopt non-parametric functional forms such as Non-Uniform Rational B-Splines (NURBS) (Zhang et al., 2004) and kernels (Zang and Qiu, 2018), parametric functions (Varady et al., 1997; Yan et al., 2012; del Castillo et al., 2015; Huang et al., 2020), or predefined patch templates with specific geometries (Gupta and Gurumoorthy, 2012). The patch quality can be assessed by checking whether R(Pi) falls within the specified envelope (Luo et al., 2018). Despite its flexibility of representing 3D objects, surface patch qualification still faces the fundamental issue of potentially infinite types of surface patches. It can be tedious and labor-intensive to specify and qualify surface patches for products with frequent design changes, for example, in one-off 3D printing.

### SUMMARY

Certain embodiments of this disclosure are directed to extracting surface patches from either a design file or a scanned image of a 3D object that will be printed or manufactured with corresponding machinery, including but not limited to, a three-dimensional (3D) printer. One nonlimiting embodiment encompasses a computer implemented method of electronically modeling a surface of an object with a plurality of virtual surface patches. The virtual surface patches collectively present surfaces to be printed or manufactured for a desired portion or the entirety of a real life, 3D object.

In one non-limiting embodiment, a computer implemented method assesses accuracy of a three-dimensional (3D) print from a design file representing the 3D print. The method includes identifying geometric feature correspondences between the 3D print and the design file by utilizing a computer with a processor to implement software steps beginning with representing the 3D print and the design file in a respective actual print digital mesh and a design digital mesh. The method includes parsing the design digital mesh into respective sets of tentative segments having tentative boundaries and determining respective centers of the tentative segments. The method then defines the tentative boundaries of the tentative segments by incorporating respective regions of high curvature along surfaces of the respective meshes, wherein the tentative boundaries meet a density threshold of vertices on the surface. Design segments are determined by modifying the tentative boundaries to encompass circular boundaries with a geodesic radius that minimizes a sum of distances between points within the tentative boundaries to a respective center of a respective tentative segment and locating corresponding segments in the actual print digital mesh. The method defines print boundaries with the geodesic radius from the circular boundaries. The quality and accuracy of the print may be confirmed by calculating diffeomorphisms between the design segments and the corresponding segments on the actual print digital mesh to complete non-rigid registration between the actual print digital mesh and the design digital mesh. This allows for identifying deviations between the digital meshes by calculating a dissimilarity metric between the meshes.

### BRIEF DESCRIPTION OF THE FIGURES

FIG. 1 is a schematic view of an overall technology map for the autonomous product qualification and quality control system.

FIG. 2 is a schematic view of a computer environment in which the systems and methods of this disclosure operate to achieve the described embodiments.

FIG. 3 is an illustration of the qualification of shape quality for (1) a simple geometry (top row) using dimensional characteristics, and (2) a complex shape (bottom row) characterized by profile data. The color denotes the point-to-point distances between the design and the actual product.

FIG. 4 is a distribution of selected φ on a dental surface. From the left to right, the first and the second plots showing the distribution of K and H, colors denote positive and negative curvature values, respectively. The curvature values have been scaled to [−1, 1] for visibility. The third and forth plots indicate the angles, with the colors denoting φ∈[0, π/2] and θ∈[0, 2π].

FIG. 5 is a distribution of Δφ on a dental surface. The color indicates the magnitude of Δφ, characterizing the smoothness of φ.

FIG. 6 shows the sequential patch extraction to automatically identify distinct deviation patterns. The bottom row presents the deviation functions characterizing the patch deviation patterns on the extracted surface patches, which will be elaborated herein.

FIG. 7 is an illustration of the changepoint detection process to determine patch size by expanding the region from centroid.

FIG. 8 shows examples of WKS, Gaussian, and mean curvature signals of different surface patches.

FIG. 9 shows the process of constructing deviation functions on freeform surfaces. φ·: S→DD⊂C is a conformal map that flatten the freeform surface into canonical 2D domain. The h:=φ2∘g∘φ−1 1:DD→DA is a T-map.

FIG. 10 shows examples of deviation functions and their characteristics ζ(1) of different surface patches on a dental model.

FIG. 11 shows extracted surface patches on the tested shapes.

FIG. 12 illustrates clustering of surface patches. (a) The representative surface patches of the clustered 11 groups. The color denotes the mean curvature on them. (b) The MDS results based on the geometric dissimilarity among surface patches. The surface patches from new shapes are also assigned to the clusters.

FIG. 13 shows deviations on the surface manifolds are indicated by color. Red denotes areas where the mean curvature of the actual print is larger than that of the design, while blue indicates areas with lower mean curvature values. The curvature values have been scaled to the range [−1, 1] for enhanced visibility.

FIG. 14 shows a CH index of measuring the disparity of the deviation functions when the clusters are formed by K-means.

FIG. 15 illustrates formulas that may be implemented by a computer according to this disclosure.

FIG. 16 illustrates formulas that may be implemented by a computer according to this disclosure.

FIG. 17 illustrates formulas that may be implemented by a computer according to this disclosure.

FIG. 18 illustrates formulas that may be implemented by a computer according to this disclosure.

FIG. 19 illustrates formulas that may be implemented by a computer according to this disclosure.

FIG. 20 illustrates formulas that may be implemented by a computer according to this disclosure.

FIG. 21 illustrates formulas that may be implemented by a computer according to this disclosure.

FIG. 22 illustrates formulas that may be implemented by a computer according to this disclosure.

FIG. 23 illustrates formulas that may be implemented by a computer according to this disclosure.

FIG. 24 illustrates formulas that may be implemented by a computer according to this disclosure.

FIG. 25 illustrates formulas that may be implemented by a computer according to this disclosure.

FIG. 26 illustrates formulas that may be implemented by a computer according to this disclosure.

FIG. 27 illustrates formulas that may be implemented by a computer according to this disclosure.

FIG. 28 illustrates formulas that may be implemented by a computer according to this disclosure.

FIG. 29 illustrates formulas that may be implemented by a computer according to this disclosure.

FIG. 30 illustrates formulas that may be implemented by a computer according to this disclosure.

FIG. 31 illustrates formulas that may be implemented by a computer according to this disclosure.

FIG. 32 illustrates Table 1 according to this disclosure.

FIG. 33 includes at (a1-a3) an illustration of the challenges in aligning two curves with complex geometries and geometric deviation. The left peaks, with larger deviations, tend to align better due to the iterative nature of registration algorithms. (b) Illustration of an intrinsic registration framework (Color: mean curvatures). φ1,2 are the conformal maps that flatten the 3D shapes into canonical 2D domains. h is the diffeomorphism between the parameterized 2D domains and g is the final registration transformation between the 3D shapes.

FIG. 34 shows the proposed ANIR method for accuracy qualification of freeform shapes.

FIG. 35 is an illustration of conformality distortion determined by the Beltrami coefficient, adopted from (Lui et al., 2014).

FIG. 36 illustrates shapes with manually imposed deviations. Colors represent changes in point-wise mean curvature.

FIG. 37 is an illustration of a simulation experimental setup.

FIG. 38 shows at (a1-a4) the surface deviations characterized using non-rigid registration methods based on different shape segmentation techniques. (b1-2) Comparison of MARE and FPR on both shapes with different segmentation methods. (c1-2) MARE results from experiments on each sample shape.

FIG. 39 shows the characterized deviations on the three dental models using the proposed registration method. (Color: deviations)

FIG. 40 shows examples of manually selected landmarks (denoted as red dots) on the design and actual printed shapes of Shape 1. (Color: mean curvature)

FIG. 41 shows the errors between the characterized deviations from automated non-rigid registration and the ground truth at manually selected corresponding landmarks.

FIG. 42 illustrates formulas that may be implemented by a computer according to this disclosure.

FIG. 43 illustrates formulas that may be implemented by a computer according to this disclosure.

FIG. 44 illustrates formulas that may be implemented by a computer according to this disclosure.

FIG. 45 illustrates formulas that may be implemented by a computer according to this disclosure.

FIG. 46 illustrates formulas that may be implemented by a computer according to this disclosure.

FIG. 47 illustrates formulas that may be implemented by a computer according to this disclosure.

FIG. 48 shows the pipeline of the proposed landmark selection method.

FIG. 49A shows distance metrics as applied to a curved surface.

FIG. 49B shows distance metrics in segmentation using Euclidean distance.

FIG. 49C shows distance metrics in segmentation using Geodesic distance.

FIG. 50A shows the correlation between δc and corresponding Var (δ).

FIG. 50B shows δc implact on a decision graph according to this disclosure.

FIG. 50C shows δc implact on a decision graph according to this disclosure.

FIG. 50D shows δc implact on a decision graph according to this disclosure.

FIG. 51A shows a comparison of different types of curvature on a teeth model. High positive and negative curvature values are indicated by the red and blue colors, respectively.

FIG. 51B shows a comparison of different types of curvature on a teeth model. High positive and negative curvature values are indicated by the red and blue colors, respectively.

FIG. 52 shows a process of assessing the effectiveness of landmarking.

FIG. 53A illustrates segmentation results on a first of eight dental models of this disclosure with the model having 11 segments.

FIG. 53B illustrates segmentation results on a second of eight dental models of this disclosure with the model having 10 segments.

FIG. 53C illustrates segmentation results on a third of eight dental models of this disclosure with the model having 11 segments.

FIG. 53D illustrates segmentation results on a fourth of eight dental models of this disclosure with the model having 8 segments.

FIG. 53E illustrates segmentation results on a fifth of eight dental models of this disclosure with the model having 12 segments.

FIG. 53F illustrates segmentation results on a sixth of eight dental models of this disclosure with the model having 6 segments.

FIG. 53G illustrates segmentation results on a seventh of eight dental models of this disclosure with the model having 7 segments.

FIG. 53H illustrates segmentation results on an eighth of eight dental models of this disclosure with the model having 6 segments.

FIG. 54A illustrates SegGP landmarking results on a first of eight dental models of this disclosure with the model having 11 segments and 125 landmarks.

FIG. 54B illustrates SegGP landmarking results on a second of eight dental models of this disclosure with the model having 10 segments and 110 landmarks.

FIG. 54C illustrates SegGP landmarking results on a third of eight dental models of this disclosure with the model having 11 segments and 115 landmarks.

FIG. 54D illustrates SegGP landmarking results on a fourth of eight dental models of this disclosure with the model having 8 segments and 121 landmarks.

FIG. 54E illustrates SegGP landmarking results on a fifth of eight dental models of this disclosure with the model having 12 segments and 124 landmarks.

FIG. 54F illustrates SegGP landmarking results on a sixth of eight dental models of this disclosure with the model having 6 segments and 57 landmarks.

FIG. 54G illustrates SegGP landmarking results on a seventh of eight dental models of this disclosure with the model having 7 segments and 62 landmarks.

FIG. 54H illustrates SegGP landmarking results on an eighth of eight dental models of this disclosure with the model having 6 segments and 58 landmarks.

FIG. 55 illustrates comparisons of a dental model selected by (a) SegGP, (b) GP, and (c) FPS, all with 57 landmarks.

FIG. 56A illustrates landmarks on a dental model selected by (a) SegGP of FIG. 55 with 57 landmarks.

FIG. 56B illustrates landmarks on a dental model selected by (b) GP of FIG. 55 with 57 landmarks.

FIG. 56C illustrates landmarks on a dental model selected by (c) FPS of FIG. 55 with 57 landmarks.

FIG. 57 illustrates formulas that may be implemented by a computer according to this disclosure.

FIG. 58 illustrates formulas that may be implemented by a computer according to this disclosure.

FIG. 59 illustrates formulas that may be implemented by a computer according to this disclosure.

FIG. 60 illustrates formulas that may be implemented by a computer according to this disclosure.

FIG. 61 illustrates formulas that may be implemented by a computer according to this disclosure.

FIG. 62 illustrates formulas that may be implemented by a computer according to this disclosure.

FIG. 63 illustrates formulas that may be implemented by a computer according to this disclosure.

FIG. 64 illustrates formulas that may be implemented by a computer according to this disclosure.

FIG. 65 is a Table 1 according to this disclosure.

### DETAILED DESCRIPTION

One non-limiting goal of this work is to develop a methodology to automatically extract surface patches from freeform designs for fast product qualification in low-volume production such as three-dimensional (“3D”) printing. Without limiting this disclosure to any particular scope, a surface patch is a region, shown in either a two dimensional or three-dimensional digital representation of a real world, 3D object and that has a corresponding region on the actual 3D object. The term “surface patch” includes a broadest plain meaning as used as a term of art in the technology of manufacturing and 3D printing. Identifying the number of and boundaries for surface patches that collectively define an object surface is a non-trivial matter.

This work addresses complexities of using surface patches to model a 3D object for printing and manufacturing through new surface patch characterization for dimension reduction in the calculation processes, automated surface patch extraction, and validity verification for new designs. Surface patch extraction is automated by identifying critical points as patch centroids through active landmark selection, and determining boundaries through a changepoint detection formulation. In fact, this disclosure sets the ground work for entirely automated patch extraction from a scan or design file of a 3D object. The work proposes to characterize and extract surface patches based on geometric descriptors indicative of surface patch deviation patterns. The surface patches are extracted by clustering, or grouping, surface points shown in the digital representation of the 3D object when the surface points have similar values of selected geometric descriptors. The centroids of surface patches are sequentially identified through an active landmark selection approach. The centroids are determined by local extrema of the selected geometric descriptors and geometric centers of surface points.

In embodiments of this disclosure, a computer can be used to iteratively determine the boundaries of surface patches that collectively define an area on a surface of a 3D object when the boundaries are mated. Once a centroid of a tentative surface patch has been identified, the computerized system and methods of this disclosure implement steps by which the surface patches will then grow around the centroids until changes in patch smoothness measurements are detected, where patch smoothness is measured by the Laplacian-Beltrami (LB) operator. The sizes and boundaries of surface patches can therefore be automatically determined by a proposed changepoint detection formulation. Systems and methods of this work capture different deviation patterns, select geometric descriptors indicative of these patterns, and use their smoothness to characterize the patches. The system and method select both the intrinsic geometric descriptor Gaussian curvature K and extrinsic geometric descriptors of mean curvature H and surface norm. Details include clustering surface points into respective surface patches with a computer implemented algorithm based on the categorization criteria being evaluated in an iterative process.

This disclosure and related works first identify surface patches based on the existence of critical points. Critical points identify the local extrema of the curvature and are first selected to serve as the patch centroids. Then, the centroids of patches without critical points, such as planar regions, are identified as the geometric centers of regions with constant Δφ. These points are selected sequentially under an active landmark selection framework to adapt to frequent design changes.

To ensure the surface patches have homogeneous smoothness of q, the system and method adapt the region-growing method to gradually expand the surface patch from the identified centroid at each step. This expansion is automatically terminated by detecting changes in the smoothness of q in the added region of surface points. Subsequent potential surface patches are determined by maximizing the distances between themselves and the previously selected patches. After identifying all the surface patches containing critical points, the next stage involves identifying smooth surface patches without critical points. Aims to identify smooth surface regions without critical points. Unlike in the first stage, the centroids of these patches typically have curvature values close to zero. Stopping criterion for the first stage is determined by a prespecified number ‘n’ of consecutive failures to add new patches.

Certain embodiments of this disclosure are directed to extracting surface patches from either a design file or a scanned image of a 3D object that will be printed or manufactured with corresponding machinery, including but not limited to, a three-dimensional (3D) printer. One non-limiting embodiment encompasses a computer implemented method of electronically modeling a surface of an object with a plurality of virtual surface patches. The virtual surface patches collectively present surfaces to be printed or manufactured for a desired portion or the entirety of a real life, 3D object. An initial step of the computer implemented method includes assigning a plurality of geometric descriptors to the object. Assigning the geometric descriptors includes using a Gaussian curvature K, mean curvature H, and surface normals for the surface of the object. The geometric descriptors of the object are implemented in software stored in memory of a computer and allow the computer to evaluate smoothness of respective groups of surface points on a surface of the object. The term “smoothness” of this disclosure is used in its broadest plain meaning sense. Without limiting the breadth of the term “smoothness,” one description of the word “smoothness” includes the rate of change of a geometric attribute within local regions around each surface point, such as point curvature or surface normals on the object. The method continues by using a processor having access to the memory of the computer to identify the respective groups of surface points as bounded surface patches.

Identifying the bounded surface patches includes identifying critical points across the surface of the object as local extremes of curvature on the surface and using the critical points as geometric centers of potential surface patches to be evaluated by the software. In other words, implementations of this disclosure can iteratively locate geometric centers and test a region of the virtual model to determine if a certain region should be considered a distinct, new surface patch that will be part of the final set of surface patches (called bounded surface patches herein) that collectively define the 3D object in real space. In some embodiments described herein, the system and method identify and use critical points as geometric centers. This process iteratively locates sequential geometric centers for subsequent potential surface patches by maximizing a distance between a respectively sequential geometric center and all points of the bounded surface patches. Maximizing the distance involves selecting the point with the highest Gaussian curvature (\varphi_1) and the greatest curvature-weighted distance from the surface points on the selected patches as the geometric center.

The method continues by adding new surface points to each respective potential surface patch by evaluating neighboring surface points relative to a respective geometric center. For each round of testing a surface points within a potential surface patch, the method continues to add the new surface points to the respective potential surface patch until neighboring surface points indicate changes in smoothness according to the geometric descriptors. The changes of smoothness are measured with a Laplacian-Beltrami (LB) operator. Measuring changes of smoothness with the LB operator includes calculating a rate at which a function defining the surface spreads out from the surface points. In one non-limiting embodiment, the function defining the surface is modeled as a triangle mesh and the LB is calculated as the function's value at a point on the mesh relative to a local average of the function surrounding the point on the mesh.

The changes in smoothness define corresponding perimeters of the bounded surface patches. In other words, upon identifying changes in smoothness in surface points that progressively extend around each of the geometric centers, the systems and methods of this disclosure can define perimeters of bounded surface patches, i.e., surface patches that are no longer just “potential surface patches” but are verified as distinct regions of the 3D object that should be printed and manufactured accordingly. Along these lines, the methods and systems of this disclosure include iteratively evaluating the groups of surface points for potential surface patches until the object has been modeled with bounded surface patches.

It logically follows that identifying the respective groups of surface points as bounded surface patches includes identifying mating perimeters of the bounded surface patches that collectively cover the entirety of the object. Perimeters of surface patches would be sufficiently complementary in shape to limit any voids in the collective assembly of surface patches defining the appropriate regions of a 3D object (or the entirety of the 3D object) and provide a proper mating tolerance to meet the requirements of the printing or manufacturing process.

The computer implemented method of deciding upon bounded surface patches further addresses flat regions that do not have critical points along their surfaces. Accordingly, the method identifies flat regions as groups of surface points with Gaussian curvature values that are approximately zero.

Additional embodiments of this disclosure are directed to establishing a library of surface patches in general for use in the artificial intelligence aspects of the research discussed herein. Once surface patches are identified for a 3D object according to the computer implemented method noted above, these surface patches can be added to a library of known surface patches for use in later manufacturing processes. More particularly, surface patches can be continually added to the library as more and more 3D objects are modeled with virtual surface patch technology. In non-limiting embodiments, the surface patches that are iteratively added to the library are grouped according to common features. In this way the library can be used to predict surface patch modeling parameters as the system learns the different kinds of surface patch shapes.

One non-limiting but basic assumption is that there are finite number of patch deviation patterns, and surface patches can be clustered into finite number of patch types for qualification. First, a finite number of surface patch types can be utilized to qualify existing and new designs. Second, region selection and quality characteristics representation are both based on patch deviation patterns. The consistency facilitates automation in qualification. To facilitate product qualification, this disclosure proposes to use Laplace-Beltrami (LB) operator and critical points to characterize surface patches and capture a finite number of patch deviation patterns. The methodology is verified by extracting surface patches from 3D printed freeform products and demonstrating that there are finite types of patch deviation patterns and surface patches for qualification.

To group surface patches, wave kernel signature and curvature signatures are adopted to quantify the geometric dissimilarity among patches. Deviations of complex surface patches are characterized as point-wise curvature changes for flexibility. To isolate effects of covariates within each patch type, the patch deviation patterns are characterized by a covariate-invariant descriptor for comparison and verification. This result shows the potential to infer the deviation patterns of a new design using the extracted finite types of surface patches.

This work, along with its system and methods, proposes to characterize and extract surface patches based on geometric descriptors indicative of patch deviation patterns. The advantage of the proposed patch characterization is two-fold. First, a finite number of surface patch types can be utilized to qualify existing and new designs. Second, region selection PS and quality characteristics representation R(PS) are both based on patch deviation patterns. The patch types are determined by clustering the extracted patches. We adopt wave kernel signatures and curvature signatures to measure the geometric dissimilarity among patches for clustering. Deviation patterns of each surface patch are characterized based on point-wise curvature changes in complex freeform products. To verify the patch deviation patterns, this disclosure proposes to construct a deviation signature to isolate the effects of printing covariates, including the printing location of the patches. Methods then proceed to evaluate the similarity of actual deviation patterns within each patch type. For example, surface smoothness measures use the Laplace-Beltrami (LB) operator to quantify surface smoothness and critical points to capture abrupt changes in selected geometric descriptors. The LB operator, denoted as A, is a generalization of the Laplacian operator in Euclidean space, which describes the rate at which a function spreads out from a point. The LB values can be intuitively understood as the difference between the function's value at a point and the local average of the function surrounding that point.

To group surface patches according to similarity in a library, the systems and methods herein capture different deviation patterns. This disclosure selects geometric descriptors indicative of these patterns and uses their smoothness to characterize the patches. The process is able to isolate the different deviation patterns associated with concave and convex geometries.

In this way, two surface patches belonging to the same group should have the same number of critical points and creases (if they are non-smooth surface patches). They should also have the same sign for curvature at every surface point. These properties describe the geometric structures that determine the major deviation patterns, as these structures influence the flow and distribution of material. The type of surface patches are specified by clustering the patches according to geometric dissimilarity, which is quantified based on wave kernel signatures, mean and Gaussian curvature signatures. The methods of this work utilize a new type of deviation function using point-wise differences in mean curvatures. The patch deviation patterns are also influenced by covariates such as the locations of the surface patches on the printing bed. The effect of a covariate would be reflected in function coefficients

This work, therefore, proposes a new deviation function to characterize the complex geometric distortions and allows for one to derive a descriptor to characterize the inherent structure of the deviation functions of patches, preserving features such as the maximum and minimum of the function, whose locations are invariant under covariates. This process enables evaluation of surface patches and their relevance to a given print job without knowing the exact functional forms and characteristics. The evaluation techniques used herein are independent of covariates such as patch size, printing location, and printing orientation.

One non-limiting goal of this disclosure is to derive a descriptor to characterize the inherent structure of the deviation functions of patches, preserving features such as the maximum and minimum of the function, whose locations are invariant under covariates with a deviation function that characterizes the changes in mean curvature at surface points.

A computer implemented method implemented herein also incorporates, therefore, using a computer, having a processor and computer readable memory storing surface patch analysis software, to perform steps including identifying geometric dissimilarity values among respective surface patches extracted from 3D objects, calculating surface patch deviation patterns from the geometric dissimilarity values; clustering the surface patches into a finite number of surface patch groupings exhibiting patch deviation patterns with categorization criteria that match within a tolerance threshold, and saving, in the computer readable memory, the surface patch groupings as distinct objects within a digital surface patch library. Identifying geometric dissimilarity values includes assigning a wave kernel signature to the respective surface patches and evaluating differences among the wave kernel signatures. Identifying geometric dissimilarity values further includes assigning a curvature signature to the respective surface patches and evaluating differences among the curvature signatures. Thus allows for calculating surface patch deviation patterns by calculating point-wise curvature changes in the respective surface patches. As noted above, one non-limiting goal of this disclosure lies in grouping surface patches from different modeling sequences for different 3D objects so that the groups are sufficiently similar. Mathematical and statistical analyses can then take advantage of the fact that there are a limited number of different surface patch shapes and parameters. With a limited number of surface patches in the universe of surface patch modeling, one can estimate 3D modeling techniques that allow machine language systems to predict how surface patches will likely be used together in modeling any 3D object.

In one non-limiting embodiment, clustering the surface patches into the proper groups within the surface patch library includes matching categorization criteria according to a number of critical points in a respective surface patch. Clustering the surface patches into groups may also include matching the categorization criteria according to a curvature sign at surface points. Clustering the surface patches may further incorporate matching the categorization criteria according to whether critical points in the surface patches are differentiable from a surface gradient or non-differentiable with surface points having no surface gradient. Overall, clustering the surface patches may include assigning differentiable critical points to a group with smooth surface patches and assigning non-differentiable surface patches to a group with non-smooth surface patches. One non-limiting goal in clustering the surface patches includes calculating, for the respective surface patches, a deviation function based on point-wise differences in mean curvatures across the respective surface patch.

Calculating the deviation function includes expressing the deviation function as a 2D deviation function that is invariant to covariates of the respective surfaced patches. The covariates under study here are patch size, printing location, and printing orientation, and the deviation function is invariant to these covariates. As 3D objects are continually modeled, printed, and/or otherwise manufactured, the universe of different surface patch shapes and parameters can be incorporated into the groups that are saved in the surface patch library. The groups converge because the categorization criteria for the surface patches in the group line up and match within a preferred degree of error. Clustering the surface patches according to categorization criteria may include calculating a Calinski-Harabasz Index (CH Index). As the groups approach a limit in terms of differentiation, the library stored in computer readable memory is more and more comprehensive. In some embodiments, the library may also include additional information about the surfaces patches in the group or the group overall because saving the surface patch groupings may also include saving metadata associated with each surface patch. Saving metadata may include saving printing outcome data as the surface patches are used in the actual printing and manufacturing process.

In this sense, systems and methods of this disclosure are also directed to AI functionality that the library of surface patches can bring to a printing or manufacturing process. A computer implemented method for printing 3D objects, therefore, may include accessing, with a computer having a processor and computer memory, surface patch groupings saved as distinct objects within a digital surface patch library, wherein the distinct objects include deviation functions corresponding to surface patches within the respective surface patch groupings. The method further includes comparing the surface patch groupings with sections of a printing design or a point cloud object for a respective 3D surface and assigning respective sections of the respective 3D surface to one of the surface patch groupings. For the respective sections, artificial intelligence may be trained for selecting a matched surface patch from an assigned surface patch grouping and iteratively selecting matched surface patches for the respective sections until an entirety of the respective 3D object is modeled with matched surface patches. After printing the 3D object according to the matched surface patches, the system may determine an accuracy measure for the 3D object as printed from the matched surface patches. Determining an accuracy measure may include registering a printed version of the 3D object with a design file of the 3D object to assess accuracy in the printing using matches surface patches. Determining an accuracy measure may incorporate registering a printed version of the 3D object with a design file of the 3D object to assess accuracy in the printing using matches surface patches and saving the accuracy measure associated with the printing in the memory of the computer.

Selecting a matched surface patch from the library can be automated by calculating a deviation function based on point-wise differences in mean curvatures across the respective sections of a model and selecting a matched surface patch from the library having a corresponding deviation function. This aspect of the disclosure is possible because the computer memory stores deviation functions for surface patches that model whole shapes of additional 3D objects and importing accuracy measures calculated after printing the additional 3D objects from matched surface patches. Accordingly, modeling and printing 3D objects may include iteratively saving respective accuracy measures for subsequent printings to develop a machine learning model to predict accuracy of printing over time. Along with iterative modeling and printing, the systems and methods herein may include training the machine learning model with updated deviation functions and additional accuracy measures with printing samples over time and generating, based on the machine learning model and design files, predictions for accuracy measures for prints from the design files as well as generating, based on the machine learning model and design files, predictions for deviation patterns in printed objects.

The qualification of geometric quality of three-dimensional (3D) products is critical to ensure product functionality and proper fit (Ge et al., 1992; Zhao and del Castillo, 2021; Scimone et al., 2022). It is typically achieved by identifying the discrepancy or similarity between the actual product geometry SA and its intended design SD and assessing compliance with design specifications. The discrepancy between SD and SA can be modeled by a function (Biasotti et al., 2016) shown as Formula 1, FIG. 15, where a region of interest or a physical portion of SD,A will first be selected through PSD,A=SD,A I{sEUiPi} (Zhang et al., 2004), and quality characteristics of the selected region PSD,A will be extracted through representation function R(·). The discrepancy function d(·) measures the deviation of the quality characteristics from their target values.

A selected region PSD,A with context-dependent semantic meaning is commonly referred to as geometric feature (Shah and Mantyla, 1995). The frequently encountered features such as cylinder, hole, and protrusion constitute a feature library for solid modelling and 3D object representation (Sunil and Pande, 2008). R(·) usually extracts dimensional or form characteristics of geometric features (Shah and Mantyla, 1995; Savio et al., 2007).

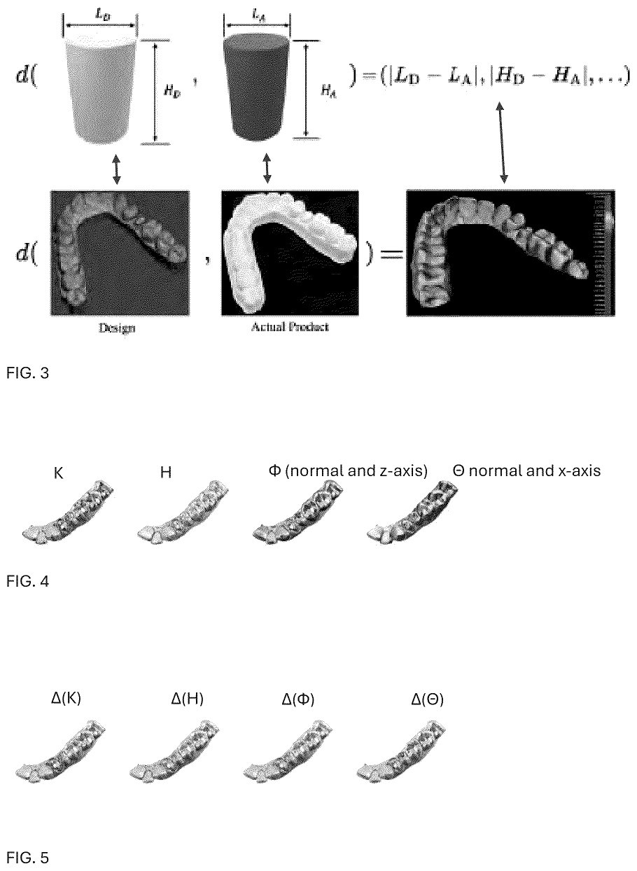

The feature quality is assessed by comparing the discrepancy d(R(PSD), R(PSA)) to the geometric dimensioning and tolerancing (GD&T) requirements, as illustrated in FIG. 3 (top row). The feature-based representation and extraction approach lacks the descriptive capability for complex freeform geometries such as custom medical implants or products with ergonomic and aesthetic considerations (Bermano et al., 2017). An infinite number of geometric features or feature groups are required to capture shape complexity.

To accommodate complex geometries, surface patches have been utilized for region PSD,A selection and representation (Zhang et al., 2004; Savio et al., 2007). Patches are typically identified in design stage for their fit or functionality, often on a case-by-case basis, e.g., turbine blade airfoil. Rather than simple dimensional or form characteristics used for geometric features, R (.) for surface patches PSD,A has to use patch profiles as quality characteristics for qualification.

Patch profiles can adopt non-parametric functional forms such as Non-Uniform Rational B-Splines (NURBS)(Zhang et al., 2004) and kernels (Zang and Qiu, 2018), parametric functions (Varady et al., 1997; Yan et al., 2012; del Castillo et al., 2015; Huang et al., 2020), or predefined patch templates with specific geometries (Gupta and Gurumoorthy, 2012). The patch quality can be assessed by checking whether R(Pi) falls within the specified envelope (Luo et al., 2018). Despite its flexibility of representing 3D objects, surface patch qualification still faces the fundamental issue of potentially infinite types of surface patches. It can be tedious and labor-intensive to specify and qualify surface patches for products with frequent design changes, for example, in one-off 3D printing.

The goal of this work is to develop a methodology to automatically extract surface patches from freeform designs for fast product qualification in low-volume production such as 3D printing. The fundamental challenge is to overcome the issue of potentially infinite variety of surface patches for quality specification. The existing patch extraction approaches are not applicable because prior knowledge such as the number and boundaries of surface patches are required for region selection PS (Attene et al., 2006; Kaiser et al., 2019). Human intervention would be required to identify and extract unseen surface patches from new designs.

The proposed methodology consists of a new patch characterization method for dimension reduction, automated patch extraction, and extraction verification in new designs. Since existing patch characterization approaches are intended to capture design complexity, they are inherently defined in the functional space with infinite dimension. To facilitate product qualification, embodiments of this disclosure propose to characterize and extract surface patches based on geometric descriptors indicative of patch deviation patterns. Our basic assumption is that there are finite number of patch deviation patterns, and surface patches are therefore can be clustered into finite number of patch types for qualification. The deviation-pattern-driven characterization is proposed and justified, along with a proof of the basis assumption.

The advantage of the proposed patch characterization is two-fold. First, a finite number of surface patch types can be utilized to qualify existing and new designs. Second, region selection PS and quality characteristics representation R(PS) are both based on patch deviation patterns. The consistency facilitates automation in qualification. The disadvantage is that the extracted patches will not always correspond to the design patches. The surface patches are extracted by clustering surface points with similar values of selected geometric descriptors. Without requiring prior design knowledge, the centroids of surface patches are sequentially identified through an active landmark selection approach. The centroids are determined by local extrama of geometric descriptors and geometric centers of surface points. The surface patches will then grow around centroids until changes in patch smoothness measurement are detected, where patch smoothness is measured by the Laplacian-Beltrami (LB) operator. The sizes and boundaries of surface patches can therefore be automatically determined by a proposed changepoint detection formulation.

The validity of the developed methodology is verified by extracting surface patches from printed freeform products using geometric descriptors and examining patch devia-tion patterns. Embodiments of this disclosure will demonstrate that there are finite types of patch deviation patterns and surface patches for qualification. The patch types are determined by clustering the extracted patches. Embodiments of this disclosure adopt wave kernel signatures and curvature signatures to measure the geometric dissimilarity among patches for clustering. Deviation patterns of each sur-face patch are characterized based on point-wise curvature changes in complex freeform products. To verify the patch deviation patterns, embodiments of this disclosure construct a deviation signature to isolate the effects of printing covariates, including the printing location of the patches. Using the covariate-invariant deviation signature, embodiments of this disclosure evaluate the similarity of actual deviation patterns within each patch type. This similarity verifies the assumption that the same type of surface patches share the same inherent deviation patterns.

In summary, the contributions of this work include, but are not limited to:
1 characterizing surface patches with geometric descriptors that can capture distinct deviation patterns and reduce dimensionality for product qualification,
2. automatically extracting and grouping surface patches from freeform designs without relying on prior design knowledge, and
3. verifying the validity of automated patch extraction method using actual printed products for fast product qualification.

Following the introduction, this disclosure provides and justifies the surface patch characterization method. It also proves that there are a finite type of surface patches for qualification. Next, the proposed automated surface patch extraction method is explained. The validity of extracted surface patches are verified using actual printed products. Case studies are conducted herein, including clustering surface patches based on geometric descriptors and evaluating their actual deviation patterns. The proposed method is compared with common extraction approaches to demonstrate its efficacy for qualification.

### Surface Patch Characterization for 3D Printing Qualification

The smoothness and abrupt change characteristics of product surfaces have a strong correlation with geometric deviations of built products. Existing surface smoothness measures are not intended to reduce the infinite variety of surface patches for deviation characterization. The proposed method uses the Laplace-Beltrami (LB) operator to quantify surface smoothness and critical points to capture abrupt changes in selected geometric descriptors. In this section, embodiments of this disclosure first introduce the mathematical preliminaries of critical points and the LB operator. Embodiments of this disclosure then present the selected geometric descriptors used to characterize the surface patches. Finally, embodiments of this disclosure prove that there are a finite number of surface patch types, each corresponding to a distinct type of deviation pattern.

### Mathematical Preliminary

This work assumes that a 3D shape S is an orientable, genus-zero metric 2D surface manifold with boundaries. The closed genus-zero surfaces such as a sphere will not be considered because the bottom of the shape attached to the print bed will not be qualified.

### Critical Points

Suppose ρ(s)=0, where ρ:Ω→R3, is the function representing a surface manifold S in R3. Let ∇ρ(s) denote the gradient of p at the point s. Critical points are either differentiable with ∇ρ=0 or non-differentiable with ∇ρ non-existing. Non-differentiable critical points indicate non-smooth surface patches. These points can be identified where the change rate of surface descriptors is extremely high, typically at points where the curvatures exhibit extremely large values and have opposite signs compared to surrounding points. Conversely, differentiable critical points are found in smooth surface patches where the change rate of surface descriptors is low and bounded. These differentiable critical points are typically identified as points with local maxima or minima of curvature values (Gao et al., 2019).

### Laplacian-Beltrami (LB) Operator

The LB operator, denoted as A, is a generalization of the Laplacian operator in Euclidean space, which describes the rate at which a function spreads out from a point (Bronstein et al., 2017). Suppose a scalar field on the manifold is defined as f: S→R. LB operator Δ: L2(S)→L2(S) acting on the scalar field is defined as Formula 2, FIG. 15, where L2 is a finite-dimensional vector space with a two-norm and the operator ∇f: L2(S)→L2(T S) represents the intrinsic gradient, analogous to the classical notion of the gradient. The difference is that the direction of the intrinsic gradient is defined as the direction of the tangent vector. For further details on the LB operator on surface manifolds, embodiments of this disclosure refer to (Reuter et al., 2006; Belkin and Niyogi, 2008; Bronstein et al., 2017).

In practice, a surface manifold S is typically represented by a triangle mesh G=(V, E, T), where V, E, F are the set of the vertices, edges and triangle faces respectively. To calculate Δ on mesh G, embodiments of this disclosure utilize the graph Laplacian operator derived from Eq. 2. Consider f∈L2(V) and FεL2(E) as functions defined on the vertices and edges of the graph, respectively. The gradient defined on a graph ∇: L2(V)→L2(E) maps functions from vertices to edges (Lim, 2020) according to Formula (3) of FIG. 15.

The graph divergence div: L2(E)→L2(V) is defined along with edge weight wij according to Formula (4) of FIG. 15.

Combining Formula (3) and Formula (4) the graph LB operator Δ: L2(V)→L2(V) can be rewritten according to Formula 2 as shown in Formula 5 of FIG. 15.

The wij on a mesh G is computed as the cotangent weights wij=½ (cot αij+cot βij), where αij and βij are the angles opposite to edge (i, j) in its two adjacent triangles (Bronstein et al., 2017). As described by Eq. 5, the LB values can be intuitively understood as the difference between the function's value at a point and the local average of the function surrounding that point. With infinite refinement of the mesh, this construction is shown to converge to the continuous Laplacian of the underlying manifold (Bronstein et al., 2017).

### Geometric Descriptor Selection to Enable Dimension Reduction in Patch Characterization

The smoothness of a 2D surface is typically characterized by the continuous change of a specified geometric descriptor at surface points, such as surface normal. To capture different deviation patterns, embodiments of this disclosure select geometric descriptors indicative of these patterns and use their smoothness to characterize the patches. In particular, embodiments of this disclosure select both intrinsic geometric descriptor Gaussian curvature K, extrinsic geometric descriptors mean curvature H and surface norm. The intrinsic Gaussian curvature is independent of the coordinate system and depends solely on the local geometries of the surface. And the extrinsic mean curvature and normal directions depend on the surface's position in the coordinate system

Mean curvature is the average of the principal curvatures, indicating how the surface bends in R3. The principal curvatures are the maximum and minimum curvatures among all tangent directions at a point on a surface. Gaussian curvature is the product of the principal curvatures, depending only on the inherent manifold structure (Do Carmo, 1976). An example to illustrate the difference between these two types of curvature is that the Gaussian curvature of a cylinder is zero, indicating it is topologically flat, while the mean curvature is non-zero. High curvature values indicate non-smooth regions on the surface, where heat dissipation along the surface is impacted and may lead to large deviations. Additionally, the normal directions of surface points determine the orientation of surface patches during printing. By specifying the surface normal for patch characterization, the goal is to ensure that the impact of the orientation within the patch can be captured through a representative normal direction, such as the average of the surface normal.

These geometric descriptors are denoted as φ(s)=(K(s), H(s), θ(s), φ(s)), ∀s ∈SD. θ(s) represents the angle between the surface normal at surface point s and the x-axis in the x-y plane, and φ(s) denotes the angle between the normal direction and the z-axis. For simplicity, embodiments of this disclosure will denote SD as S in the remainder of this section. An example of φ on a dental model are shown in FIG. 4. Larger values of K and H indicate critical geometries, such as peaks and creases, which are likely to result in large deviations.

The LB operator quantifies the smoothness of the φ(s), an example is shown in FIG. 5. In addition, large values (denoted as darker color) indicates abrupt changes in each of φ, indicating the presence of non-differential critical points and non-smooth surface patches.

### Surface Patch Characterization and Proof of Finite Dimensionality

Given the selected geometric descriptors, embodiments of this disclosure first provide our definition of two broad categories of surface patches: smooth and non-smooth patches. Additional constraints are imposed on traditional definitions. Embodiments of this disclosure further prove that there are finite types of surface patches in each category.

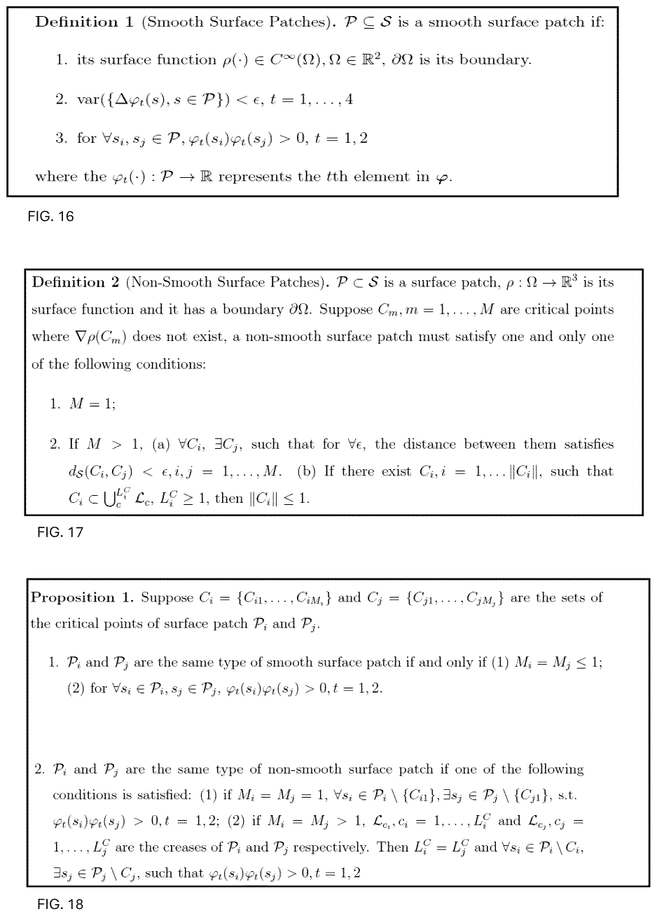

A smooth surface patch, which has a smooth deviation pattern, is defined as Definition 1 of FIG. 16.

In particular, the first condition in Definition 1 ensures that every point on the surface is infinitely differentiable. In the second condition, the bounded variance of LB values is to ensure low variability in the selected deviation-related geometric descriptors within a patch. The third condition stipulates that the Gaussian curvature K and the mean curvature H within the patch must share the same sign, preventing the coexistence of concave and convex regions within the same smooth surface patch. This distinction helps to isolate the different deviation patterns associated with concave and convex geometries. Furthermore, this condition aligns with the standard classification of smooth surfaces based on the signs of K and H (Besl and Jain, 1988).

Non-smooth surface patches are defined as small regions containing non-differentiable critical points, capturing the abrupt changes in deviation patterns. These patches typically contain either cusps, which are single and isolated points, or creases, which are formed by connected non-differentiable critical points. The creases within a non-smooth surface patch are denoted as Lc, c=1, . . . , LC. The definition is given as Definition 2 of FIG. 17.

This definition guarantees the compactness of the non-smooth patches. Specifically, the mutually exclusive condition ensures that a non-smooth surface patch can contain either a cusp or creases, but not both. In particular, if a surface patch contains creases, embodiments of this disclosure restrict that LC E R creases can only connect with LC smooth regions, ensuring that there can be only one intersection within a patch.

Based on Definition 1 and Definition 2 of FIGS. 16 and 17, it can be proved that there are finite types of surface patches in each category. Embodiments of this disclosure begin by specifying the criteria for grouping surface patches into the same type. This is further described in Proposition 1 of FIG. 18.

The intuitive explanation of this proposition is that two surface patches belonging to the same group should have the same number of critical points and creases (if they are non-smooth surface patches). They should also have the same sign for curvature at every surface point. These properties describe the geometric structures that determine the major deviation patterns, as these structures influence the flow and distribution of material. For instance, the major deviation pattern for a peak might be shrinkage or reduction in cur-vature values around the peak point. This primary deviation pattern is specific to surface patches with a peak structure and would not occur in surface patches with a ridge or valley. Embodiments of this disclosure then demonstrate that the types of surface patches are finite.
Corollary 1. There are N, N∈N types of the surface patches.
Proof. Embodiments of this disclosure prove that (1) there are N1, N1∈N types of smooth surface patches and (2) there are N2, N2∈N types of non-smooth surface patches.

To prove (1), embodiments of this disclosure utilize the fundamental surface theorem (Do Carmo, 1976), which states that a differentiable surface's shape is completely determined by the first and the second fundamental form. Since H and K can be derived from and uniquely correspond to the first and the second forms, the surface patch can be uniquely determined by H and K, along with boundary conditions. Based on Proposition 1 same types of smooth surface patches are determined by the same signs of the curvatures at every surface point. Classified by the sign of curvature, a finite number of smooth surface types have been identified (Besl and Jain, 1988). Therefore, embodiments of this disclosure can conclude that N1, N1 ∈N.

To prove (2), embodiments of this disclosure first hypothesize that there are infinitely many types of non-smooth surface patches. According to Proposition 1 (2.1), when M=1, the types of non-smooth surface patches are limited due to the finite possibilities of the curvature signs at the critical points. To substantiate the existence of infinitely many types of non-smooth surface patches, embodiments of this disclosure consider cases where M>1. Based on Proposition 1 (2.2), the same type of non-smooth surface patches have the same number of creases when M>1. To ensure an infinite number of non-smooth surface patches, there must exist a surface patch exhibiting an infinite number of creases, i.e., LC=∞. It follows that this patch represents a region where LC=∞ smooth surface patches meet. Suppose the area of each connected smooth surface patch is Ai ∈R. Then, the total area of this non-smooth surface patch would be Σi=1 to ∞ Ai=∞. However, since the boundary of a non-smooth surface patch exists, its surface area A must be a real number, i.e., A ∈R. This presents a contradiction. Therefore, the assumption that there are infinitely many types (N2=∞) of non-smooth surface patches is flawed. Instead, N2 ∈N.

### Automated Patch Extraction Based on Deviation-Pattern-Driven Characterization

Extracting surface patches that satisfy Definitions 1 and 2 needs to be automated to enable qualifying the geometric quality of an infinite variety of designs. Current patch extraction methods are conducted by clustering surface points to capture the geometric characteristics of the design shapes. This clustering process is typically informed by specified patch profiles {R(Pi)}I. The formulation can be summarized as min {Pi}I {Σ}I=i to I C (x, x∈Pi|R(Pi)), with the surface points on mesh G denoted as x ∈ V and C(·) being a cost function that measures the homogeneity within Pi.

The clustering procedures for patch extraction, however, all require prior knowledge derived from {R(Pi)}I, such as the number of patches I or the threshold of C(·) for each Pi. For example, hierarchical agglomerative clustering progressively groups adjacent surface points based on geometric similarities, utilizing specified linkage and stopping criteria to determine I (Attene et al., 2006). K-means clustering aims to minimize within-patch geometric dissimilarities with a given I (Bruce et al., 1993). Region-growing methods ensure geometric similarity within a patch by expanding regions based on geometric proximity from the seed locations (Sunil and Pande, 2008; Kaiser et al., 2019). These seed locations are typically manually identified as the centers of semantic features. The boundaries of the patches are then determined based on predefined thresholds of C (.), which quantify the geometric dissimilarity between the seeds and the boundaries (Sander et al., 2003).

### Formulation for Automated Patch Extraction

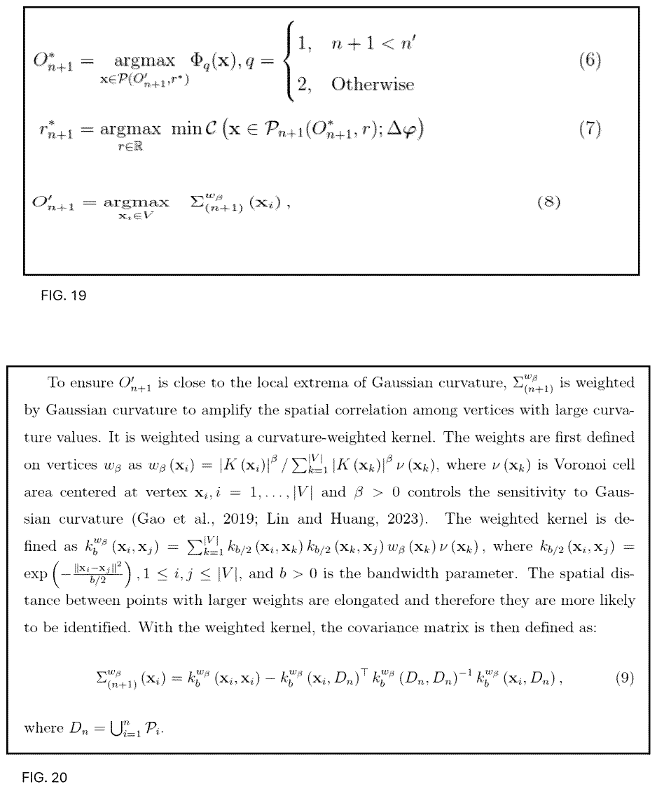

To identify surface patches without knowing {R(Pi)}I, embodiments of this disclosure cluster surface points based on the categorization criteria defined in Proposition 1, which identifies different types of surface patches according to the number of critical points. Embodiments of this disclosure first identify surface patches based on the existence of critical points. Critical points identifying the local extrema of the curvature are first selected to serve as the patch centroids. Then, the centroids of patches without critical points, such as planar regions, are identified as the geometric centers of regions with constant Δφ. These points are selected sequentially under an active landmark selection framework to adapt to frequent design changes. To ensure the surface patches have homogeneous smoothness of q, embodiments of this disclosure adapt the region-growing method to gradually expand the surface patch from the identified centroid at each step. This expansion is automatically terminated by detecting changes in the smoothness of φ in the added region. That is, at step n+1, the centroid O*n+1 and radius r*n+1 are automatically determined by solving Formula 6 and Formula 7 of FIG. 19.

Specifically, Φq(x), where q=1, 2, are the criteria for the active landmark selection to identify critical points and geometric centers for regions without critical points at each stage.

This process continues until most of the surface is covered, as shown in FIG. 4. For simplicity, embodiments of this disclosure extract patches with geodesic circular boundaries similar to (Bronstein et al., 2017). Each patch can be denoted as Pi(Oi, ri)={x ∈G|d(Oi, x)≤ri}, where ri is its geodesic radius. It can be easily extended to freeform boundaries by modifying the distance metric d(·, ·).

### Automated Patch Extraction Based on Deviation Pattern-Driven Characterization.

Extracting surface patches that satisfy Definitions 1 and 2 of FIGS. 16 and 17 needs to be automated to enable qualifying the geometric quality of an infinite variety of designs. Current patch extraction methods are conducted by clustering surface points to capture the geometric characteristics of the design shapes. This clustering process is typically informed by specified patch profiles {R(Pi)}I. The formulation can be summarized as min {Pi}I {Σ}I=i to I C (x, x ∈ Pi|R(Pi)), with the surface points on mesh G denoted as x ∈ V and C(·) being a cost function that measures the homogeneity within Pi.

The clustering procedures for patch extraction, however, all require prior knowledge derived from {R(Pi)}I, such as the number of patches I or the threshold of C(·) for each Pi. For example, hierarchical agglomerative clustering progressively groups adjacent surface points based on geometric similarities, utilizing specified linkage and stopping criteria to determine I (Attene et al., 2006). K-means clustering aims to minimize within-patch geometric dissimilarities with a given I (Bruce et al., 1993). Region-growing methods ensure geometric similarity within a patch by expanding regions based on geometric proximity from the seed locations (Sunil and Pande, 2008; Kaiser et al., 2019). These seed locations are typically manually identified as the centers of semantic features. The boundaries of the patches are then determined based on predefined thresholds of C(·), which quantify the geometric dissimilarity between the seeds and the boundaries (Sander et al., 2003).

### Formulation for Automated Patch Extraction

To identify surface patches without knowing {R(Pi)}I, embodiments of this disclosure cluster surface points based on the categorization criteria defined in Proposition 1, which identifies different types of surface patches according to the number of critical points. Embodiments of this disclosure first identify surface patches based on the existence of critical points. Critical points identifying the local extrema of the curvature are first selected to serve as the patch centroids. Then, the centroids of patches without critical points, such as planar regions, are identified as the geometric centers of regions with constant Δφ. These points are selected sequentially under an active landmark selection framework to adapt to frequent design changes. To ensure the surface patches have homogeneous smoothness of φ, embodiments of this disclosure adapt the region-growing method to gradually expand the surface patch from the identified centroid at each step. This expansion is automatically terminated by detecting changes in the smoothness of φ in the added region. That is, at step n+1, the centroid O*n+1 and radius r*n+1 are automatically determined by solving Formula 6 and Formula 7 of FIG. 19. Specifically, Φq(x), where q=1, 2, are the criteria for the active landmark selection to identify critical points and geometric centers for regions without critical points at each stage.

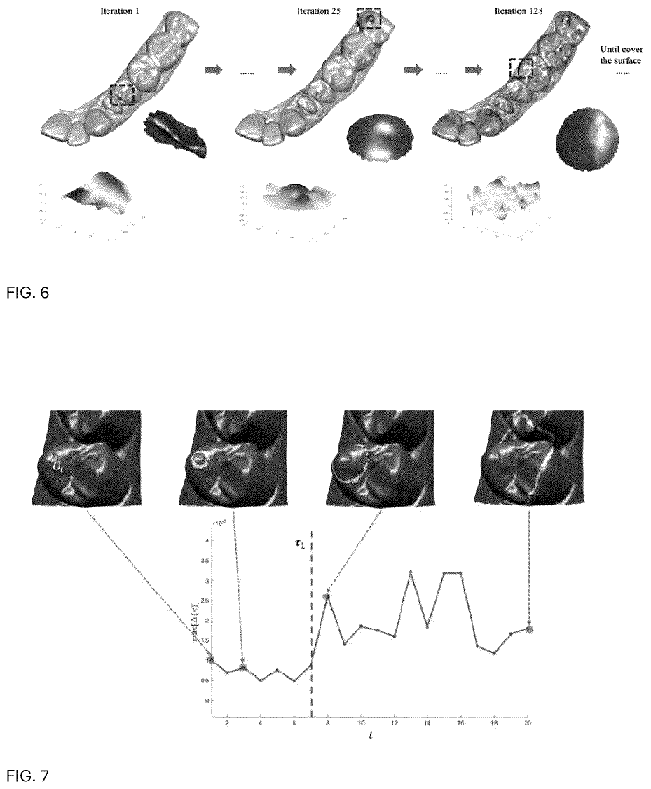

This process continues until most of the surface is covered, as shown in FIG. 6. For simplicity, embodiments of this disclosure extract patches with geodesic circular boundaries similar to (Bronstein et al., 2017). Each patch can be denoted as Pi(Oi, ri)={x∈G|d(Oi, x)≤ri}, where ri is its geodesic radius. It can be easily extended to freeform boundaries by modifying the distance metric d(·,·).

### Identifying Patch Centroids Through Active Landmark Selection

To identify the centroids of the surface patches, an attempt centroid O′n+1 is first found at each step in Eq. 6. These O′ n+1 are determined by maximizing the distances between themselves and the previously selected patches, thus ensuring that the extracted patches are able to cover the original surface. Then, at each stage, the location of O*n+1 is determined by adjusting On+1 to the point with maximum Φq(x) around it.

### Stage 1: Identification of Critical Points

This stage aims to identify O*n+1 as the critical points. Embodiments of this disclosure set Φ1(x)=∥φ1(x)∥ to move the attempt O′n+1 to the local maximum of the absolute value of the Gaussian curvature K. The region to define the local maximum is within the radius r*, which will be elaborated upon in the next subsection.

Embodiments of this disclosure first explain the identification of the attempt O′n+1 in the first stage. The initial centroid is determined as the global maximum of the absolute values of K. At step (n+1) in the first stage, the O′n+1 is identified by maximizing its distance from all points in the previously extracted patches. The O′n+1 is found by solving the following Formula 8 of FIG. 19 where Σ(n+1) to wβ(xi) is the covariance matrix characterization of the spatial correlation.

This disclosure continues with Formula 9 of FIG. 20 regarding using weighted kernels and defining the covariance matrix. It is noted that Eq. 9 differs from the approaches in (Gao et al., 2019; Lin and Huang, 2023) as it accounts for all points within the determined patches, whereas Gao et al. (2019); Lin and Huang (2023) consider only landmarks or centroids.

The stopping criterion for the first stage is determined by a prespecified number n′ of consecutive failures to add new patches. After identifying all the surface patches containing critical points, the next stage involves identifying smooth surface patches without critical points. These include flat planar, spherical, and cylindrical surface patches, among others.

### Identification of Geometric Center on Flat Regions

Stage 2 aims to identify smooth surface regions without critical points. Unlike in the first stage, the centroids of these patches typically have curvature values close to zero. Therefore, embodiments of this disclosure determine the attempt centroid On+1 without weighting Σwβn+1 using the curvature in Formula 8 of FIG. 19. This modification intends to identify the point in flat regions.

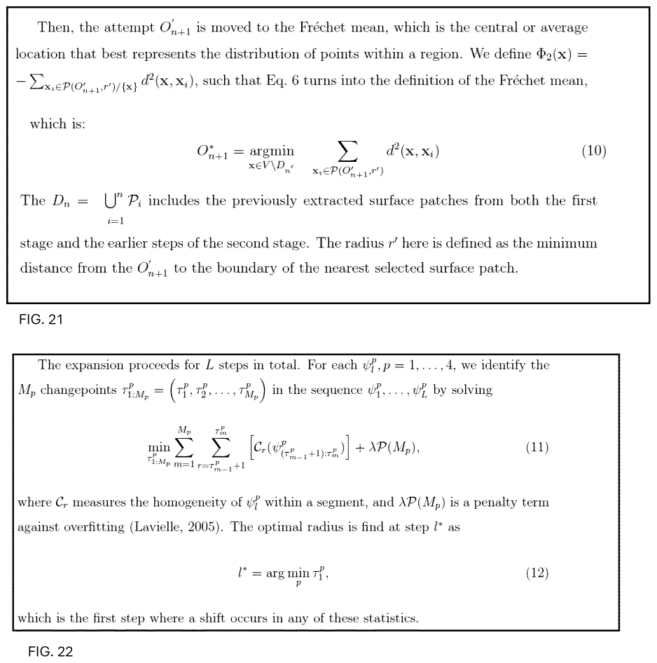

Then, the attempt O′n+1 is moved to the Frechet mean, which is the central or average location that best represents the distribution of points within a region. See Formula 10 FIG. 21.

### Determining Patch Size Via Region Growing and a Change-Point Detection Formulation

The optimal radius r* in Formula 7 of FIG. 19 is determined by expanding the region and automatically terminating when the homogeneous smoothness of φ within the patch is violated. Starting from the centroid, the radius is incrementally expanded by a fixed amount or from an initial radius r0. The newly added regions at step 1 are denoted as δP1+1={x|d(Oi, x)∈[r1, r1+1)}, r1=r0+1×δr. At each step, the distribution of geometries and covariate values of the added regions will be monitored and compared with those in the previous steps. The optimal radius is considered reached at step 1 if δP1+1 demonstrates significantly different statistics of Δφ compared to the internal region.

This process is conducted through changepoint detection, which identifies the statistical shift in Δφ while expanding the region. Embodiments of this disclosure construct the statistics of Δφt individually. Suppose ψi p represents the pth statistics of the {Δφt(x)}, x∈δP1 at step 1. In particular, embodiments of this disclosure definel ψ1=max(ΔK(δP)), ψ2=IQR (H(δP)), ψ3=max (Δθ(SP)), and ψ4=max (Δφ(δP1)) for detecting the changes. Specifically, ψ1 1 tracks smoothness in Gaussian curvatures to determine the extent of the deviation pattern. ψ12 is the inter-quantile range (IQR) of mean curvature. Monitoring it helps detect significant geometric changes within the added region that may not be detected by ψ11. In addition, ψ13 and ψ14 monitor the rate of change in point orientations. The uniform change is to ensure that the effect of orientation can be characterized as a single covariate value on a deviation function.

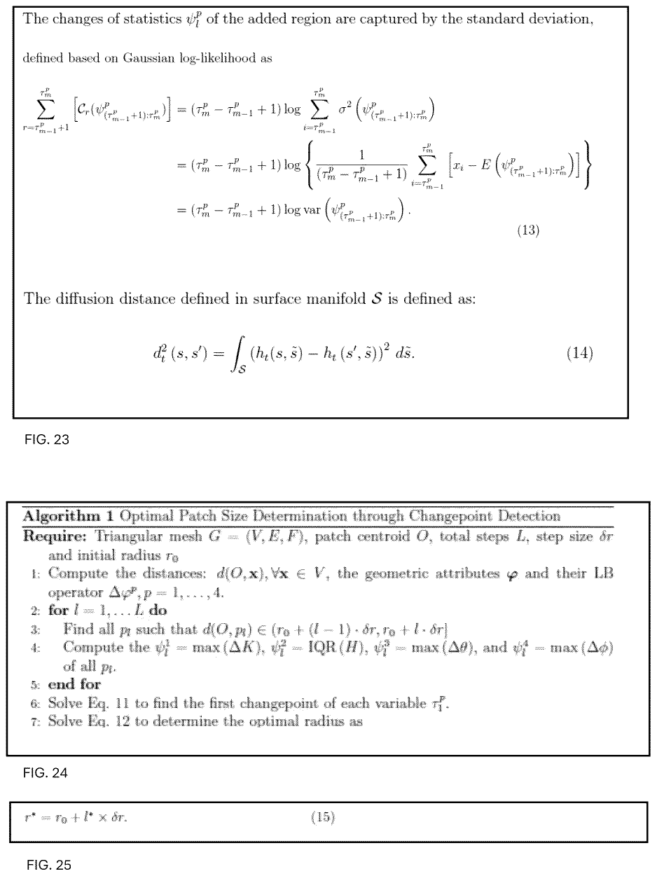

The expansion process for L steps i total. For each ψ1p p=1, . . . , 4, embodiments of this disclosure identify the Mp changepoints. The process continues as shown in Formulas 11-14 of FIGS. 22 and 23

The ht (s, s′) is the heat kernel. From a physical perspective, ht (s, s′) quantifies the amount of heat transferred from point s to point s′ over a time period t. The diffusion distance is particularly useful as it averages over the various paths between two points, thereby offering robustness against noise and minor perturbations on the manifolds. The diffusion distances on a mesh G are computed following (Crane et al., 2013).

The process for determining the optimal patch size can be summarized in Algorithm 1 of FIG. 24. The complete implementation of the proposed automated patch extraction method is outlined in Algorithm 2 of FIG. 26.

### Verification of the Extracted Surface Patches

The validity of the developed surface patch characterization and extraction method is evaluated by clustering the extracted surface patches from actual printed products and examining their deviation patterns. The aim is to demonstrate that surface patches of the same type exhibit inherently similar deviation patterns. The type of surface patches are specified by clustering the patches according to geometric dissimilarity, which is quantified based on wave kernel signatures, mean and Gaussian curvature signatures specified herein.

To verify the patch deviation within a patch type, the similarity among their deviation patterns has to be quantified. To characterize the deviation pattern on freeform patches, embodiments of this disclosure define a new type of deviation function using point-wise differences in mean curvatures, elaborated below. However, beyond the type of surface patches, the patch deviation patterns are also influenced by covariates such as the locations of the surface patches on the printing bed (Luan et al., 2019) and the sizes of the geometries (Huang et al., 2020). Based on the proven assumptions above, finite types of surface patches can be specified with distinct geometric structures characterized by the selected geometric descriptors. These geometric characteristics determine the critical deviation patterns of patches, which establish the unique parametric forms of the deviation functions for each patch type. The effect of covariate would be reflected in function coefficients (Huang et al., 2020). The actual functional forms of these deviation functions of surface patches, however, are currently unknown for freeform patches, making it challenging to model the effects of covariates. Therefore, to compare the deviation patterns of surface patches, embodiments of this disclosure extract characteristics of the deviation functions to isolate the effects of covariates. These characteristics, called deviation signatures, are defined in Formula 18 of FIG. 29. They are invariant to covariates and capture solely the deviation patterns dependent on patch type.

### Quantification of Geometric Dissimilarity Among Surface Patches

Clustering the surface patches depends on quantifying the geometric dissimilarity be-tween different patches. This quantification is distinct from computing the geometric discrepancy d (R(PDi), P(PAi)), which captures subtle differences in local regions. Instead, the focus here is on capturing differences in overall geometric structures for clustering the surface patches. Embodiments of this disclosure adopt the Wave Kernel Signature (WKS) (Aubry et al., 2011) to char-acterize the intrinsic geometries of the surface patches. Additionally, embodiments of this disclosure construct Gaussian curvature maps and mean curvature maps (Gatzke et al., 2005) to identify patches with varying signs of curvature.

Wave Kernel Signature (WKS) leverages the spectral properties of the LB operator on surface manifolds. It calculates the wave kernel, reflecting both local and global geometric features, and is invariant to rigid motions in R3. Embodiments of this disclosure utilize the WKS at the center point Oi∈Pi to characterize the geometries of the surface patches. Examples of calculated WKSs of surface patches can be found in FIG. 8. For further details, embodiments of this disclosure refer interested readers to (Aubry et al., 2011).

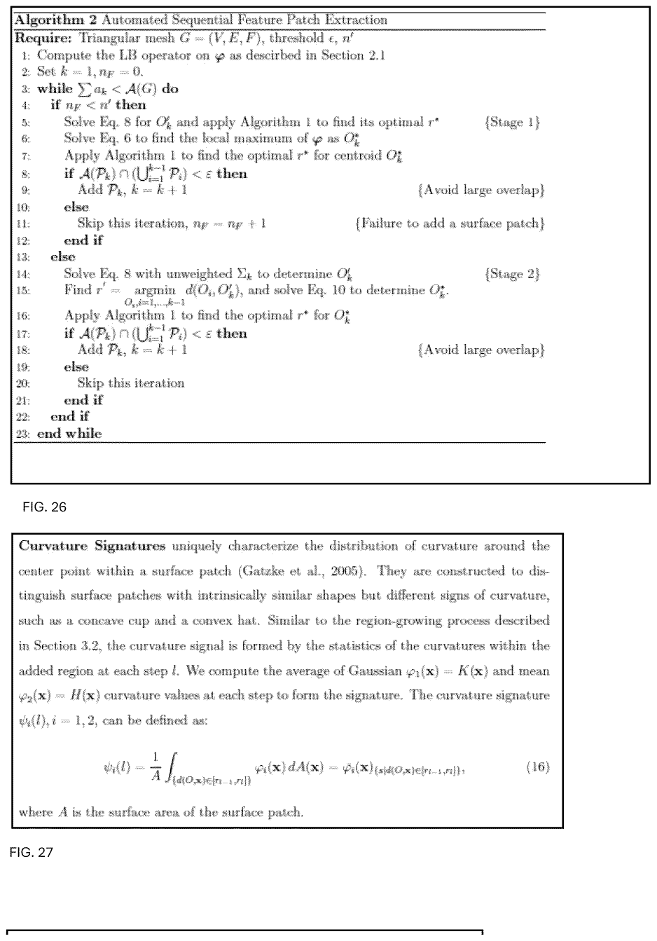

Curvature Signatures uniquely characterize the distribution of curvature around the center point within a surface patch (Gatzke et al., 2005). They are constructed to distinguish surface patches with intrinsically similar shapes but different signs of curvature, such as a concave cup and a convex hat. Similar to the region-growing process described in Section 3.2, the curvature signal is formed by the statistics of the curvatures within the added region at each step 1. Embodiments of this disclosure compute the average of Gaussian φ1(x)=K(x) and mean φ2(x)=H(x) curvature values at each step to form the signature. The curvature signature ψi (1), i=1, 2, can be defined as disclosed in Formula 16 at FIG. 27.

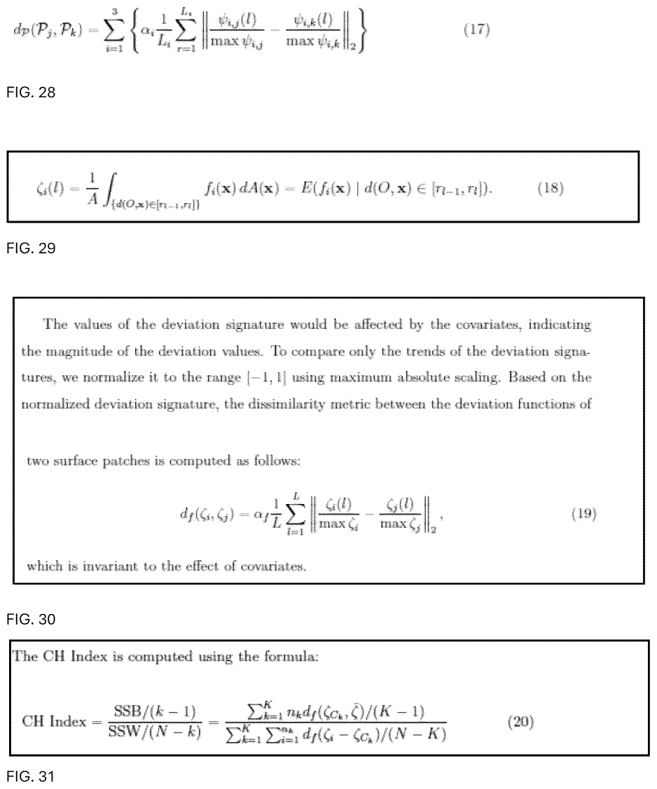

For each surface patch, embodiments of this disclosure compute the WKS, Gaussian, and mean curvature signals to characterize their geometries for comparison and clustering. Examples of these characteristics are shown in FIG. 8. Based on these, embodiments of this disclosure define a distance metric to represent the differences between two surface patches. The WKS is denoted as ψ3(1). The signals ψi(1), i=1, 2, 3, are rescaled to the range [−1, 1] using maximum absolute scaling to address unit disparities. The distance is defined as shown at Formula 17 at FIG. 28, where αk are the user-determined weights such that two curvature signature and WKS, respectively.

### Deviation

To characterize deviation patterns on freeform surfaces for evaluation, embodiments of this disclosure first register the design shape with the actual print to extract patches from the actual product. Considering that the patches can be oriented arbitrarily in R3, Embodiments of this disclosure propose a new deviation function to characterize the complex geometric distortions. The deviation functions of different surface patches are compared after isolating the effects of covariates for verification. Embodiments of this disclosure derive a descriptor to characterize the inherent structure of the deviation functions of patches, preserving features such as the maximum and minimum of the function, whose locations are invariant under covariates.

### Diffeomorphic Shape Registration

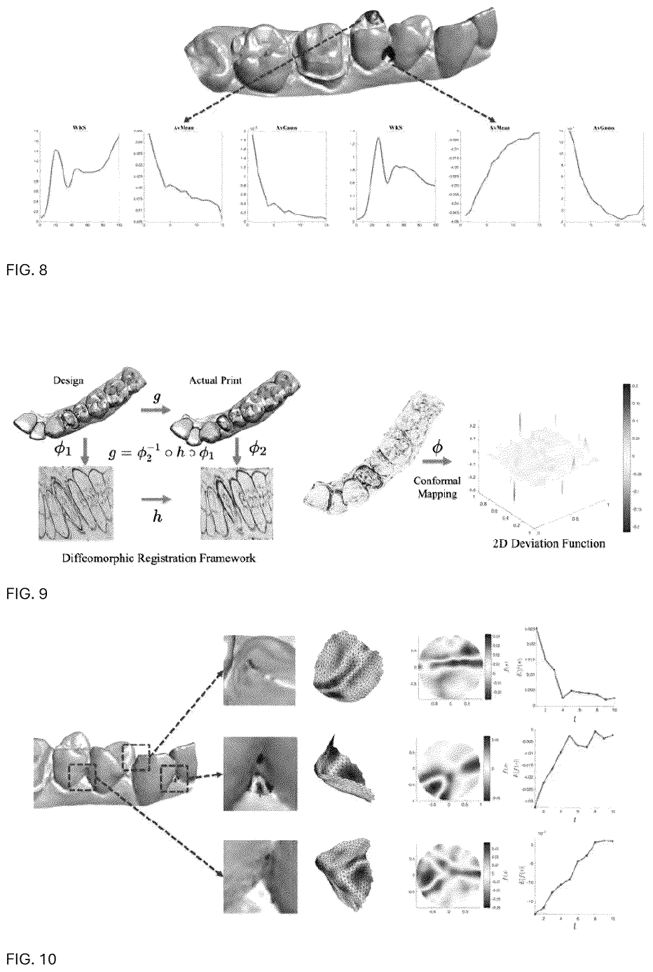

Embodiments of this disclosure adopt a diffeomorphic registration framework to register freeform surfaces (Glaunes et al., 2008; Lui et al., 2014; Choi et al., 2020), achieved by minimizing geometric distortions such as conformality distortion between the surfaces, as shown in FIG. 7. To improve registration accuracy for complex freeform shapes, Embodiments of this disclosure use deviation-aware shape segmentation and landmark selection to register segments on freeform shapes while im-posing landmark constraints (Lin and Huang, 2023). In each segment, embodiments of this disclosure determine the optimal diffeomorphism on the flattened surface as a Teichmuller map (T-map), which uniquely minimizes the maximal conformality distortion. For details on obtaining the op-timal T-map, refer to (Lui et al., 2014; Choi et al., 2020). The optimal, final registration is obtained as g*=φ1−1∘h∘φ2, as shown in FIG. 9. The surface patches on the actual products are extracted as PAi=g*(PDi).

### Deviation Functions of Complex Freeform Shapes

The discrepancy between the patch profiles, d(R(PDi), R(PAi)), is typically characterized by a deviation function f: R3→R. This function characterizes the deviation patterns on the surface and is defined as a scalar field of point-wise differences. These point-wise differences are typically defined as the spatial distances between corresponding points on PDi and PAi. Distances are typically calculated along a specified direction, either the z-axis (del Castillo et al., 2015; Zang and Qiu, 2018), or the radial distance in spherical coordinates following coordinate transformations (Huang et al., 2015; Luan and Huang, 2017). These functions capture the geometric deformation on the surface perpendicular to the specified direction, ignoring the deviation along the direction. As a result, these deviation functions may overlook details of the geometric deformation of complex shapes.

To capture geometric complexity, embodiments of this disclosure propose a deviation function that characterizes the changes in mean curvature at surface points. Embodiments of this disclosure choose mean curvature as it can be used to reconstruct the surface (Ye et al., 2021), potentially facilitating quality control by adjusting the design profile. These differences are calculated based on the point-to-point correspondence determined by the optimal shape registration g*:s∈SD→s′∈SA. The deviation functions of surface patches Pi are then determined as fi(x)=H′(g*(x))−H(x), x∈D=φ(PDi), ∀i=1, . . . , I. The D is obtained by conformally mapping PDi into a canonical 2D domain. And H′(s′), s∈PAi is the mean curvature on the surface patches of the actual printed product. Examples of deviation functions of surface patches are shown in the bottom row of FIG. 6.

### Covariate-Invariant Descriptors to Characterize Deviation Functions

To enable evaluation without knowing the exact functional forms of fis, embodiments of this disclosure extract fis' characteristics that are independent of covariates such as patch size, printing location, and printing orientation. The different covariates of identical surface patches will not change the inherent structure of their deviation functions, including collinearity, parallelism, convexity, and intersections. To extract the covariate-independent characteristics of the deviation functions, embodiments of this disclosure adapt the concept of curvature signatures discussed herein. Embodiments of this disclosure construct a deviation signature to uniquely characterize the 2D deviation function as shown in Formula 18 of FIG. 29.

This signature records the average deviation values in the added region at each step of expansion. Its trend depends solely on the inherent structure of the deviation functions, as the statistics of the deviation values in the Ith added regions are invariant to the embedding of the deviation functions. Examples of ζ(1) are shown in FIG. 10.

The values of the deviation signature would be affected by the covariates, indicating the magnitude of the deviation values. To compare only the trends of the deviation signatures, Embodiments of this disclosure normalize it to the range [−1, 1] using maximum absolute scaling. Based on the normalized deviation signature, the dissimilarity metric between the deviation functions of two surface patches is computed as shown in Formula (19) at FIG. 30.

### Experiments: Clustering Surface Patches and Evaluating Their Deviation Functions

In this session, embodiments of this disclosure conduct the automated surface patch extraction described herein on a series of freeform shapes. The extracted surface patches are then clustered into groups based on the geometric similarity criteria introduced this disclosure. The goal is to demonstrate that a finite number of surface patch groups can be generated despite the variety of shapes. Then, embodiments of this disclosure extract the surface patches from actual printed products to evaluate the deviation patterns of surface patches. The covariate-independent deviation function characteristics described herein are extracted from each patch to verify that the same type of surface patches share the similar deviation patterns.

Clustering Surface Patches from Different Shapes

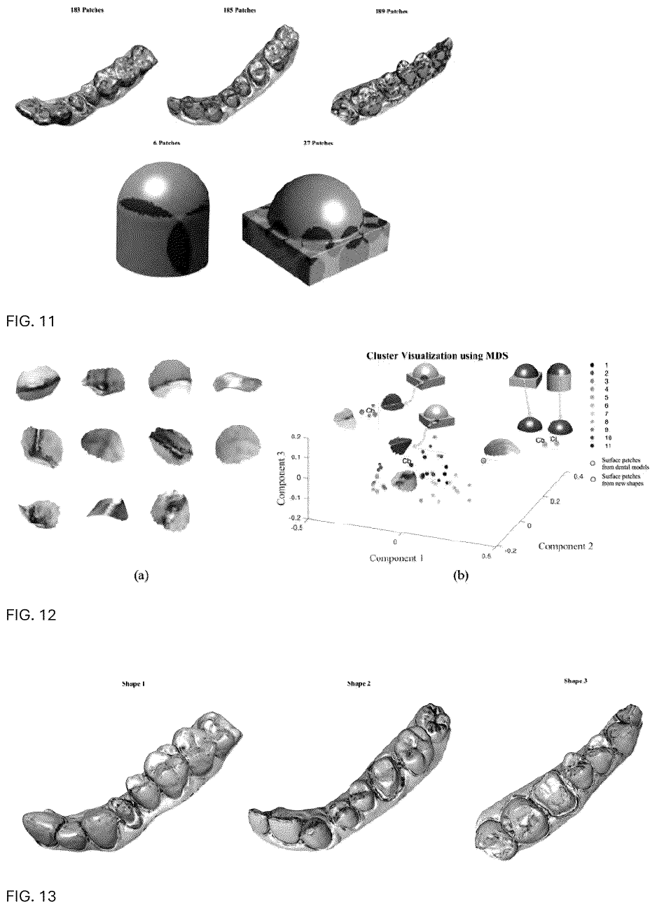

The tested shapes and their extracted surface patches are shown in the FIG. 11. Without prior knowledge of the number of surface patches, there are 183, 185, and 189 surface patches extracted for the three dental models, 6, and 27 patches for the other two shapes (as new designs). Embodiments of this disclosure first form the groups of surface patches from the dental models. And then demonstrate the smooth surface patches from the two new designs can be clustered into the formed groups.

To conduct the clustering analysis, embodiments of this disclosure adapt the distance metric from and computed pairwise distances among all surface patches from three dental models. Clustering is performed using the density peak method described in (Rodriguez and Laio, 2014). This method relies solely on pairwise distances and does not require prior knowledge of the number of clusters. Using the criterion to automatically determine the number of clusters in (Lin and Huang, 2023), eleven clusters of surface patches can be determined for the dental models. The cluster centroid, i.e., representative surface patch of each cluster, can be found as in the FIG. 12A.

Embodiments of this disclosure also illustrate the clustering results using multidimensional scaling (MDS). The surface patches extracted from the shapes of a dome over a cube and a dome over a cylinder are assigned to a cluster formed by the surface patches from dental models. For example, these dome patches can be grouped into the cluster of spherical surface patches from dental models based on geometric similarity measurements. The non-smooth patches, which containing a crease, from the new designs, can also be grouped into the geometrically similar patches from the dental models. The results of MDS and the clustering of the surface patches from new shapes are shown in FIG. 12B.

### Comparing the Deviation Functions Within and Across Different Patch Types

In this section, embodiments of this disclosure evaluate the validity of the extracted patches based on their effectiveness in identifying distinct deviation patterns for different patch types. Embodiments of this disclosure printed the three dental models using the SprintRay Model Pro95 Digital Light Processing printer, SprintRay Study Model White resin and with a layer thickness of 100 μm. The printed products are registered with the designs as introduced herein to extract the surface patches from the actual printed products. The deviations on the three dental models are shown in FIG. 13. The deviation functions of the surface patches are then transformed to 2D domain by flatten the surface patches conformally, according to the disclosure herein.

The deviation functions of surface patches are compared based on the deviation signatures defined above using the clustering results presented herein. The proposed surface patch extraction method (denoted as Seq) is compared with two other common surface patch extraction methods: Voronoi diagram patch extraction (Voronoi) and shape segmentation by K-means clustering (Kmeans). The Voronoi method generates a Voronoi diagram from landmarks selected through farthest point sampling (Lipman and Funkhouser, 2009), where each cell in the Voronoi diagram is extracted as a surface patch. For the Voronoi and Kmeans methods, embodiments of this disclosure extracted sets of 100, 150, 200, and 250 patches for comparison. Additionally, embodiments of this disclosure extracted the same number of patches as the proposed method, referred to hereafter as Adapt.

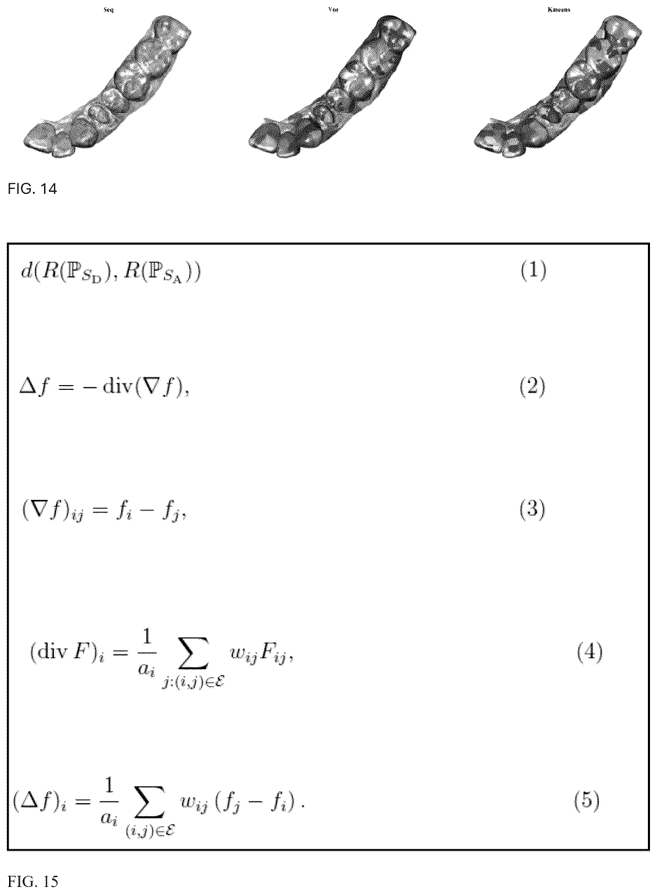

The extracted patches on dental model 1, using different methods and having the same number of patches, are displayed in FIG. 14. Embodiments of this disclosure observe that patches extracted by the Voronoi method tend to center around local geometry extrema as well. However, these patches often have irregular boundaries, potentially leading to significant conformal distortions during parameterization. In contrast, surface patches extracted by the Kmeans method typically exhibit more regular, convex shapes with uniform sizes. However, this approach can result in unnecessarily small, flat patches. These issues can be addressed by the proposed Seq method, since their sizes are adapted to the local geometries.

To assess the similarity of deviation functions both within and across clusters, Embodiments of this disclosure employ the Calinski-Harabasz Index (CH Index) (Maulik and Bandyopadhyay, 2002), also referred to as the Variance Ratio Criterion. Let SSB (Sum of Squares Between clusters) represent the sum of the squared deviations between the centroid of each cluster and the overall data mean, each weighted by the number of elements within that cluster. Similarly, SSW (Sum of Squares Within clusters) denotes the sum of squared deviations between each data point and its respective cluster centroid. The CH Index is computed using Formula 20 of FIG. X, where N is the total number of data points and K is the number of clusters. A higher CH Index indicates that the clusters are well-separated and internally cohesive, suggesting a more optimal clustering structure.

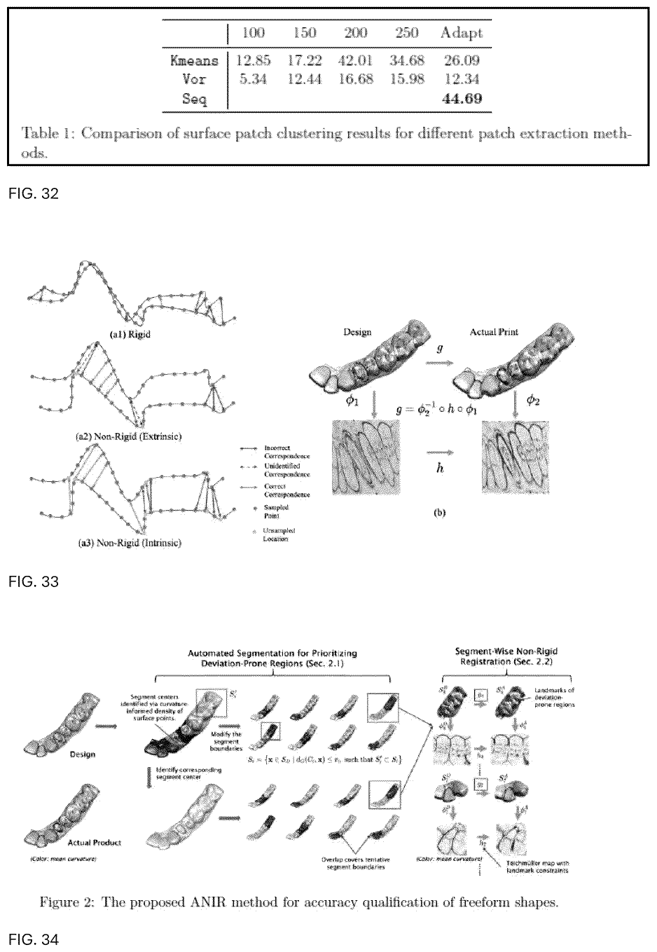

The CH indexes of clustering deviation functions for surface patches extracted via various methods are presented in Table 1 of FIG. 32. The proposed Seq method exhibits the highest CH index, indicating better separation of deviation functions among different types of surface patches. In general, Kmeans outperforms Vor due to the latter's irregular boundaries, which introduce inconsistent deviation patterns within the same type.

To ensure the robustness of the results despite the surface patch clustering methods, embodiments of this disclosure adopted an alternative clustering framework (Linderman and Steinerberger, 2019) and compared the CH index across different surface patch extraction methods. The surface patches were first embedded into a low-dimensional shape space using t-distributed stochas-tic neighbor embedding (t-SNE). This process was based on the pairwise distances between the deviation signatures computed as in Eq. 19. K-means clustering was then conducted within the low-dimensional space. To ensure the reliability of the clustering results, embodiments of this disclosure replicated each experiment 1000 times, accounting for the inherent randomness in the initial selection of centroids in K-means and the stochastic nature of t-SNE.

The results of clustering the surface patches using t-SNE and K-means are illustrated in FIG. 13. In accordance with the results presented in Table 1, the Seq method performs better than both the Kmeans and Vor methods in terms of achieving higher CH index values. For both the Kmeans and Vor methods, the CH index was highest when the surface was decomposed into 250 pieces. This outcome can be attributed to the fact that most surface patches are small and have simple geometries, such as planes. These small pieces exhibit simple deviation patterns, making them easier to distinguish from non-smooth surface patches. However, critical geometric structures that influences deviation patterns may be lost when decomposing into extremely small surface patches. In conclusion, the Seq method effectively identifies different deviation patterns and preserves essential geometric information across the extracted surface patches.

The qualification of a product's geometric accuracy often requires comparing the geometric differences between the actual product and its intended design (Ge et al., 1992; Scimone et al., 2022). This comparison is typically conducted based on shape registration, which determines the optimal transformation to establish correspondences between the two shapes (Li and Gu, 2004; Zeng and Gu, 2011). In general, the optimal transformation g between the design product SD and the actual product SA is usually determined by minimizing a predefined geometric difference d (·, ·) as follows (Tam et al., 2013) as shown in Formula A1-1, FIG. 42.

Solving Eq. (1) often requires iteratively reducing the sum of point-wise distances by making small adjustments to the transformation g (Tam et al., 2013). In rigid shape registration, g is determined as a rigid motion, i.e., translation and rotation, and the metric d(·,·) represents the point-to-point Euclidean distance in R3 (Besl and Mckay, 1992). Rigid motions align measured data with the nominal shape within a common coordinate system for deviation characterization (Tong et al., 2008). However, advanced manufacturing techniques like 3D printing enable the fabrication of complex geometries (Bermano et al., 2017). Geometric features such as curves, folds, and sharp peaks introduce heterogeneous distortions that rigid motions alone cannot capture (Jin et al., 2019; Ghorbani and Khameneifar, 2021). To determine the optimal rigid motion, the objective function in Eq. (1) minimizes the sum of squared Euclidean distances. This process may converge to a solution where the geometric features are only partially aligned, as further adjustments to the transformation do not significantly reduce the overall sum. The correspondences between SD and SA are then established by finding the closest points, which can result in misalignment of other distorted geometric features, as illustrated in FIG. 33A at a1.

To overcome the limitation of rigid registration, various forms of non-rigid transformation g have been developed to capture heterogeneous spatial shape deviations for products with complex geometries (McConaha and Anand, 2020; Thiebaut et al., 2018). The non-rigid g can be defined either extrinsically, where each point on the surface of SD is deformed to match its location in R3 with a corresponding point on SA, or intrinsically, where surface points are matched based on intrinsic geometries that are invariant to the coordinate system (Tam et al., 2013). Extrinsic methods for defining g typically require the identification of control points or nodes in SD and SA that feature their shapes. Obtained through uniform sampling or manual selection (McConaha and Anand, 2020; Schweinoch et al., 2016), control points are utilized to determine the transformation g either as the optimal point-wise rigid transformation (Thiebaut et al., 2018), an affine transformation (McConaha and Anand, 2020), or as a transformation function characterized by thin-plate splines (Chui and Rangarajan, 2003). The accuracy of the registration therefore depends on the distribution and representativeness of the selected control points. Complex geometries may require a denser set of nodes; otherwise, true correspondences may remain unidentified, as shown in FIG. 33A at a2. Regions with smaller geometric deviations may be overlooked while solving Eq. (1), since the sum of point-wise distances may not reduce significantly once the geometric features are partially aligned.

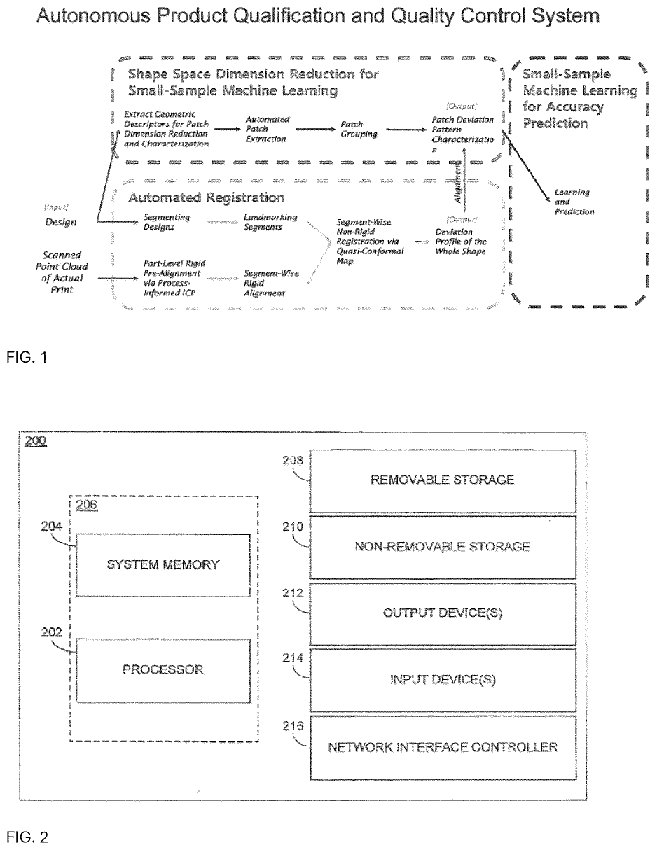

Intrinsic methods for determining non-rigid registration are more robust because the metric d (·, ·) in Eq. (1) captures changes in the inherent geometric structures rather than distances determined by control points. As illustrated in FIG. 33A at a3, intrinsic methods can correctly identify the true correspondence despite the selection of control points. A typical framework for intrinsic methods of 3D shapes is shown in FIG. 1(b). These methods first map 3D shapes to canonical 2D forms while preserving intrinsic geometries, such as the angles between curves, through conformal mapping (Wang et al., 2007; Sheffer et al., 2007). This process is usually referred to as surface parameterization. The registration is then conducted on the 2D forms. The transformation h is found by minimizing a geometric dissimilarity metric, such as conformal distortion (Lui et al., 2014; Choi et al., 2020a), among the parameterized 2D forms. The final non-rigid registration between the original 3D shapes is achieved by composing the parameterization and registration functions (Tam et al., 2013).

However, preserving intrinsic geometric structures for complex geometries through φ1,2 can be particularly challenging. The φ1,2 are determined by iteratively minimizing geometric distortions such as area, distance, and angles between a 3D shape and its 2D canonical form (Wang et al., 2007; Sheffer et al., 2007). For highly complex shapes with dense 3D meshes, iterations may terminate prematurely when distortions can no longer be reduced after some geometric features are correctly parameterized or when computational limits are reached (Choi et al., 2020b). This issue is especially pronounced for shapes with multiple high-curvature regions that require trade-offs in optimization. In addition to parameterization errors, determining h between the parameterized 2D domains for complex geometries by iteratively solving Eq. (1) can be difficult due to the lower sensitivity to local deviations (Lam and Lui, 2014). These two sources of error can result in lower accuracy for some features, while still achieving accurate registration for geometric features with large distortions, as shown in FIG. 33A at a3.

To reduce registration errors when searching for h, landmark constraints have been introduced to specify geometric feature correspondences and reduce trade-offs across local regions (Lui et al., 2014; Choi et al., 2020a; Lam and Lui, 2014). In 3D printing, efforts have focused on automatically selecting landmarks in high-curvature regions prone to deviations (Lin and Huang, 2023). However, relying solely on landmark constraints does not fully resolve errors between 3D shapes. Parameterization errors remain significant, especially in complex geometries and deviation-prone, high-curvature regions.

To address parameterization challenges in complex geometries, (Choi et al., 2020b) proposes to segment a complex shape, apply parameterization to the segments, and then stitch them together to reconstruct the parameterization of the entire shape. The segmentation aims to reduce computational costs and prevent premature iteration termination. It often relies on human input, such as determining the number of segments. However, directly adopting this strategy to improve shape registration in product qualification presents two challenges. First, geometric shape deviations may not be accurately characterized due to improper segmentation. Current methods often cut along high-curvature regions for feature identification (Page et al., 2003; Attene et al., 2006), where deviations are more likely to occur (Lin and Huang, 2023). However, these deviations may be overlooked during registration, as iterations may terminate once the central region of a shape has been registered. Second, when stitching the registration results of the segments back together, incorrect correspondences may occur along the boundaries. This can result in discontinuous deviation characterizations in subsequent steps.

Therefore, to enhance the accuracy and efficiency of non-rigid registration for product qualification, we propose to prioritize these deviation-prone, high-curvature regions during segmentation and registration. As shown in FIG. 34, the proposed ANIR method includes automated deviation-aware shape segmentation and segment-wise intrinsic non-rigid registration. Unlike other segmentation methods that detect high-curvature points as boundaries, embodiments herein position these points in the central regions of each segment. Embodiments herein propose a curvature-informed, density-based clustering method to automatically identify these regions for determining segment centers. Furthermore, instead of enforcing strict separations between segments, embodiments herein specify a geodesic radius to define the circular boundaries, and allow segment overlap. This overlap enables errors from parameterization and registration near the boundaries to be corrected through smoothing in the overlapping areas. The corresponding segments on SA are identified based on the specified radius and segment centers.

These centers are determined by geometric similarities between points, using wave kernel and curvature signatures of surface points. Embodiments herein utilize the Teichmuller map (Lui et al., 2014; Choi et al., 2020a) to achieve intrinsic non-rigid registration between segments. It is a special type of diffeomorphism determined by minimizing conformal distortions. This map preserves the local geometric structure during transformation while allowing flexible local stretching. To further improve the accuracy of the segment-wise Teichmu\ddot{ }ller map, embodiments herein identify landmarks (Lin and Huang, 2023) that pinpoint regions of locally high curvature within segments as constraints. As a result, accurate point correspondences are achieved despite complex printing deviations.

Some non-limiting contributions of this work can be summarized as: (i) Develop segment-wise intrinsic non-rigid registration to accurately find point-wise correspondence for freeform products with complex spatial deviation pattern; (ii) Automate identification of deviation-prone regions to reduce parameterization and registration errors; and (iii) ensure continuous deviation characterization of the entire shape by adjusting segment boundaries and smoothing deviations in overlapping areas.

### AINR Methodology

### Automated Segmentation of Freeform Shapes for Prioritizing High-Curvature Regions

Current 3D shape segmentation methods primarily focus on extracting semantic features for pattern recognition (Theologou et al., 2015) and engineering design (Gu and Huang, 1998). Unsupervised methods detect feature boundaries (Golovinskiy and Funkhouser, 2008) or cluster points for semantic feature identification (Page et al., 2003; Attene et al., 2006), typically segmenting shapes along high-curvature features like prongs and creases. Alternatively, supervised models can be trained to identify high-curvature regions, but they require large, labeled datasets (Kalogerakis et al., 2010), which are challenging to adapt to the frequent design changes in 3D printing. An automated deviation-aware shape segmentation method was introduced in (Lin and Huang, 2023) to identify high-curvature regions while adapting to frequent design changes. However, this method, designed for balanced landmark selection, tends to preserve regions with extremely high curvature while overlooking locally high-curvature regions along segment boundaries.

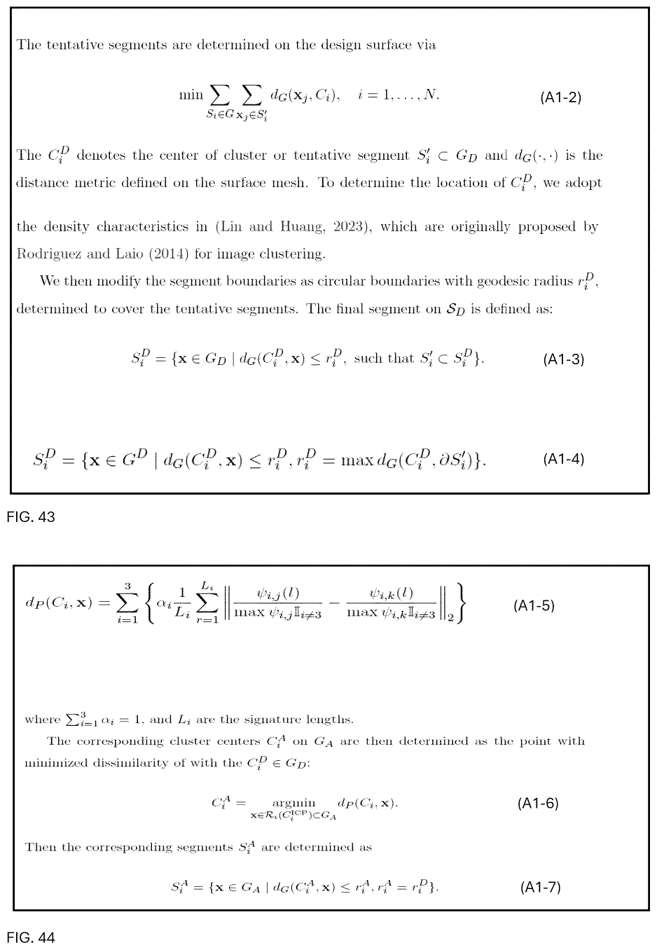

To reduce non-rigid registration errors for qualification, embodiments herein adapt and modify the deviation-aware shape segmentation method from (Lin and Huang, 2023). Tentative segments are first identified following the approach in (Lin and Huang, 2023), and their boundaries are extended to include locally high-curvature regions. In this work, embodiments herein represent surfaces SD and SA using triangle meshes, denoted as GD and GA. The design and printed shapes are pre-aligned using process-informed shape registration (Wang et al., 2022). Based on the assumption that deviation-prone, high-curvature regions require dense vertices on a mesh representation, the tentative segments are determined by clustering vertices according to their concentration on the mesh. Let x denote the vertices on GD of the design surface. See Formula A1-3 FIG. 43.

This formulation ensures that surface points or vertices along the tentative boundaries are covered by adjacent final segments. The corresponding segments on the actual product surface are determined by locating the corresponding cluster centers {CiA}N and applying the same geodesic radius.

The modified process for determining segments SD their corresponding segment SA⊂GD, i=1, . . . . N, and finding their corresponding segment SA⊂GA is outlined in the following steps.

The first step is Curvature-sensitive meshing of GD. To identify high-curvature regions, embodiments herein first extract vertices with high curvature values through curvature-sensitive remeshing. Vertex densities on the re-meshed surface GR of GD are controlled by geometric attributes such as Gaussian and mean curvature. Embodiments herein use total curvature, which is always positive. Starting from an arbitrary vertex, the remeshing iteratively samples the farthest point, with selection likelihood weighted by total curvature (Peyre and Cohen, 2006).

To reduce the computational cost of calculating geodesic distances (Lin and Huang, 2023) for determining density characteristics on GR, embodiments herein use diffusion distance for dG (·, ·) to measure the distance between vertices on the mesh. This distance is determined by modeling heat propagation on the surface manifold S (Crane et al., 2013). The diffusion distance on S is defined as dt (s, s′)=(fS (ht (s, s^{˜})−ht (s′, s″)½, where ht (s, s^{˜}) is the heat kernel that measures the amount of heat transferred from point s to point s′ over time t. The diffusion distance dt (s, s′) on GD is approximated using the method described in (Crane et al., 2013). The time parameter tis set as t=h2, where h represents the mean spacing between adjacent nodes.

The next step is Automated identification of cluster center CD. The number of clusters is determined automatically as in (Lin and Huang, 2023) without requiring the prior knowledge of the shape. Let pi and Si denote the density characteristicsof vertex i and γi=δiρi. Cluster centers are determined sequentially by selecting vertices with the highest γi. The selection is guided by the increment in the covariance of the feature vectors (ρ, δ) to ensure adequate dispersion of the cluster centers.

The density characteristic ρi is defined as the number of vertices within a fixed diffusion distance dc from vertex i, denoted as ρi=jχ(dij−dc), where χ(·) is a Heaviside step function. A higher ρi indicates that vertex i is within the core of a cluster. To account for the spatial separation of cluster centers, embodiments herein define δi as the minimum distance between vertex i and any vertex with a higher density (Rodriguez and Laio, 2014), denoted as δi=minj:ρj>ρi (dij). Thus, δi represents the radius within which vertex i has the highest local density. A larger δi increases the likelihood of vertex i being a cluster center.

The cut-off distance dc is determined by maximizing the variance of δ=(δ1, . . . , δ|VR|) as in (Lin and Huang, 2023), where |VR| is the total number of vertices on GR. The optimal dc ensures that vertices with higher p values are well isolated, such that δ effectively captures the distances between them.

The third step involves determination of the segments on SD. The resulting cluster centers on remeshed GR represent the centers of prominent features on the original shape. Embodiments herein first find their correspondence vertices on the original surface mesh GD, denoted as {CD}N, to be the centers of each tentative segments. Then the tentative segments are determined by finding the Voronoi regions of these centers (Peyr′e and Cohen, 2006). The surface points within each segment have the shortest distance to its corresponding center. Then, Embodiments herein determine the radius in Eq. (3) as the maximum diffusion distance from the center to the boundary of the tentative segment, denoted δS′k. The formulation to determine segments on GD can be summarized in Formula A1-4, FIG. 43.

The fourth step is Determination of corresponding segments on SA. The corresponding segments on the actual product surface are identified by locating the corresponding cluster centers and applying the same radius as SD. Since the shapes have already been pre-aligned using process-informed registration (Wang et al., 2022), there is no need to search for the corresponding segment centers from the entire set of vertices in GA as in (Lipman and Funkhouser, 2009; Zhao and del Castillo, 2023). Instead, embodiments herein first identify the rough regions of corresponding points using the rigid iterative closest point (ICP) registration method (Besl and Mckay, 1992). The aligned cluster centers of CD∈GD on GA are denoted as Ci ICP∈GA.

Due to the geometric complexity and intricate spatial deviation patterns, Ci ICP∈GA may not exactly correspond to the correct points. Since these cluster centers typically identify prominent geometric features, embodiments herein refine the locations by finding the points with the highest geometric similarity within the rough regions around CICP. Embodiments herein denote the small regions as Ri(CICP)={x∈GA: dG (x, Ci ICP)<r*}, where r* is the user-specified small radius to determine the size searching regions.

Within each Ri(Ci ICP), each point's local geometric structures are characterized for comparison. The wave kernel signature (WKS) (Aubry et al., 2011) is selected for its sta-bility and discriminative ability, as it remains unaffected by a shape's position, orientation, or scale. It captures the intrinsic structure of the surface by reflecting the quantum me-chanical probability of a particle being present at various points. In addition, embodiments herein construct curvature signatures (Gatzke et al., 2005) to describe the curvature distribution within a region centered at each point for comparison. Starting from a surface point s, the region is gradually expanded, and curvature statistics are computed at each step 1. The curvature signature is formed by averaging the Gaussian curvature φ1(x) and mean curvature φ2(x) within the expanded region. For i=1, 2, with A as the surface area of expansion, the signature ψi(1) is given by ψi(1)=1/A∫{dG(O,x)∈[r1−1,r1]}φi(x) dA(x).

For each surface point within Ri (Ci ICP) ∈GA, WKS, Gaussian, and mean curvature signals are constructed to compare with the signatures of the CD∈GD. The curvature signals ψi(1), i=1, 2 are rescaled to the range [−1, 1] using maximum absolute scaling to address unit disparities. With the WKS denoted as ψ3(1), the dissimilarity metric between the cluster center CD specified on the design surface and the surface points x∈Ri (Ci ICP) GA⊂GA is defined as Formula A1-5, 6, 7, FIG. 44.

### Segment-Wise Non-Rigid Registration Via Teichmuller Map

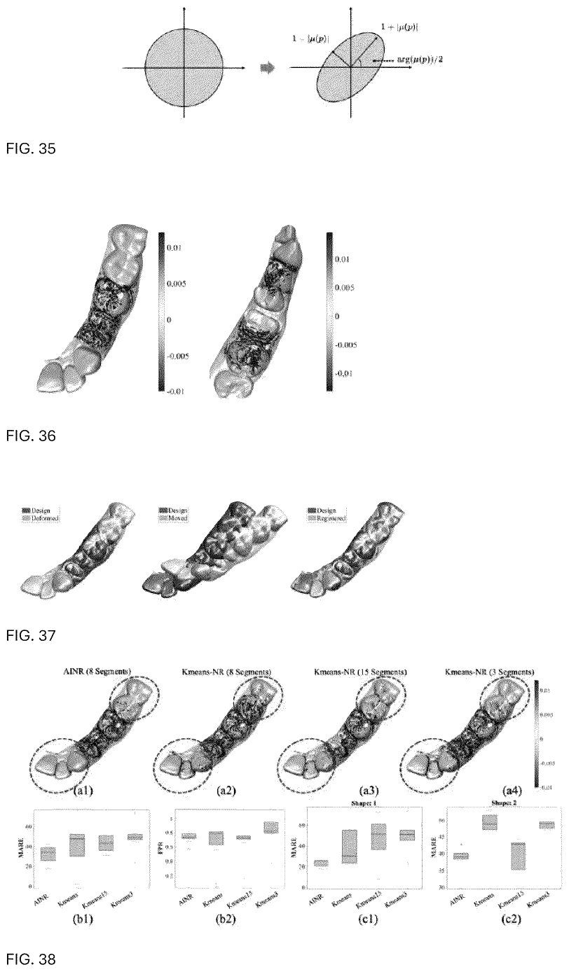

After determining the segments {SiD}N and {SiA}N on the design and actual product surfaces, Embodiments herein construct diffeomorphisms between the corresponding surface segments. Each surface segment is first conformally parameterized into a canonical 2D domain (Choi et al., 2020a). This process is denoted as φiD: SiD→DiD and φiA: SiA→DiA for the design and actual product surfaces, respectively. To capture the complex deviation patterns, the diffeomorphism hi: DiD→DiA on each segment is modeled using a quasi-conformal map (Gardiner and Lakic, 2000; Lam and Lui, 2014), a generalization of an angle-preserving conformal map. This approach is chosen because exact preservation of geometric properties such as angles, lengths, and areas between SD and SA is impractical due to the heterogeneous deviation patterns in 3D printing. The quasi-conformal map h is typically found by minimizing the maximal conformality distortion between DD and DA (Lui et al., 2014; Choi et al., 2020a). See FIG. 35.

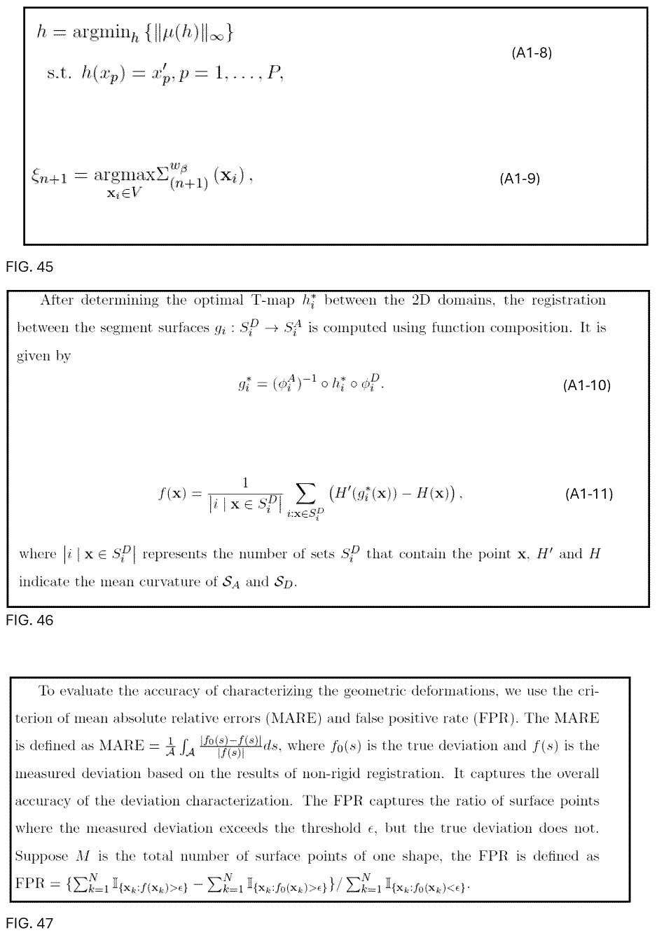

Quasi-conformal transformations map infinitesimal circles to infinitesimal ellipses with bounded conformality distortion, i.e., bounded eccentricity. Mathematically, h: C→C is quasi-conformal if it satisfies the Beltrami equation ∂h/∂z⁻=μ(z)∂h/∂z for some complex-valued function μ with ∥μ∥∞<1. This function, known as the Beltrami coefficient (BC), measures the nonconformality at each point, indicating how far the map deviates from a conformal map (Gardiner and Lakic, 2000). An illustration of how the BC measures the nonconformality of a point can be found in FIG. 3. The BC of a function h, denoted as μ(h), quantifies the conformality distortion of the map h. Embodiments herein select h as a Teichmuller map (T-map), which has been proven to be the unique solution among quasi-conformal maps, while other types, such as extremal mappings, may not be unique (Lui et al., 2014). This unique solution helps ensure consistency of product qualification. The dissimilarity metric d(·,·) in Eq. 1 is captured by the conformality distortion represented by the Beltrami coefficient (BC). Landmark constraints are imposed to reduce compromises among geometric features within a segment. The optimal T-map h* is found by solving the following objective function via QC iteration, with details available in (Lui et al., 2014; Choi et al., 2020a) as shown in Formula A1-8 FIG. 45, where xp, p=1, . . . , P are the landmarks on parameterized DD corresponding to the selected landmarks on SD (Lin and Huang, 2023), and x′ are the corresponding points on SA. In Eq. (8), landmark constraints are identified to reduce registration errors caused by the trade-off between global and local registration accuracy. Embodiments herein use the automated landmark selection method introduced in (Lin and Huang, 2023) to identify landmarks that pinpoint regions prone to deviations. These landmarks are determined within each segment using a Gaussian process (GP) landmarking framework (Gao et al., 2019; Lin and Huang, 2023) by solving Formula A1-9, FIG. 45, where ξn+1 denotes the (n+1)th landmark; and Σ((n+1) to wβ) (x) is a gaussian-curvature-weighted covariance matrix with wβ being a weight function on vertices (Lin and Huang, 2023). For computational details on obtaining the optimal T-map in Eq. (8), embodiments herein refer the readers to (Choi et al., 2020a; Lui et al., 2014).

In (Lin and Huang, 2023), the number of landmarks for each segment is determined by the ratio of the number of vertices, which can vary due to different mesh representations, even for the same geometry. To make this process more consistent for identical geometries, embodiments herein base the number of landmarks on the geometric complexity within each segment and its surface area. Complexity is quantified by the Interquartile Range (IQR) of Gaussian curva-ture values within each segment, with curvature values scaled using max normalization. If the geometric complexity exceeds a predefined threshold L, the number of landmarks is set so that one landmark is placed per 5% of the segment area, where s is predefined by users. Then, the corresponding landmarks on the actual product surface GA are determined in a manner analogous to the process used for finding the corresponding cluster centers, as introduced earlier.

After determining the optimal T-map h* between the 2D domains, the registration between the segment surfaces gi: SiD→SiA is computed using function composition. It is given by Formula A1-10 FIG. 46.

In this section, embodiments herein demonstrate the effectiveness of the proposed automated non-rigid registration framework by its ability to accurately characterize surface deviations. Embodiments herein conduct simulation studies to show that the proposed shape segmentation method accurately identifies complex synthesized geometric deformations, and embodiments herein compare it with other segmentation methods. Additionally, a case study is presented to illustrate the framework's capability to characterize subtle local geometric deviations in actual printed products using the non-rigid registration results.

This disclosure includes criteria for evaluating AINR. To validate the proposed non-rigid registration methods, embodiments herein first introduce a surface deviation characterization method based on the registration results. Surface deviations are typically represented by associating each point on the surface with its observed deviation value, such as point-to-surface distances (Decker et al., 2021). Existing methods often measure deviation along a specified direction, such as the z-axis at each point (Zang and Qiu, 2018; Wang et al., 2014). Radial distances in spherical coordinates have also been used based on point cloud transformations (Huang et al., 2015). However, these methods often overlook surface complexities. To account for deviations in all directions, the x-, y-, and z-axes can be modeled separately (del Castillo et al., 2015), but this increases dimensionality, complicating the qualification process.

To address this limitation, embodiments herein represent surface deviations by characterizing point-wise changes in geometric attributes on a surface manifold. Specifically, this approach maps each location on the surface to its point-wise differences in mean curvature. Embodiments herein chose mean curvature due to its critical role in surface reconstruction (Ye et al., 2021). As a result, the surface deviation can be represented as a univariate scalar field defined on a 2D domain, which reduces the dimensionality of the deviation representation while preserving geometric information.

### The Formulation is as Shown in Formula A1-11 FIG. 46.

Embodiments herein first manually imposed geometric deviations on two sample dental models, chosen for demonstration due to their complex geometries. The proposed method can be applied to various shapes, as it does not require prior knowledge or a training set for the computations. The imposed deformations, characterized by differences in the mean curvature values of points, are shown in FIG. 4. For the first shape, embodiments herein deformed the central parts of the dental model by flattening the local geometric details and applying elastic shrinkage deformation using the software Blender. For the second shape, the deformations were ap-plied to two separate middle sections. The objective is to demonstrate that the proposed non-rigid registration method can accurately identify and differentiate regions with and without imposed deformation.

To compare with the proposed AINR, embodiments herein also performed non-rigid registration based on shape segmentation using a common k-means shape segmentation approach, denoted as Kmeans-NR. Since k-means requires specifying the number of segments, embodiments herein tested three predefined values. The first corresponds to the number of segments automatically deter-mined by AINR. Additionally, embodiments herein tested with 3 segments and 15 segments. To control for the effects of landmark constraints across different segmentation methods, embodiments herein did not spec-ify landmark constraints in this simulation study. Non-rigid registration for each segment was conducted following the method described herein. See FIG. 37.

Since the sample shapes were deformed directly from the original design without altering their location or orientation, the input deformed mesh and the original mesh were already properly aligned in R3, as shown in the leftmost plot of FIG. 5. The experimental procedure first applied an initial transformation to the deformed shapes to simulate a realistic scenario where the initial positions of the two shapes differ, as shown in the central plot of FIG. 5. After this, embodiments herein used ICP to align the shapes, mimicking the practical process of characterizing geometric accuracy, as shown in the rightmost plot of FIG. 5. Finally, segment-wise non rigid registration was performed using various shape segmentation methods to evaluate the results.

The initial transformation matrix were set independently for the translation and rotation components. The translation parameters were randomly generated from the interval [−10, 10], while the rotation axis parameters were randomly generated from the interval [0, 1]. The angle of rotation was randomly chosen from the interval [0, π/6]. These settings ensure small initial transformations that fall within the valid range for the ICP algorithm to produce reliable registration results. For each shape, the experiments were conducted six times, with the K-means segmentation performed randomly each time.

The parameters for conducting the AINR are set as follows: the remeshing step reduces the original mesh to 3.5% of the original number of vertices, r*=0.5 for searching the corresponding segment center within small circular regions, L=0.1 and ζ=0.03 to determine the number of landmarks, and α1=0.4, α2=0.4, and α3=0.2 to calculate geometric similarity for determining segment centers. An example of the captured surface deviations, f(s), can be seen in FIG. 6. From the characterized surface deviations, it can be observed that the proposed AINR performs the best in accurately capturing the regions with and without imposed deviations, as shown in the left shape in FIG. 38.

To evaluate the accuracy of characterizing the geometric deformations, embodiments herein use the criterionof mean absolute relative errors (MARE) and false positive rate (FPR). The MARE is defined as MARE=1/A∫∥f0(s)−f(s)|/|f(s)|ds, where f0(s) is the true deviation and f(s) is the measured deviation based on the results of non-rigid registration. It captures the overall accuracy of the deviation characterization. The FPR captures the ratio of surface points where the measured deviation exceeds the threshold e, but the true deviation does not. Suppose M is the total number of surface points of one shape, the FPR is defined as:

$$\{ Σ k = 1 to N ( I \{ xk : f ( x k ) > ϵ \} - Σ k = 1 to N I \{ xkL : f 0 ( x k ) > ϵ \} \} / Σk = 1 to N I \{ xk : f 0 ( xk ) < ϵ \} .$$

The results for MARE and FPR across all trials are summarized in FIG. 38 (b1-2). The proposed AINR achieved the lowest MARE, indicating a more accurate characterization of the manually imposed deviation values, as shown in FIG. 36. The AINR also resulted in the smallest FPR, demonstrating its accuracy in identifying regions with and without geometric distortions. Additionally, the MARE for the two different sample shapes is presented separately in FIG. 38 (c1-2). It is evident that the AINR method robustly and accurately captures deviation patterns, regardless of their heterogeneity. In contrast, the performance of methods based on Kmeans shape segmentation is more sensitive to deviation heterogeneity.

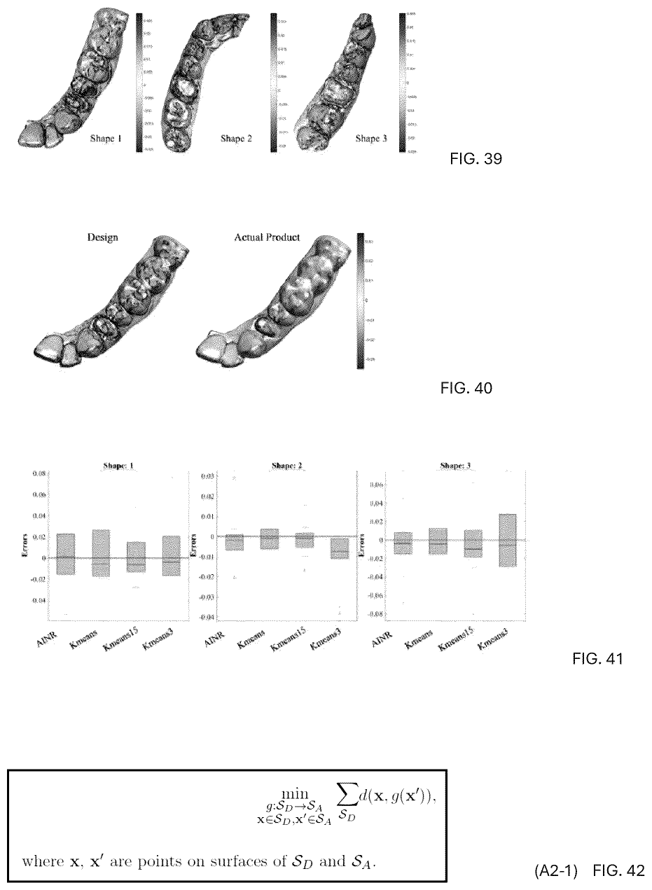

Case Study. Embodiments herein printed three dental models using the SprintRay Model Pro95 Digital Light Pro-cessing printer, SprintRay Study Model White resin, and a layer thickness of 100 μm. Embodiments herein characterize their surface deviations defined in Eq. (A1-11) at FIG. 46. Their shapes and the characterized deviations are shown in FIG. 39.

To evaluate the accuracy of deviation characterization, embodiments herein manually selected landmarks in the design and actual products and computed the differences in their mean curvature as ground truth deviation values. A total of 28, 24, and 23 landmarks were selected for each shape, respectively. An example of manually selected landmarks is shown in FIGS. 40 and 41.

Similarly to the simulation, this disclosure registered the three dental models with the actual printed products using four different segmentation methods and compared their accuracy in characterizing deviations. The parameter settings are the same as in the simulation studies. To evaluate the accuracy of the registration, the deviations calculated from the automated non-rigid registration at selected landmarks were compared to the ground truth, with the results shown in FIG. 9. The closer the difference between the automated characterized deviation and the actual deviation is to zero, the higher the accuracy of the registration. Embodiments herein observed that the proposed AINR consistently produced errors centered around zero, indicating greater accuracy compared to registrations using other segmentation methods. Although some K-means-based methods (e.g., Shape 2 segmented into 15 segments) achieved high registration accuracy, their performance was less stable due to the randomness inherent in the segmentation process.

Since geometric quality impacts the designed product form, fit, and function, the qualification and characterization of product shape deviation have increasingly become a major focus in Additive Manufacturing (AM) quality control (Ge et al., 1992; Tong et al., 2003; Navangul et al., 2013; Huang et al., 2014; Paul et al., 2014; Huang et al., 2015; Colosimo et al., 2018; Zhu et al., 2018; Qin et al., 2022; Scimone et al., 2022). The deviation characterization requires comparisons of the 3D scans of printed products to their intended designs. These comparisons, commonly known as registration, search for the optimal transformation between the scanned point cloud and its design counterpart (Li and Gu, 2004; Xu et al., 2017; Khanzadeh et al., 2018). In mass production, the characterization of a product's geometric accuracy, such as dimensional and form errors, is usually determined by aligning its features to their datum references via rigid registrations. The quality is then assessed by determining whether these features are within the specified geometric dimensioning and tolerancing (GD&T) requirements (Spitz, 1999; Tong et al., 2008; Ferreira et al., 2019; Yang et al., 2022). These conventional features, however, become insufficient for capturing geometric complexity of freeform products in AM. To assess their shape accuracy, elementary datums such as planes and cylinders (Gu and Huang, 1998; Li and Gu, 2004) are fitted and registered to compare with the pre-specified tolerancing zones (Luo et al., 2018).

However, feature extraction and datum alignment (Huang et al., 1996; Li and Gu, 2005a; Li and Gu, 2005b; Mehrad et al., 2013; Luan and Huang, 2016; Sang et al., 2021) for complex freeform products are computationally costly and inefficient (Jin et al., 2019), especially for the shapes that are too complex to be approximated by a few parametric surfaces.

An alternative approach for freeform product qualification is to characterize the deviations as transformations that map the original shapes to the deformed ones via non-rigid registrations (Shmukler and Fischer, 2010; Jadayel and Khameneifar, 2020). Unlike rigid registrations, non-rigid transformations such as diffeomorphism (Grenander and Miller, 1998; Beg et al., 2005; Glaun_es et al., 2008) are capable of capturing non-uniform deformations of complex shapes. These transformations directly encode the deformations of local regions (Rueckert et al., 2003; Zeng and Gu, 2011; Gao et al., 2019), which reduces computational costs by eliminating the need to fit numerous parametric datum features. However, the optimal solution might not adequately represent local deviations (Zeng et al., 2010; van Kaick et al., 2011) as it tends to minimize the overall or global shape registration errors such as conformal distortions (Lui et al., 2014).

To balance the trade-off between local and global registration errors, landmark constraints are imposed to specify the geometric feature correspondence (Choi and Mahadevan, 2018; Choi et al., 2020). For example, landmarks are defined as semantic or biologically important points (Roth, 1993; Zelditch et al., 2012) in anatomical shape identification and other common applications (Zeng and Gu, 2011; Choi and Mahadevan, 2018; Huang et al., 2020). These landmarks, which are typically high-curvature points, capture these corresponding features between target and source shapes and mitigate the registration errors caused by large, global shape differences. The selection of these landmarks currently relies heavily on manual identification and operator experience.

Automated landmark selection methods are preferred in AM, due to design variety and complexity; however, limited methods have been developed. Statistical model-based landmarking approaches use manually labeled landmarks on each shape and compute a mean geometry model for similar shapes (Lu and Yang, 2014; Davey and Gaetjens, 2018; Geng et al., 2023). Landmarks on a new shape are then determined by predicting their locations via the trained model.

However, training such models requires a large number of similar shapes with labeled landmarks, which is cost-prohibitive for AM. Additionally, it is difficult to use the trained model to predict the landmarks on an unseen design. Unlike the learning-based methods, down-sampling methods determine landmarks based on intrinsic geometric properties regardless of the shape. For example, Farthest Point Sampling (FPS) uniformly reduces surface points to a predetermined number of landmarks based on the geodesic distances between the points (Moenning and Dodgson, 2003). To capture detailed geometric features, FPS can adopt different weights determined by geometric properties such as the Gaussian curvature (Lipman and Funkhouser, 2009).

These down-sampling methods are designed to select landmarks that possess a space-filling characteristic, primarily for shape identification purposes. In particular, redundant landmarks would be selected on flat and smooth areas, while local, high-curvature regions prone to registration errors might be overlooked.

To reduce registration errors for AM products, embodiments herein propose to select landmarks that are indicative of surface regions prone to deviations. These regions are often associated with high curvatures (Zhang et al., 2015; Biegler et al., 2018), such as curvy ridges, grooves, and cusps. To identify these regions, a promising automatic landmarking approach is Gaussian process landmarking (Liang and Paisley, 2015; Gao et al., 2018; Gao et al., 2019), which sequentially identifies points with the highest curvature. It has been successfully utilized in identifying biologically significant landmarks (Roth, 1993; Zelditch et al., 2012) on anatomical structures, such as bones. These structures typically exhibit a limited number of geometric features formed by points with high curvatures. However, this approach tends to produce landmarks concentrating on prominent features with extreme curvature values, neglecting other featurees with locally high curvatures. Consequently, local deviations may not be adequately captured, leading to registration inaccuracy.

To reduce the redundant landmarks surrounding prominent features, embodiments herein propose to identify and isolate these high curvature regions through surface segmentation. Although traditional semantic shape segmentation tends to group points based on curvature similarity (Liu and Zhang, 2004; Lavou_e and Wolf, 2008), our objective is to preserve high curvature vertices within each segment. This is designed to maintain the intrinsic structure of the deviation-prone regions during landmark selection. Therefore, rather than comparing curvature similarities across all vertices, embodiments herein form segments by clustering vertices with high curvatures that are in close proximity on the product surface. In summary, the proposed method intends to (i) mitigate global and local registration errors by selecting landmarks indicative of deviation-prone regions; (ii) address imbalanced landmark distributions on complex shapes through deviation-aware segmentation; and (iii) identify deviation-prone regions across diverse designs by leveraging the curvature distribution on a shape's surface.

Following the introduction, embodiments herein detail the proposed automated landmark selection framework in Section 2 and demonstrate the developed method with printed dental models in Section 3. Embodiments herein compare the selection results of the proposed approach to other widely used automatic landmarking methods. Embodiments herein also evaluate and compare the effectiveness of selected landmarks with a new evaluation criterion through registration. Conclusions are summarized herein.

### Automated Deviation-Aware Active Landmark Selection

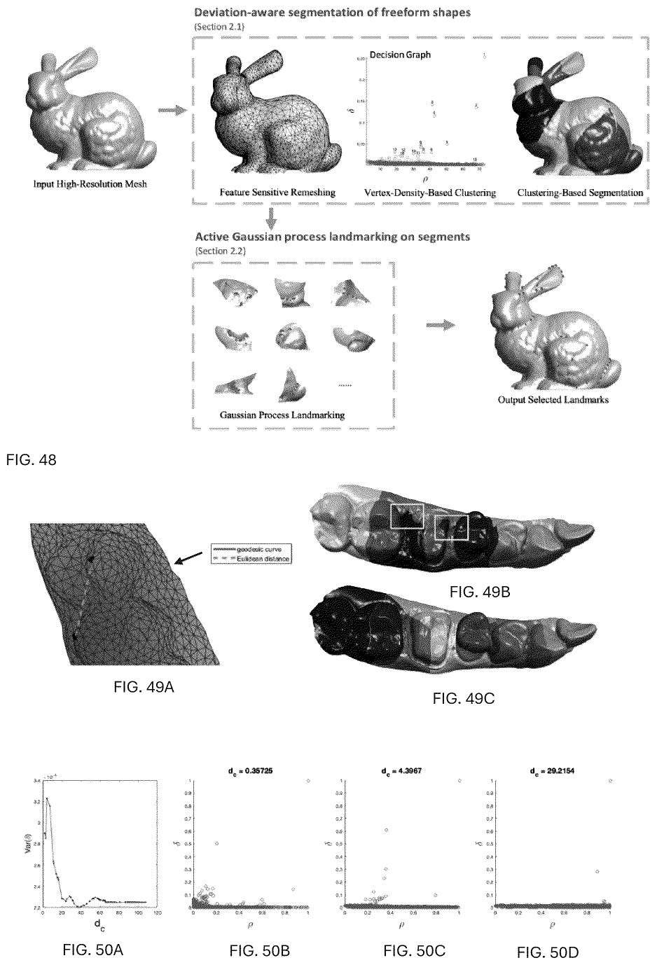

To automatically identify the deviation-prone regions with balanced landmarks, embodiments herein propose to segment a freeform design into high-curvature regions. Curvature-sensitive remeshing of a product design is conducted first to extract points with high curvatures and filtering out the low curvature details. The segmentation process then automatically clusters the extracted vertices based on vertex density characteristics. Within each segment or region, embodiments herein choose a curvature-weighted function within the active learning scheme (Gao et al., 2019) to prioritize the capture of locally complex geometries. The procedure of the proposed partition-based automated landmarking method for complex freeform designs is illustrated in FIG. 48. Furthermore, embodiments herein introduce a new evaluation criterion to examine the effectiveness of the selected landmarks through registration.

In the following sections, embodiments herein elaborate the proposed method based on the triangular mesh G=(V,E,F) which is a discretized 2D surface manifold embedded in R3.

Theoretically, the proposed method could be applied to point cloud data and other shape representations since embodiments herein mainly utilize the intrinsic geometric properties. Shape segmentation has been extensively studied in engineering design (Gu and Huang, 1998; Woo et al., 2002; Agathos et al., 2007; Anwer and Mathieu, 2016; Taghizadeh et al., 2019; Romanengo et al., 2022) and computer vision (Theologou et al., 2015; Sharma and Suji, 2016) for semantic feature extraction. Although supervised models can be employed to identify the prominent features, they necessitate large labeled training datasets that specifically cater to these features (Kalogerakis et al., 2010; Kalogerakis et al., 2017). However, due to the large variety of designs in AM, obtaining such labeled data poses significant challenges. As an alternative, unsupervised segmentation methods are preferred, as they do not rely on explicit training sets. Existing unsupervised segmentation methods often focus on either detecting sharp features as boundaries (Katz and Tal, 2003; Golovinskiy and Funkhouser, 2008) or clustering points/vertices for semantic feature identification (Liu and Zhang, 2004; Yamauchi et al., 2005; Lavoue and Wolf, 2008; Shapira et al., 2008). These approaches commonly employ similarity metrics to cluster vertices based on their homogeneous geo-metric attributes, such as mesh normals and mesh face angles. Consequently, high-curvature features such as prongs, valleys, and creases often emerge as boundaries shared by adjacent segments, due to drastic changes of attribute values therein. Moreover, these methods often require prior knowledge of the shape to determine the number of clusters, which can be costly to obtain in AM, due to large design variety.

To reduce non-rigid registration errors for complex geometries, embodiments herein propose to segment a 3D surface into deviation-prone or high-curvature regions for balanced landmarks. Since these regions require dense vertices on a mesh representation, the shape segmentation for registration is formulated as a vertex clustering problem based on the concentration of vertices on a mesh as shown in the Formula A2-1 of FIG. 57, where MR is a surface mesh containing vertices xj and Ck denotes the center of the cluster or segment Sk.

To automatically determine the location of Ck, embodiments herein extend the density characteristics initially proposed by Rodriguez and Laio (2014) for image clustering. However, in Rodriguez and Laio (2014), the density is calculated based on the similarity among images and the number of clusters needs to be manually determined. To incorporate the density characteristics in vertex clustering on a mesh, embodiments herein select the geodesic distance metric (Lin et al., 2020) and propose a greedy search algorithm to identify the optimal neighborhood size for calculating vertex density. Furthermore, embodiments herein automate the determination of the number of cluster centers N by identifying the local maxima of vertex density with the highest dispersion. The process of constructing and solving (1) is outlined below.

### Curvature-Sensitive Remeshing for MR and Distance Metric

To effectively extract the vertices with high curvatures, embodiments herein first re-mesh the design surface into a low resolution mesh MR for computation efficiency. The vertex densities in different regions on MR are controlled by a filter τ(x) which is pre-defined based on the geometric attributes of each vertex τ(x), such as the Gaussian curvature and mean curvature.

Starting with an arbitrary vertex, and the remeshing process iteratively samples the farthest point using a distance weighted by τ(x), and vertices with higher τ(x), are more likely to be chosen. Further remeshing details can be found in (Peyre and Cohen, 2005, 2006, 2009).

Embodiments herein choose the geodesic distance metric to measure the distance d (·, ·) between two vertices on mesh MR (Lin et al., 2020). Comparing to Euclidean distance in R3, geodesic distance better captures the geometric structure of the surface, as illustrated in FIG. 49A. Moreover, FIG. 49B demonstrates that the Euclidean distance metric would lead to mis-identification of vertex clusters on surfaces with complex geometric structures. In this study, embodiments herein adopt the method in Surazhsky et al. (2005) to calculate the approximated geodesic distances on triangular meshes. See FIG. 49C.

### Automated Identification of Cluster Center Ck Using Vertex Density

The problem of automatic determination of the number and location of cluster centers is formulated as Formula A2-2, FIG. 58.

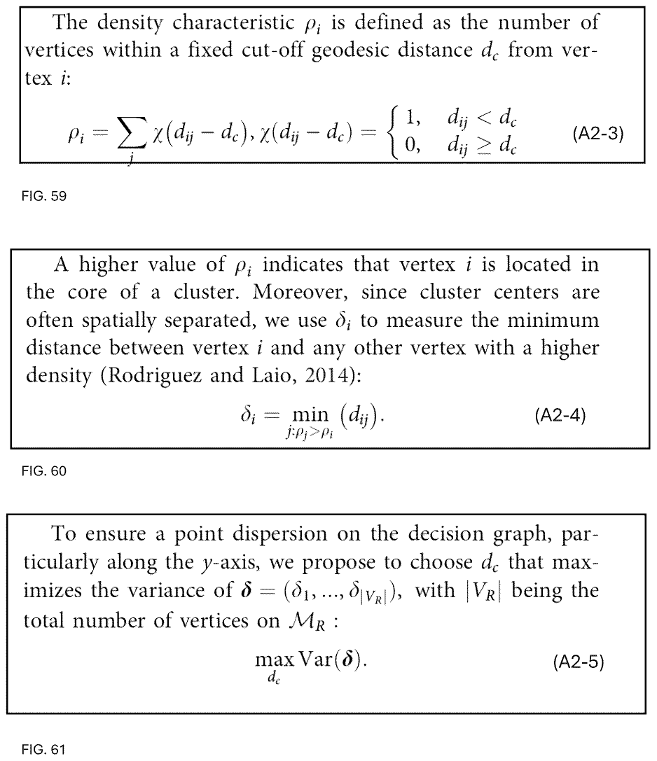

Embodiments herein sequentially select the vertices with the highest values of γi: The variability among density characteristics of selected cluster centers, which is quantified by the covariance matrix of the feature vector (ρ, δ) is employed as the increment-based stopping criterion to ensure the dispersion of cluster centers. See Formula A2-3, FIG. 59; Formula A2-4, FIG. 60

In essence, δ i represents the radius within which vertex I exhibits the highest local density. A larger value of δ i indicates that vertex i has the highest density over a larger range, thereby increasing the likelihood of it being a cluster center.

Based on these density characteristics, cluster centers are selected to maximize both the density ρ and δ, i.e., maximizing their product γ=ρδ, ρ, δ∈R+in Formula (A2-2). This corresponds to choosing cluster centers in the upper-right area of a decision graph (Rodriguez and Laio, 2014), with the x-axis representing q and the y-axis representing δ: However, the determination of cluster centers relies heavily on the cut-off distance δc, which directly affects the vertex density characteristics ρ and δ. Rodriguez and Laio (2014) set δc as 1-2% smallest distance among all pairs of images and claim its robustness for image clustering.

However, on surface meshes, the values of ρ and δ for each vertex are sensitive to δc. As illustrated in FIGS. 50B and 50D, when the parameter dc is set to a small value, the density q becomes too small for most vertices, leading δi to primarily capture proximity to its adjacent vertices. Conversely, if δc is set to a large value, the density p becomes uniformly high for the majority of vertices, causing δi to only capture its adjacent vertices as well. Ideally, vertices with the local maximal ρ should have distinguishable δ values on the decision graph, as shown in FIG. 50C indicating that the density peaks are spatially isolated from each other. See Formula A2-5 FIG. 61

The correlation between δc and corresponding Var (δ) is shown in FIG. 50A. With the optimal δc, the vertices with higher ρ values are most isolated from each other, enabling the δ values to effectively capture the distances among them.

### Projecting Sk to the Original Design Mesh

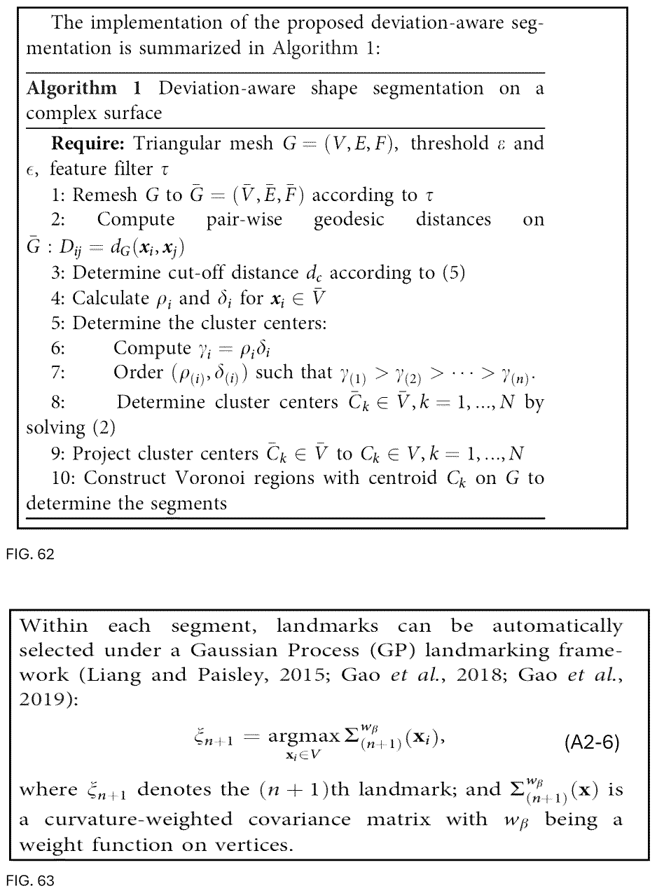

The resulting cluster centers represent the centers of prominent features on the original shape. To segment on the original shape, embodiments herein project the locations of these cluster centers Ck onto it. The remaining vertices on the original mesh are assigned to the cluster with the shortest geodesic distance to form segment Sk: This process is similar to determining the Voronoi regions of pre-defined centers (Peyr′e and Cohen, 2006). The computation burden is reduced significantly since it only requires calculating and comparing the geodesic distance between each vertex and the cluster centers. See App. 2 Algorithm 1, FIG. 62.

Within each segment, landmarks can be automatically selected under a Gaussian Process (GP) landmarking frame-work (Liang and Paisley, 2015; Gao et al., 2018; Gao et al., 2019) as shown Formula A2-6 FIG. 63.

The choice of wβ reflects the preference of landmark points. Points with higher wβ values are more likely to be selected. Originally developed for anatomical shape identifi-cation (Gao et al., 2018; Gao et al., 2019), wβ captures both overall surface bending (e.g., smooth ridges) indicated by mean curvature, and small-scale high-curvature structures (e.g., cusps) indicated by Gaussian curvature.

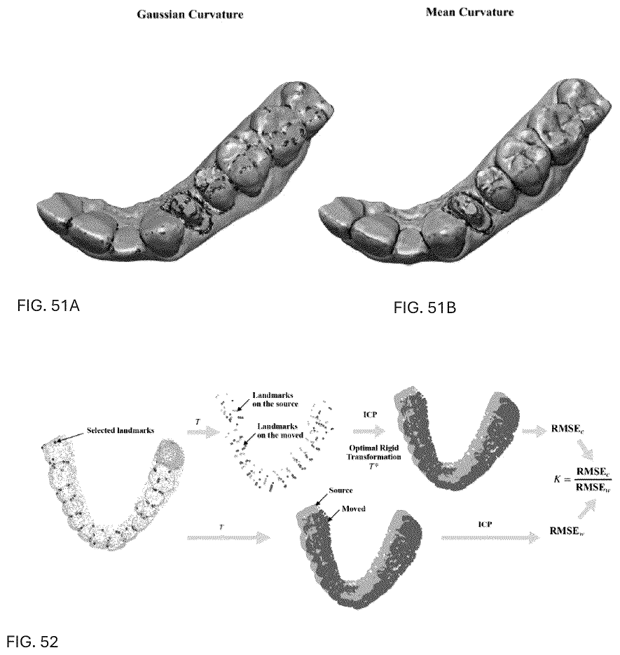

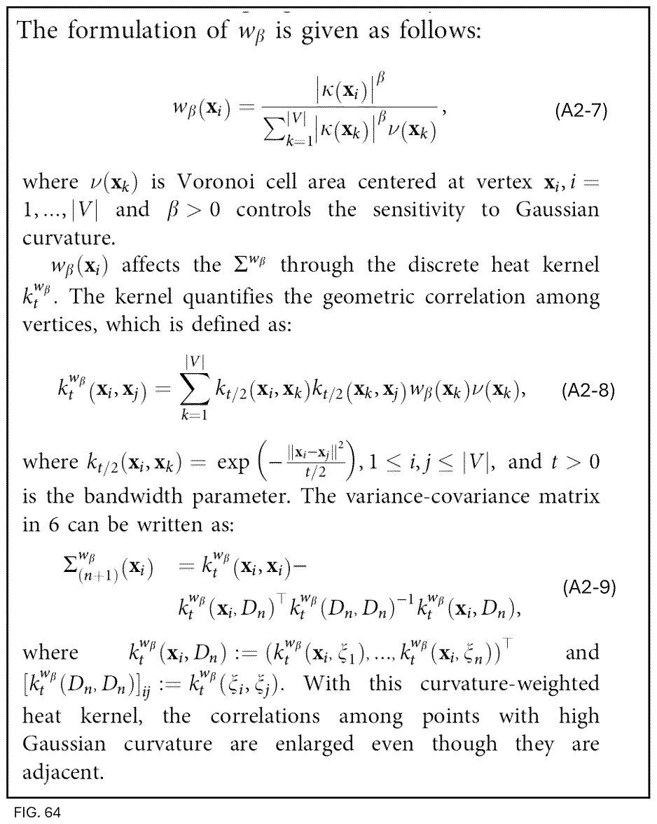

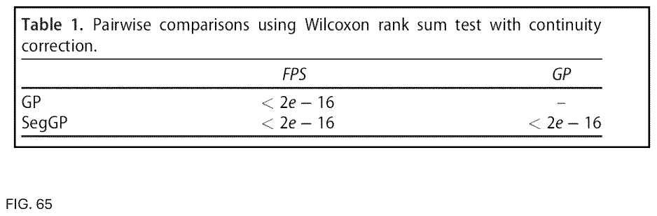

In this work, embodiments herein prefer to identify local regions that contribute to non-uniform deviations. Therefore, embodiments herein choose Gaussian-curvature-weighted wβ to prioritize the identification of small-scale high-curvature structures. FIGS. 51A, 51B illustrates the distributions of mean curvatures and Gaussian curvatures within the same shape. It can be seen that high Gaussian curvature values highlight the locally intricate geometries. The formulation of wβ is as shown in Formula A2-7 FIG. 64.

Currently, the number of landmarks for each segment has to been predefined in order to establish a stop criterion for the selection process. Embodiments herein employ an empirical approach to assign a total number of landmarks based on the surface area of the shape. Regarding landmarks within each segment, embodiments herein assign them proportionally according to the ratio of the number of vertices within the segment to the total number of vertices in the shape. This assignment accounts for the complexity of the geometries, ensuring that segments with intricate geometries are adequately represented by a sufficient number of landmarks.

### Criterion and Method to Assess the Effectiveness of Landmarking

Embodiments herein devise a criterion and method to evaluate whether the selected landmarks can effectively capture the product deviation during registration. Although some studies assess the performance of automatic landmarking methods by comparing the automatically selected landmarks with those chosen by experts (Gao et al., 2019), there is currently no established criterion for evaluating the effectiveness of land-marks for accurate registration. The basic idea is to compare the rigid alignment errors of two identical shapes between the entire shape and only landmarks. Since the shapes to be aligned are exactly the same, the alignment errors should be close to zero ideally if directly aligning the whole shapes (all points). However, alignment errors occur because the complex geometries stop the algorithm at the local optimal solution, especially in the deviation-prone regions. If the landmarks contain sufficient information about these areas, the transformation obtained by aligning just the selected landmarks could reduce the alignment errors of aligning the entire shapes.

The transformation or the alignment is achieved by the well-studied Iterative Closest Point (ICP) registration algo-rithm (Besl and Mckay, 1992), which is proved to be robust if the shapes are initially close enough. The proposed evalu-ation procedure is shown in FIG. 5 and as follows:

Apply an small initial random translation T to a 3D shape and their landmarks.

Use the ICP algorithm to align the two pairs of point clouds (source shape/landmarks and moved shape/land-marks) separately. Apply the resulted optimal transformation of aligning the entire source and moved shape T for alignment, cal-culating the Root-Mean-Square Error (RMSE) as RMSEw.

Apply the resulted optimal transformation of aligning source and moved landmarks T* to align the entire point clouds, calculating the RMSE (denote as RMSEc).

$$Calculate K = RMSEc / RMSEw for evaluation .$$

The effectiveness of the selected landmarks can be evaluated by comparing the RMSEc with the RMSEw. The RMSEw serves as the control group and is obtained by directly registering the entire point cloud using the same initial random transformation. To assess the effectiveness of the landmarks, embodiments herein compute the ratio K=RMSEc/RMSEw. A value of K less than or equal to 1 indicates that the overall error of the landmark-based alignment is even smaller than the error resulting from directly registering the entire point cloud. This observation suggests that the selected landmark set contains the most informative points and offers a superior representation of deviation-prone regions.

### Methodology Validation and Application

In this section, embodiments herein evaluate the effectiveness of the proposed segment-based Gaussian process landmarking (SegGP) method on dental models. Embodiments herein compare the landmarks selected by SegGP with those obtained using the FPS approach, which incorporates Gaussian curvature weights, as well as Gaussian process landmarking without segmentation (GP). To assess the quality of the selected landmarks, embodiments herein utilize the proposed ICP-based evaluation criterion and conduct a statistical analysis to compare their performances.

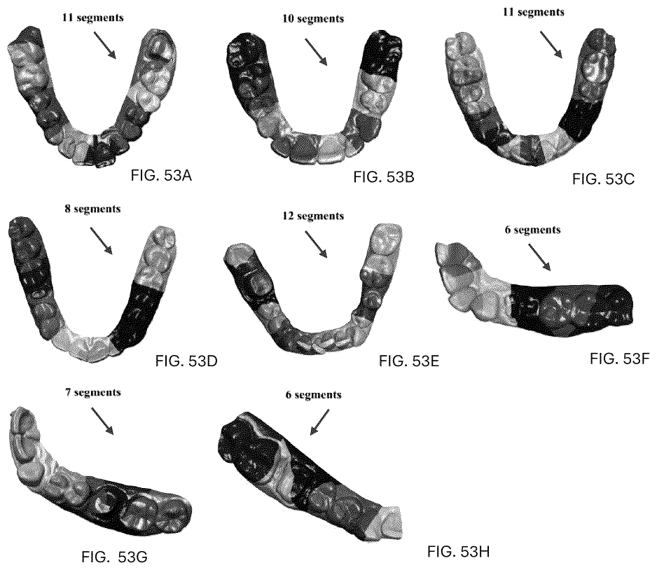

In the experiments, embodiments herein tested eight teeth models, which include five sets of whole teeth models and three sets of half teeth models. The segmentation results are shown in FIGS. 53A-53H. The number of curvature-preserving re-meshed meshes was set to be 3% of the original mesh vertices. And embodiments herein utilized the total curvature as the feature filter, defined as τ(x)=|kmax(x)|+|kmin(x)|, where kmaz and kmin represent the principal curvatures. By taking the absolute values of the principal curvatures, the magnitude directly reflects the extent to which the curved surface deviates from a plane. The parameters used to determine the cluster centers in Algorithm A2-1 were set as ϵ=10⁻³ and ϵ=0.05. Within each segment, embodiments herein performed GP landmarking with β=1 in Formula A2-7.

The Initial Landmark was Determined to have the Largest Value of w β.

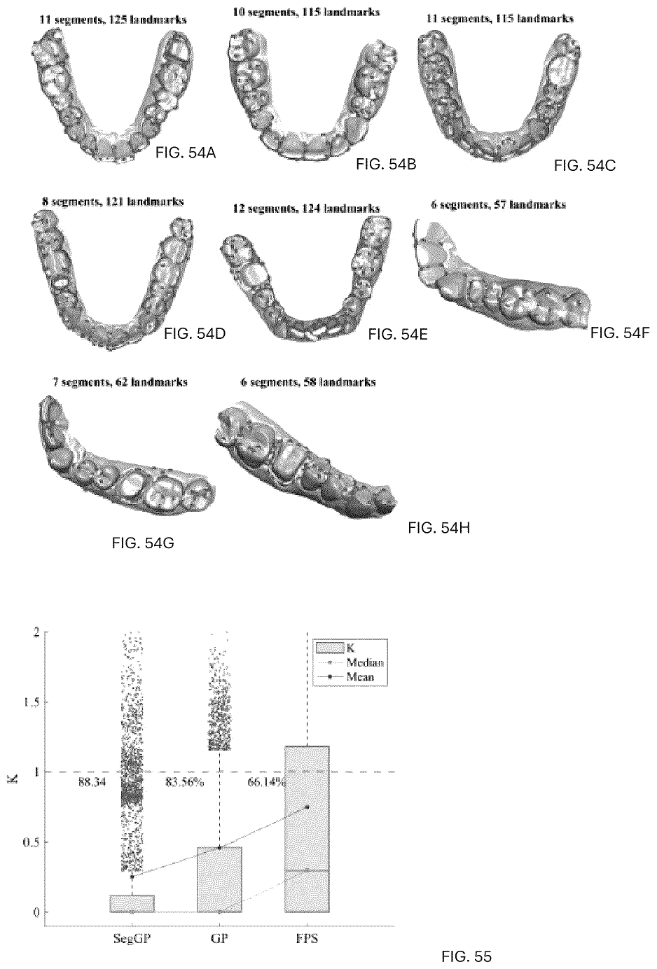

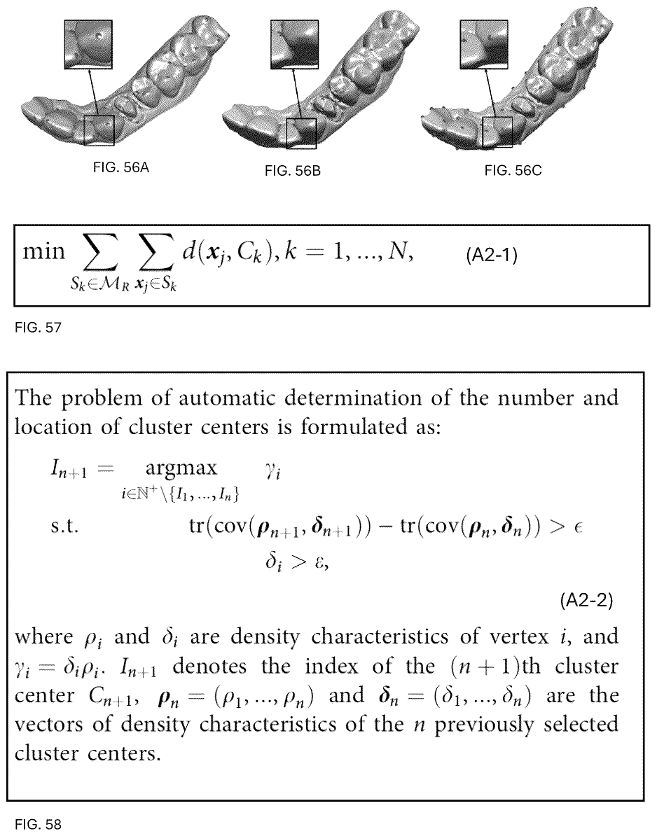

FIG. 6 shows the segmentation results on the teeth models. The center of each segment is the prominent geometries with extreme curvatures, such as the edges between teeth and pits for dentures. These are the deviation-prone regions that might lead to bias on the non-rigid registration for deviation characterization. Based on the deviation-aware segmentation, the SegGP landmarking results are presented in FIG. 54A-54H. The numbers of selected landmarks are 125, 115, 115, 121, 124, 57, 62 and 58 from left to right, top to bottom. Embodiments herein can observe that selected landmarks are on the cusps, curvy ridges and grooves, where deviation tends to occur. FIGS. 56A-56C compare the landmarks selected by SegGP with GP and FPS. The landmarks selected by FPS tend to fill the manifold, but fail to capture the high-curvature geometries sufficiently. GP could select landmarks with extreme geometries better compared with FPS. However, GP-selected landmarks tend to concentrate primarily around prominent geometric features, such as the fifth tooth from the left, and disregard other deviation-prone regions compared with SegGP. Overall, partition-based landmarking has better flexibility to determine adequate and balanced landmarks in local regions.

### Comparison of Landmark Effectiveness

To evaluate and compare the effectiveness of landmarks selected by different methods, embodiments herein utilized the evaluation criterion described above on each set of landmarks. The parameters in the initial transformation matrix were set independently for the translation matrix and the rotation matrix. The parameters in the translation matrix were randomly generated from the interval [−3, 3] whereas the parameters of the rotation axis are randomly generated from the interval [0, 1]. The angle of rotation was randomly chosen from the interval [0, ω̅/6]. These parameter settings ensure small initial transformations, which are within the valid range for the ICP algorithm to produce reliable registration results.

Embodiments herein conducted 1000 experimental runs of the ICP-based evaluation process for each landmarking method (see FIG. 54B). SegGP consistently outperformed GP and FPS, as evidenced by its smaller K values. Moreover, SegGP exhibited the largest proportion of K1, indicating that the selected landmarks robustly represent the original shape.

To statistically compare the K values of different methods, embodiments herein performed a one-way analysis of variance (ANOVA). Since the Kolmogorov-Smirnov normality test (Gross and Ligges, 2015) revealed that the data did not follow a normal distribution (p<2:2e-16), embodiments herein conducted a Kruskal-Wallis test (Chan and Walmsley, 1997) to compare the mean ranks. The test yielded a significant result with X2=2483.8 and p<2.2e-16, indicating that the K values varied among the different methods. To identify the specific methods that differed from one another, embodiments herein conducted pair-wise comparisons using the Wilcoxon rank sum test, with Bonferroni correction for multiple comparisons. The resulting p values are presented in Table 1, supporting our conclusion that there are significant differences in the K values obtained from the different methods.

Embodiments of this Disclosure Include:

A computer implemented method of assessing accuracy of a three-dimensional (3D) print from a design file representing the 3D print, the method comprising identifying geometric feature correspondences between the 3D print and the design file by utilizing a computer with a processor to implement software steps comprising representing the 3D print and the design file in a respective actual print digital mesh and a design digital mesh; parsing the design digital mesh into respective sets of tentative segments having tentative boundaries; determining respective centers of the tentative segments; defining the tentative boundaries of the tentative segments to incorporate respective regions of high curvature along surfaces of the respective meshes, wherein the tentative boundaries meet a density threshold of vertices on the surface; defining design segments by modifying the tentative boundaries to encompass circular boundaries with a geodesic radius that minimizes a sum of distances between points within the tentative boundaries to a respective center of a respective tentative segment; locating corresponding segments in the actual print digital mesh and defining print boundaries with the geodesic radius from the circular boundaries; and calculating diffeomorphisms between the design segments and the corresponding segments on the actual print digital mesh to complete non-rigid registration between the actual print digital mesh and the design digital mesh; and identifying deviations between the digital meshes by calculating a dissimilarity metric between the meshes.

Embodiments further comprise pre-aligning the actual print digital mesh and the design digital mesh before parsing the design digital mesh.

Embodiments further comprise determining tentative segments by clustering vertices according to a concentration of the vertices on the mesh.

Embodiments further comprise modifying the tentative boundaries comprises allowing overlapping of the circular boundaries.

Embodiments further comprise wherein determining regions of high curvature comprises a curvature-sensitive remeshing to determine total curvature of a segment.

Embodiments further comprise wherein the total curvature is calculated on a triangle mesh.

Embodiments further comprise wherein locating corresponding segments in the actual print digital mesh comprises comparing segments from the design digital mesh with the actual print digital mesh according to wave kernel signature comparison.

Embodiments further comprise further comprising computing the respective signatures of the meshes by calculating a curvature signature formed by averaging a Gaussian curvature and mean curvature.

Embodiments further comprise wherein calculating the diffeomorphism comprises utilizing an intrinsic registration process comprising steps including converting the respective actual print digital mesh and a design digital mesh to canonical 2D domains.

Embodiments further comprise further comprising calculating the diffeomorphism with conformal mapping to achieve surface parameterization of the meshes.

Embodiments further comprise wherein the conformal mapping further comprises iteratively minimizing at least one of area, distance, or angles between the meshes and the 2D domains.

Embodiments further comprise wherein calculating the diffeomorphism comprises applying landmark constraints to the non-rigid registration.

Embodiments further comprise wherein assessing accuracy between the three-dimensional (3D) print and the design file representing the 3D print comprises iteratively calculating the diffeomorphism with the landmark constraints to form a Teichmuiller map (T-map).

Embodiments further comprise wherein the T-map comprises conformality distortion represented by a Beltrami coefficient calculated for the T-map.

Embodiments further comprise wherein identifying the regions of high curvature comprises identifying local maxima of vertex density with the highest dispersion of vertices.

Embodiments further comprise wherein defining the tentative boundaries of the tentative segments comprises assigning respective vertices of the design digital mesh to a cluster of vertices having the shortest geodesic distance from the center of the respective tentative boundary.

Embodiments further comprise wherein identifying landmark constraints comprises compiling a covariance matrix of a feature vector having elements representing vectors of density characteristics of incremental clusters of vertices.

Embodiments further comprise wherein the density characteristics comprise rho and delta, wherein rho is defined as the number of vertices within a fixed cut-off geodesic distance from a cluster center to a given vertex and delta is defined as a radius within which the given vertex maximizes a vertex density within a tentative segment.

Embodiments further comprise wherein identifying the landmark constraints comprises iteratively identifying the landmark constraints until a variability value among density characteristics meets a threshold value to stop incrementing the iterative process calculating the diffeomorphism with the landmark constraints to form a Teichmuiller map (T-map).

Another embodiment is a computer implemented method of electronically modeling a surface of an object with a plurality of virtual surface patches, the method comprising assigning to the object a plurality of geometric descriptors implemented in software stored in memory of a computer, by which the computer evaluates smoothness of respective groups of surface points on a surface of the object; using a processor having access to the memory of the computer to identify the respective groups of surface points as bounded surface patches by performing steps comprising identifying critical points across the surface of the object as local extremes of curvature on the surface; using the critical points as geometric centers of potential surface patches to be evaluated by the software; adding new surface points to a respective potential surface patch by evaluating neighboring surface points relative to a respective geometric center; continuing to add the new surface points to the respective potential surface patch until neighboring surface points indicate changes in smoothness according to the geometric descriptors, wherein the changes in smoothness define corresponding perimeters of the bounded surface patches; and iteratively evaluating the groups of surface points for potential surface patches until the object has been modeled with bounded surface patches.

Embodiments further comprise wherein identifying the respective groups of surface points as bounded surface patches comprises identifying mating perimeters of the bounded surface patches that collectively cover the entirety of the object.

Embodiments further comprise wherein assigning the geometric descriptors comprises using a Gaussian curvature K, mean curvature H, and surface normals for the surface of the object.

Embodiments further comprise wherein the changes of smoothness are measured with a Laplacian-Beltrami (LB) operator.

Embodiments further comprise wherein measuring changes of smoothness with the LB operator comprises calculating a rate at which a function defining the surface spreads out from the surface points.

Embodiments further comprise wherein the function defining the surface is modeled as a triangle mesh and the LB is calculated as the function's value at a point on the mesh relative to a local average of the function surrounding the point on the mesh.

Embodiments further comprise wherein using the critical points as geometric centers comprises iteratively locating sequential geometric centers for subsequent potential surface patches by maximizing a distance between a respectively sequential geometric center and all points of the bounded surface patches.

Embodiments further comprise wherein maximizing the distance comprises maximizing an angle (φ) between a z-axis of a coordinate system of the object and a surface normal extending from a surface point estimated as the sequential geometric center

Embodiments further comprise calculating centroids of potential surfaces patches that define flat regions that do not have critical points.

Embodiments further comprise identifying flat regions as groups of surface points with Gaussian curvature values that are approximately zero.

In another embodiment, a computer implemented method includes using a computer, having a processor and computer readable memory storing surface patch analysis software, to perform steps comprising identifying geometric dissimilarity values among respective surface patches extracted from 3D objects; calculating surface patch deviation patterns from the geometric dissimilarity values; clustering the surface patches into a finite number of surface patch groupings exhibiting patch deviation patterns with categorization criteria that match within a tolerance threshold; saving, in the computer readable memory, the surface patch groupings as distinct objects within a digital surface patch library.

Embodiments further comprise extracting the respective surface patches according to changes in surface smoothness of respective 3D objects, wherein the changes in smoothness are identified according to geometric descriptors comprising at least one of Gaussian curvature, mean curvature, or surface normals.

Embodiments further comprise wherein extracting the respective surface patches further comprises identifying groups of surface points as bounded surface patches by performing steps comprising identifying critical points across the surface of the object as local extremes of curvature on the surface; using the critical points as geometric centers of potential surface patches to be evaluated by the software; adding new surface points to a respective potential surface patch by evaluating neighboring surface points relative to a respective geometric center; continuing to add the new surface points to the respective potential surface patch until neighboring surface points indicate changes in smoothness according to the geometric descriptors, wherein the changes in smoothness define corresponding perimeters of the bounded surface patches; and iteratively evaluating the groups of surface points for potential surface patches until the entire surface of the respective 3D object has been modeled with bounded surface patches.

Embodiments further comprise identifying geometric dissimilarity values comprises assigning a wave kernel signature to the respective surface patches and evaluating differences among the wave kernel signatures.

Embodiments further comprise wherein identifying geometric dissimilarity values comprises assigning a curvature signature to the respective surface patches and evaluating differences among the curvature signatures.

Embodiments further comprise wherein identifying geometric dissimilarity values comprises assigning a wave kernel signature and a curvature signature to the respective surface patches and evaluating differences between the wave kernel signatures and the curvature signatures; and calculating surface patch deviation patterns comprises calculating point-wise curvature changes in the respective surface patches.

Embodiments further comprise wherein clustering the surface patches comprises matching the categorization criteria according to a number of critical points in a respective surface patch.

Embodiments further comprise wherein clustering the surface patches comprises matching the categorization criteria according to a curvature sign at surface points.

Embodiments further comprise wherein clustering the surface patches comprises matching the categorization criteria according to whether critical points in the surface patches are differentiable from a surface gradient or non-differentiable with surface points having no surface gradient.

Embodiments further comprise wherein clustering the surface patches comprises assigning differentiable critical points to a group with smooth surface patches and assigning non-differentiable surface patches to a group with non-smooth surface patches.

Embodiments further comprise wherein clustering the surface patches comprises calculating, for the respective surface patches, a deviation function based on point-wise differences in mean curvatures across the respective surface patch.

Embodiments further comprise wherein calculating the deviation function comprises expressing the deviation function as a 2D deviation function that is invariant to covariates of the respective surfaced patches.

Embodiments further comprise wherein the covariates are patch size, printing location, and printing orientation, and the deviation function is invariant to the covariates.

Embodiments further comprise assigning coefficients to the deviation function such that the deviation function remains invariant to the covariates.

Embodiments further comprise clustering the surface patches according to categorization criteria comprises calculating a Calinski-Harabasz Index (CH Index).

Embodiments further comprise wherein saving the surface patch groupings further comprises saving metadata associated with each surface patch.

Embodiments further comprise wherein saving metadata comprises saving printing outcome data.

In another embodiment, a computer implemented method for printing 3D objects, the method comprising accessing, with a computer having a processor and computer memory, surface patch groupings saved as distinct objects within a digital surface patch library, wherein the distinct objects comprise deviation functions corresponding to surface patches within the respective surface patch groupings; comparing the surface patch groupings with sections of a printing design or a point cloud object for a respective 3D surface; assigning respective sections of the respective 3D surface to one of the surface patch groupings; for the respective sections, selecting a matched surface patch from an assigned surface patch grouping; iteratively selecting matched surface patches for the respective sections until an entirety of the respective 3D object is modeled with matched surface patches; printing the 3D object according to the matched surface patches; and determining an accuracy measure for the 3D object as printed from the matched surface patches.

Embodiments further comprise wherein selecting a matched surface patch comprises calculating a deviation function based on point-wise differences in mean curvatures across the respective sections and selecting a matched surface patch from the library having a corresponding deviation function.

Embodiments further comprise wherein determining an accuracy measure comprises registering a printed version of the 3D object with a design file of the 3D object to assess accuracy in the printing using matches surface patches.

Embodiments further comprise saving the accuracy measure associated with the printing in the memory of the computer.

Embodiments further comprise storing deviation functions for surface patches that model whole shapes of additional 3D objects; and importing accuracy measures calculated after printing the additional 3D objects from matched surface patches.

Embodiments further comprise iteratively saving respective accuracy measures for subsequent printings to develop a machine learning model to predict accuracy of printing over time.

Embodiments further comprise training the machine learning model with updated deviation functions and additional accuracy measures with printing samples over time.

Embodiments further comprise generating, based on the machine learning model and design files, predictions for accuracy measures for prints from the design files.

Embodiments further comprise generating, based on the machine learning model and design files, predictions for deviation patterns in printed objects.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. While implementations will be described for steering wheel hand detection systems, it will become evident to those skilled in the art that the implementations are not limited thereto.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The figures utilize an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

In its most basic configuration, a computing device typically includes at least one processing unit and memory. Depending on the exact configuration and type of computing device, memory may be volatile (such as random access memory (RAM)), non-volatile (such as read-only memory (ROM), flash memory, etc.), or some combination of the two.

Computing devices may have additional features/functionality. For example, computing device may include additional storage (removable and/or non-removable) including, but not limited to, magnetic or optical disks or tape. Such additional storage is illustrated in FIG. 2 by removable storage and non-removable storage.

Computing device typically includes a variety of computer readable media. Computer readable media can be any available media that can be accessed by the device and includes both volatile and non-volatile media, removable and non-removable media.

Computer storage media include volatile and non-volatile, and removable and non-removable media implemented in any method or technology for storage of information such as computer readable instructions, data structures, program modules or other data. Memory, removable storage, and non-removable storage are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device. Any such computer storage media may be part of computing device.

Computing device 200 may contain communication connection(s) that allow the device to communicate with other devices. Computing device may also have input device(s) such as a keyboard, mouse, pen, voice input device, touch input device, etc. Output device(s) such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as CD-ROMs, hard drives, or any other machine-readable storage medium where, when the program code is loaded into and executed by a machine, such as a computer, the machine becomes an apparatus for practicing the presently disclosed subject matter.

FIG. 2 illustrates an example of a computer environment in which the above described electronic control unit operates. In general, the ECU 30, designated to control sensing and shielding operations as described above, processes signals, whether power signals or data signals, received from and/or provided to the shield circuit 7, the sensor circuit 8, and a heater mat 6. With the appropriate processor 202 and memory 204, the ECU 30 can be configured with computer implemented software to ensure that the circuits in the overall shielding, sensing, and heating systems of this disclosure operate for the purposes described above. In one sense, the ECU 30 may be local to the substrate 190 of this disclosure, and in certain non-limiting embodiments, may include a somewhat basic configuration 206 that is tailored to control only the sensing, shielding, and heating circuits in a substrate installation. This local ECU 30 may also be connected to a more global vehicle control system that implements a plurality of vehicle systems and accessories with more powerful hardware configurations, generally designated as a computerized vehicle data management system 200. It is notable that a vehicle-wide data management system 200 will likely include system memory and processors, but will also incorporate more sophisticated kinds of memory devices 208, 210, multiple I/O connections 212, 214, and a network interface controller 216 for diverse data communications throughout the vehicle. In this regard, the various components of computerized systems utilized for sensing technology herein are selected to transfer data or even power signals between source devices and recipient devices according to various implementations that tailored to the use at hand. In particular, the embodiments of this disclosure may utilize any kind of computer operations capable of network connection, including accessories such as human machine interface systems (e.g., touch pad(s), touch sensitive areas on a display, and/or switches for interfacing with one or more components on a data communications network handling occupant sensing and corresponding user communications).

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### REFERENCES

Attene, M., B. Falcidieno, and M. Spagnuolo (2006). Hierarchical Mesh Segmentation
Based on Fitting Primitives. The Visual Computer 22 (3), 181-193.
Aubry, M., U. Schlickewei, and D. Cremers (2011). The Wave Kernel Signature: A Quan-tum Mechanical Approach to Shape Analysis. In 2011 IEEE International Conference on Computer Vision Workshops (ICCV Workshops), Barcelona, Spain, pp. 1626-1633. IEEE.
Belkin, M. and P. Niyogi (2008). Towards a Theoretical Foundation for Laplacian-based Manifold Methods. Journal of Computer and System Sciences 74 (8), 1289-1308.
Bermano, A. H., T. Funkhouser, and S. Rusinkiewicz (2017). State of the Art in Methods and Representations for Fabrication-Aware Design. Computer Graphics Forum 36 (2), 509-535.
Besl, P. and R. Jain (1988). Segmentation through Variable-Order Surface Fitting. IEEE Transactions on Pattern Analysis and Machine Intelligence 10 (2), 167-192.
Biasotti, S., A. Cerri, A. Bronstein, and M. Bronstein (2016). Recent Trends, Applications, and Perspectives in 3D Shape Similarity Assessment. Computer Graphics Forum 35 (6), 87-119.
Bronstein, M. M., J. Bruna, Y. LeCun, A. Szlam, and P. Vandergheynst (2017). Geometric Deep Learning: Going beyond Euclidean data. IEEE Signal Processing Magazine 34 (4), 18-42.
Bruce, V., A. Coombes, and R. Richards (1993). Describing the Shapes of Faces Using Surface Primitives. Image and Vision Computing 11 (6), 353-363.
Choi, G. P., H. L. Chan, R. Yong, S. Ranjitkar, A. Brook, G. Townsend, K. Chen, and L. M. Lui (2020). Tooth morphometry using quasi-conformal theory. Pattern Recognition 99, 107064.
Crane, K., C. Weischedel, and M. Wardetzky (2013). Geodesics in Heat: A New Approach to Computing Distance Based on Heat Flow. ACM Transactions on Graphics 32 (5), 1-11.
del Castillo, E., B. M. Colosimo, and S. D. Tajbakhsh (2015). Geodesic Gaussian Processes for the Parametric Reconstruction of a Free-Form Surface. Technometrics 57 (1), 87-99.
Do Carmo, M. P. (1976). Differential Geometry of Curves and Surfaces. Prentice-Hall.
Gao, T., S. Z. Kovalsky, D. M. Boyer, and I. Daubechies (2019). Gaussian Process Land-marking for Three-Dimensional Geometric Morphometrics. SIAM Journal on Mathe-matics of Data Science 1 (1), 237-267.
Gatzke, T., C. Grimm, M. Garland, and S. Zelinka (2005). Curvature Maps for Local Shape Comparison. In International Conference on Shape Modeling and Applications 2005 (SMI′ 05), pp. 244-253.
Ge, Q., B. Chen, P. Smith, and C. Menq (1992). Tolerance specification and comparative analysis for computer-integrated dimensional inspection. The International Journal Of Production Research 30 (9), 2173-2197.
Glaunes, J., A. Qiu, M. I. Miller, and L. Younes (2008). Large Deformation Diffeomorphic Metric Curve Mapping. International journal of computer vision 80 (3), 317-336.
Gupta, R. K. and B. Gurumoorthy (2012). Automatic extraction of free-form surface features (FFSFs). Computer-Aided Design 44 (2), 99-112.
Huang, Q., Y. Wang, M. Lyu, and W. Lin (2020). Shape Deviation Generator-A Con-volution Framework for Learning and Predicting 3-D Printing Shape Accuracy. IEEE Transactions on Automation Science and Engineering, 1-15.
Huang, Q., J. Zhang, A. Sabbaghi, and T. Dasgupta (2015). Optimal Offline Compensation of Shape Shrinkage for Three-Dimensional Printing Processes. IIE Transactions 47 (5), 431-441.
Kaiser, A., J. A. Ybanez Zepeda, and T. Boubekeur (2019). A Survey of Simple Geometric Primitives Detection Methods for Captured 3D Data. Computer Graphics Forum 38 (1), 167-196.
Lavielle, M. (2005). Using penalized contrasts for the change-point problem. Signal Pro-cessing 85 (8), 1501-1510.
Lim, L.-H. (2020). Hodge Laplacians on Graphs. SIAM Review 62 (3), 685-715.
Lin, W. and Q. Huang (2023). Automated Deviation-Aware Landmark Selection for Freeform Product Accuracy Qualification in 3D Printing. IISE Transactions 0 (0), 1-10.
Linderman, G. C. and S. Steinerberger (2019). Clustering with t-sne, provably. SIAM journal on mathematics of data science 1 (2), 313-332.
Lipman, Y. and T. Funkhouser (2009). Mobius Voting for Surface Correspondence. ACM Transactions on Graphics 28 (3), 1-12.
Luan, H., M. Grasso, B. M. Colosimo, and Q. Huang (2019). Prescriptive Data-Analytical Modeling of Laser Powder Bed Fusion Processes for Accuracy Improvement. Journal of Manufacturing Science and Engineering 141 (1), 011008.
Luan, H. and Q. Huang (2017). Prescriptive Modeling and Compensation of In-Plane Shape Deformation for 3-D Printed Freeform Products. IEEE Transactions on Automation Science and Engineering 14 (1), 73-82.
Lui, L. M., K. C. Lam, S.-T. Yau, and X. Gu (2014). Teichmuller Mapping (T-Map) and Its Applications to Landmark Matching Registration. SIAM Journal on Imaging Sciences 7 (1), 391-426.
Luo, C., P. Franciosa, D. Ceglarek, Z. Ni, and F. Jia (2018). A Novel Geometric Tolerance Modeling Inspired by Parametric Space Envelope. IEEE Transactions on Automation Science and Engineering 15 (3), 1386-1398.
Maulik, U. and S. Bandyopadhyay (2002). Performance Evaluation of Some Clustering Algorithms and Validity Indices. IEEE Transactions on Pattern Analysis and Machine Intelligence 24 (12), 1650-1654.
Reuter, M., F.-E. Wolter, and N. Peinecke (2006). Laplace-Beltrami spectra as ‘Shape-DNA’ of surfaces and solids. Computer-Aided Design 38 (4), 342-366.
Rodriguez, A. and A. Laio (2014). Clustering by fast search and find of density peaks.
Science 344 (6191), 1492-1496.
Sander, P. V., Z. J. Wood, S. J. Gortler, J. M. Snyder, and H. Hoppe (2003). Multi-Chart Geometry Images. Eurographics Symposium on Geometry Processing, 146-155.
Savio, E., L. De Chiffre, and R. Schmitt (2007). Metrology of freeform shaped parts. CIRP Annals 56 (2), 810-835.
Scimone, R., T. Taormina, B. M. Colosimo, M. Grasso, A. Menafoglio, and P. Secchi (2022). Statistical Modeling and Monitoring of Geometrical Deviations in Complex Shapes With Application to Additive Manufacturing. Technometrics 64 (4), 437-456.
Shah, J. J. and M. M″antyl″a (1995). Parametric and feature-based CAD/CAM: concepts, techniques, and applications. John Wiley & Sons.
Sunil, V. and S. Pande (2008). Automatic recognition of features from freeform surface CAD models. Computer-Aided Design 40 (4), 502-517.
Va′rady, T., R. R. Martin, and J. Cox (1997). Reverse Engineering of Geometric Models—an Introduction. Computer-Aided Design 29 (4), 255-268.
Yan, D.-M., W. Wang, Y. Liu, and Z. Yang (2012). Variational mesh segmentation via quadric surface fitting. Computer-Aided Design 44 (11), 1072-1082.
Ye, Z., N. Umetani, T. Igarashi, and T. Hoffmann (2021). A Curvature and Density-based Generative Representation of Shapes. Computer Graphics Forum 40 (1), 38-53.
Attene, M., Falcidieno, B., and Spagnuolo, M. (2006). Hierarchical mesh segmentation based on fitting primitives. The Visual Computer, 22 (3): 181-193.
Aubry, M., Schlickewei, U., and Cremers, D. (2011). The wave kernel signature: A quan-tum mechanical approach to shape analysis. In 2011 IEEE International Conference on Computer Vision Workshops (ICCV Workshops), pages 1626-1633, Barcelona, Spain. IEEE.
Bermano, A. H., Funkhouser, T., and Rusinkiewicz, S. (2017). State of the Art in Methods and Representations for Fabrication-Aware Design. Computer Graphics Forum, 36 (2): 509-535.
Besl, P. J. and Mckay, N. D. (1992). A method for registration of 3-d shapes. IEEE Transactions on Pattern Analysis and Machine Intelligence, 14 (2): 239-256.
Choi, G. P., Chan, H. L., Yong, R., Ranjitkar, S., Brook, A., Townsend, G., Chen, K., and Lui, L. M. (2020a). Tooth morphometry using quasi-conformal theory. Pattern Recognition, 99:107064.
Choi, G. P. T., Leung-Liu, Y., Gu, X., and Lui, L. M. (2020b). Parallelizable Global Conformal Parameterization of Simply-Connected Surfaces via Partial Welding. SIAM Journal on Imaging Sciences, 13 (3): 1049-1083.
Chui, H. and Rangarajan, A. (2003). A new point matching algorithm for non-rigid regis-tration. Computer Vision and Image Understanding, 89 (2-3): 114-141.
Crane, K., Weischedel, C., and Wardetzky, M. (2013). Geodesics in heat: A new approach to computing distance based on heat flow. ACM Transactions on Graphics, 32 (5): 1-11.
Decker, N., Lyu, M., Wang, Y., and Huang, Q. (2021). Geometric Accuracy Prediction and Improvement for Additive Manufacturing Using Triangular Mesh Shape Data. ASME J. Manuf. Sci. Eng., 143 (6): 061006.
del Castillo, E., Colosimo, B. M., and Tajbakhsh, S. D. (2015). Geodesic Gaussian Processes for the Parametric Reconstruction of a Free-Form Surface. Technometrics, 57 (1): 87-99.
Gao, T., Kovalsky, S. Z., and Daubechies, I. (2019). Gaussian process landmarking on manifolds. SIAM Journal on Mathematics of Data Science, 1 (1): 208-236.
Gardiner, F. P. and Lakic, N. (2000). Quasiconformal Teichmu\ddot{ }ller Theory. Mathematical Surveys and Monographs, v. 76. American Mathematical Society, Providence, R. I.
Gatzke, T., Grimm, C., Garland, M., and Zelinka, S. (2005). Curvature maps for local shape comparison. In International Conference on Shape Modeling and Applications 2005 (SMI′ 05), pages 244-253.
Ge, Q., Chen, B., Smith, P., and Menq, C. (1992). Tolerance specification and comparative analysis for computer-integrated dimensional inspection. The International Journal Of Production Research, 30 (9): 2173-2197.
Ghorbani, H. and Khameneifar, F. (2021). Accurate Registration of Point Clouds of Dam-aged Aeroengine Blades. ASME J. Manuf. Sci. Eng., 143 (3): 031012.
Golovinskiy, A. and Funkhouser, T. (2008). Randomized cuts for 3D mesh analysis. ACM Transactions on Graphics (Proc. SIGGRAPH ASIA), 27 (5): 1-12.
Gu, P. and Huang, X. (1998). Cad-model based inspection of sculptured surfaces with datums. International Journal of Production Research, 36 (5): 1351-1367.
Huang, Q., Zhang, J., Sabbaghi, A., and Dasgupta, T. (2015). Optimal offline compensation of shape shrinkage for three-dimensional printing processes. IIE Transactions, 47 (5): 431-441.
Jin, Y., Pierson, H., and Liao, H. (2019). Scale and pose-invariant feature quality in-spection for freeform geometries in additive manufacturing. ASME J. Manuf. Sci. Eng., 141 (12): 121008.
Kalogerakis, E., Hertzmann, A., and Singh, K. (2010). Learning 3d mesh segmentation and labeling. ACM Trans. Graph., 29 (4): 12.
Lam, K. C. and Lui, L. M. (2014). Landmark- and intensity-based registration with large deformations via quasi-conformal maps. SIAM Journal on Imaging Sciences, 7 (4): 2364-2392.
Li, Y. and Gu, P. (2004). Free-form surface inspection techniques state of the art review. Computer-Aided Design, 36 (13): 1395-1417.
Lin, W. and Huang, Q. (2023). Automated deviation-aware landmark selection for freeform product accuracy qualification in 3d printing. IISE Transactions, pages 1-16.
Lipman, Y. and Funkhouser, T. (2009). Mobius voting for surface correspondence. ACM Transactions on Graphics, 28 (3): 1-12.
Lui, L. M., Lam, K. C., Yau, S. T., and Gu, X. (2014). Teichmuller mapping (T-Map) and its applications to landmark matching registration. SIAM Journal on Imaging Sciences, 7 (1): 391-426.
McConaha, M. and Anand, S. (2020). Additive Manufacturing Distortion Compensation Based on Scan Data of Built Geometry. ASME J. Manuf. Sci. Eng., 142 (6): 061001.
Page, D. L., Koschan, A. F., and Abidi, M. A. (2003). Perception-based 3D triangle mesh segmentation using fast marching watersheds. Proceedings of the IEEE Computer Society Conference on Computer Vision and Pattern Recognition, 2:3-8.
Peyr′e, G. and Cohen, L. D. (2006). Geodesic remeshing using front propagation. Interna-tional Journal of Computer Vision, 69 (1): 145-156.
Rodriguez, A. and Laio, A. (2014). Clustering by fast search and find of density peaks.
Science, 344 (6191): 1492-1496.
Schweinoch, M., Sch\ddot{ }afer, R., Sacharow, A., Biermann, D., and Buchheim, C. (2016). A non-rigid registration method for the efficient analysis of shape deviations in production engineering applications. Production Engineering, 10 (2): 137-146.
Scimone, R., Taormina, T., Colosimo, B. M., Grasso, M., Menafoglio, A., and Secchi,
P. (2022). Statistical Modeling and Monitoring of Geometrical Deviations in Complex Shapes With Application to Additive Manufacturing. Technometrics, 64 (4): 437-456.
Sheffer, A., Praun, E., Rose, K., et al. (2007). Mesh parameterization methods and their applications. Foundations and Trends in Computer Graphics and Vision, 2 (2): 105-171.
Tam, G. K., Cheng, Z. Q., Lai, Y. K., Langbein, F. C., Liu, Y., Marshall, D., Martin, R. R., Sun, X. F., and Rosin, P. L. (2013). Registration of 3d point clouds and meshes: A survey from rigid to Nonrigid. IEEE Trans. Vis. Comput. Graph., 19 (7): 1199-1217.
Theologou, P., Pratikakis, I., and Theoharis, T. (2015). A comprehensive overview of methodologies and performance evaluation frameworks in 3D mesh segmentation. Com-puter Vision and Image Understanding, 135:49-82.
Thiebaut, F., Bendjebla, S., Quinsat, Y., and Lartigue, C. (2018). Nonrigid Registration for Form Defect Identification of Thin Parts. ASME J. Comput. Inf. Sci. Eng., 18 (2): 021012.
Tong, K., Joshi, S., and Amine Lehtihet, E. (2008). Error compensation for fused deposition modeling (fdm) machine by correcting slice files. Rapid Prototyping Journal, 14 (1): 4-14.
Wang, A., Wang, K., and Tsung, F. (2014). Statistical Surface Monitoring by Spatial-Structure Modeling. Journal of Quality Technology, 46 (4): 359-376.
Wang, S., Wang, Y., Jin, M., Gu, X. D., and Samaras, D. (2007). Conformal geometry and its applications on 3d shape matching, recognition, and stitching. IEEE Transactions on Pattern Analysis and Machine Intelligence, 29 (7): 1209-1220.
Wang, Y., Ruiz, C., Park, S., Shin, K.-H., Kim, J.-H., and Huang, Q. (2022). A shape registration methodology for geometric deviation correction in additive manufacturing. In International Manufacturing Science and Engineering Conference, volume 85802, page V001T01A043. American Society of Mechanical Engineers.
Ye, Z., Umetani, N., Igarashi, T., and Hoffmann, T. (2021). A Curvature and Density-based Generative Representation of Shapes. Computer Graphics Forum, 40 (1): 38-53.
Zang, Y. and Qiu, P. (2018). Phase I Monitoring of Spatial Surface Data from 3D Printing.
Technometrics, 60 (2): 169-180.
Zeng, W. and Gu, X. D. (2011). Registration for 3d surfaces with large deformations using quasi-conformal curvature flow. In CVPR 2011, pages 2457-2464.
Zhao, X. and del Castillo, E. (2023). Registration-free localization of defects in three-dimensional parts from mesh metrology data using functional maps. INFORMS Journal on Data Science, pages 1-19.
Agathos, A., Pratikakis, I., Perantonis, S., Sapidis, N. and Azariadis, P. 2007) 3d mesh segmentation methodologies for CAD applications. Computer-Aided Design and Applications, 4 (6), 827-841.
Anwer, N. and Mathieu, L. (2016) From reverse engineering to shape engineering in mechanical design. CIRP Annals, 65 (1), 165-168.
Beg, M. F., Miller, M. I., Trouvle, A. and Younes, L. (2005) Computing large deformation metric mappings via geodesic flows of diffeomor-phisms. International Journal of Computer Vision, 61 (2), 139-157.
Besl, P. J. and Mckay, N. D. (1992) A method for registration of 3-d shapes. IEEE Transactions on Pattern Analysis and Machine Intelligence, 14 (2), 239-256.
Biegler, M., Marko, A., Graf, B. and Rethmeier, M. (2018 December) Finite element analysis of in-situ distortion and bulging for an arbi-trarily curved additive manufacturing directed energy deposition geometry. Additive Manufacturing, 24, 264-272.
Chan, Y. and Walmsley, R. P. (1997) Learning and understanding the Kruskal-Wallis one-way analysis-of-variance-by-ranks test for differ-ences among three or more independent groups. Physical Therapy, 77 (12), 1755-1761.
Choi, G. P., Chan, H. L., Yong, R., Ranjitkar, S., Brook, A., Townsend, G., Chen, K. and Lui, L. M. (2020) Tooth morphometry using quasi-conformal theory. Pattern Recognition, 99, 107064.
Choi, G. P. and Mahadevan, L. (2018) Planar morphometrics using Teichmueller maps. Proceedings of the Royal Society A: Mathematical, Physical and Engineering Sciences, 474 (2217), 20170905.
Colosimo, B. M., Huang, Q., Dasgupta, T. and Tsung, F. (2018) Opportunities and challenges of quality engineering for additive manufacturing. Journal of Quality Technology, 50 (3), 233-252.
Davey, S. J. and Gaetjens, H. X. (2018) Adaptive appearance models. In Track-Before-Detect Using Expectation Maximisation, Springer, Singapore, pp. 171-207.
Ferreira, R.d.S. B., Sabbaghi, A. and Huang, Q. (2019) Automated geo-metric shape deviation modeling for additive manufacturing systems via Bayesian neural networks. IEEE Transactions on Automation
Science and Engineering, 17 (2), 584-598.
Gao, T., Kovalsky, S. Z., Boyer, D. M. and Daubechies, I. (2018) Gaussian process landmarking for three-dimensional geometric mor-phometrics. arXiv, 1 (1), 237-267.
Gao, T., Kovalsky, S. Z. and Daubechies, I. (2019) Gaussian process landmarking on manifolds. SIAM Journal on Mathematics of Data Science, 1 (1), 208-236.
Ge, Q., Chen, B., Smith, P. and Menq, C. (1992) Tolerance specifica-tion and comparative analysis for computer-integrated dimensional inspection. The International Journal of Production Research, 30 (9), 2173-2197.
Geng, Z., Sabbaghi, A. and Bidanda, B. (2023) Reconstructing original design: Process planning for reverse engineering. IISE Transactions, 55 (5), 509-522.
Glaun′es, J., Qiu, A., Miller, M. I. and Younes, L. (2008) Large deform-ation diffeomorphic metric curve mapping. International Journal of Computer Vision, 80 (3), 317-336.
Golovinskiy, A. and Funkhouser, T. (2008 December) Randomized cuts for 3D mesh analysis. ACM Transactions on Graphics (Proc. SIGGRAPH ASIA), 27 (5), 1-12.
Grenander, U. and Miller, M. I. (1998) Computational anatomy: An emerging discipline. Quarterly of Applied Mathematics, 56 (4), 617-694.
Gross, J. and Ligges, U. (2015) nortest: Tests for Normality, R package version 1.0-4. https://CRAN.R-project.org/package=nortest
Gu, P. and Huang, X. (1998) CAD-model based inspection of sculp-tured surfaces with datums. International Journal of Production Research, 36 (5), 1351-1367.
Huang, J., Sun, H., Kwok, T.-H., Zhou, C. and Xu, W. (2020 April) Geometric deep learning for shape correspondence in mass custom-ization by three-dimensional printing. Journal of Manufacturing Science and Engineering, 142 (6), 061003.
Huang, Q., Nouri, H., Xu, K., Chen, Y., Sosina, S. and Dasgupta, T. (2014) Statistical predictive modeling and compensation of geomet-ric deviations of three-dimensional printed products. Journal of Manufacturing Science and Engineering, 136 (6), 061008.
Huang, Q., Zhang, J., Sabbaghi, A. and Dasgupta, T. (2015) Optimal offline compensation of shape shrinkage for three-dimensional printing processes. IIE Transactions, 47 (5), 431-441.
Huang, X., Gu, P. and Zernicke, R. (1996) Localization and comparison of two free-form surfaces. Computer-Aided Design, 28 (12), 1017-1022. Jadayel, M. and Khameneifar, F. (2020) Improving geometric accuracy of 3d printed parts using 3d metrology feedback and mesh morphing. Journal of Manufacturing and Materials Processing, 4 (4), 1-15.
Jin, Y., Pierson, H. and Liao, H. (2019) Scale and pose-invariant feature quality inspection for freeform geometries in additive manufacturing. Journal of Manufacturing Science and Engineering, 141 (12), 121008.
Kalogerakis, E., Averkiou, M., Maji, S. and Chaudhuri, S. (2017) 3d shape segmentation with projective convolutional networks, in Proceedings of the IEEE Conference on Computer Vision and Pattern Recognition, IEEE Press, Piscataway, NJ, pp. 3779-3788.
Kalogerakis, E., Hertzmann, A. and Singh, K. (2010, jul) Learning 3d mesh segmentation and labeling. ACM Transactions on Graphics, 29 (4), 1-12.
Katz, S. and Tal, A. (2003) Hierarchical mesh decomposition using fuzzy clustering and cuts. ACM Transactions on Graphics, 22 (3), 954-961.
Khanzadeh, M., Rao, P., Jafari-Marandi, R., Smith, B. K., Tschopp, M. A. and Bian, L. (2018)
Quantifying geometric accuracy with unsuper-vised machine learning: Using self-organizing map on fused filament fabrication additive manufacturing parts. Journal of Manufacturing Science and Engineering, 140 (3), 031011.
Lavou′e, G. and Wolf, C. (2008) Markov random fields for improving 3d mesh analysis and segmentation, in Proceedings of the 1st Eurographics Conference on 3D Object Retrieval, 3DOR ′08, The Eurographics Association, The Netherlands pp. 25-32.
Li, Y. and Gu, P. (2004) Free-form surface inspection techniques state of the art review. CAD Computer Aided Design, 36 (13), 1395-1417.
Li, Y. and Gu, P. (2005a) Feature-based alignment and comparison between portion and whole of free-form surfaces. CIRP Annals, 54 (1), 135-138.
Li, Y. and Gu, P. (2005b) Inspection of free-form shaped parts.
Robotics and Computer-Integrated Manufacturing, 21 (4-5), 421-430.
Liang, D. and Paisley, J. (2015) Landmarking manifolds with Gaussian processes, in International Conference on Machine Learning, Proceedings of Machine Learning Research, Lille, France, pp. 466-474.
Lin, W., Dai, P. and Huang, Q. (2020) Automatic feature selection for shape registration in additive manufacturing, in IIE Annual Conference. Proceedings, IISE, Norcross, pp. 979-984.
Lipman, Y. and Funkhouser, T. (2009) Moebius voting for surface cor-respondence. ACM Transactions on Graphics, 28 (3), 1-12.
Liu, R. and Zhang, H. (2004) Segmentation of 3d meshes through spec-tral clustering, in 12th Pacific Conference on Computer Graphics and Applications, 2004. PG 2004. Proceedings., IEEE, Seoul, Korea (South), pp. 298-305.
Lu, H. and Yang, F. (2014) Active Shape Model and Its Application to Face Alignment, Springer, Berlin Heidelberg, Germany, pp. 1-31.
Luan, H. and Huang, Q. (2016) Prescriptive modeling and compensation of in-plane shape deformation for 3-d printed freeform products. IEEE Transactions on Automation Science and Engineering, 14 (1), 73-82.
Lui, L. M., Lam, K. C., Yau, S. T. and Gu, X. (2014) Teichmueller mapping (T-Map) and its applications to landmark matching registra-tion. SIAM Journal of Imaging Science, 7 (1), 391-426.
Luo, C., Franciosa, P., Ceglarek, D., Ni, Z. and Jia, F. (2018) A novel geometric tolerance modeling inspired by parametric space envelope. IEEE Transactions on Automation Science and Engineering, 15 (3), 1386-1398.
Mehrad, V., Xue, D. and Gu, P. (2013) Inspection of freeform surfaces considering uncertainties in measurement, localization and surface reconstruction. Measurement Science and Technology, 24 (8), 085008. Moenning, C. and Dodgson, N. A. (2003 April) Fast marching farthest point sampling. Technical Report UCAM-CL-TR-562, University of Cambridge, Computer Laboratory.
Navangul, G., Paul, R. and Anand, S. (2013 June) Error minimization in layered manufacturing parts by stereolithography file modification using a vertex translation algorithm. Journal of Manufacturing Science and Engineering, 135 (3), 031006.
Paul, R., Anand, S. and Gerner, F. (2014 June) Effect of thermal deformation on part errors in metal powder based additive manu-facturing processes. Journal of Manufacturing Science and Engineering, 136 (3), 031009.
Peyr′e, G. and Cohen, L. (2005) Geodesic computations for fast and accurate surface remeshing and parameterization, in Elliptic and
Parabolic Problems: A Special Tribute to the Work of Haim Brezis, BirkhCauser, Basel, Switzerland, pp. 157-171.
Peyr′e, G. and Cohen, L. D. (2006) Geodesic remeshing using front propa-gation. International Journal of Computer Vision, 69 (1), 145-156.
Peyr′e, G. and Cohen, L. D. (2009) Geodesic methods for shape and sur-face processing, in Advances in Computational Vision and Medical Image Processing: Methods and Applications, Springer Netherlands Dordrecht, The Netherlands, pp. 29-56.
Qin, J., Hu, F., Liu, Y., Witherell, P., Wang, C. C., Rosen, D. W., Simpson, T. W., Lu, Y. and Tang, Q. (2022) Research and application of machine learning for additive manufacturing. Additive Manufacturing, 52, 102691.
Rodriguez, A. and Laio, A. (2014) Clustering by fast search and find of density peaks. Science, 344 (6191), 1492-1496.
Romanengo, C., Raffo, A., Qie, Y., Anwer, N. and Falcidieno, B. (2022 February) Fit4CAD: A point cloud benchmark for fitting simple geometric primitives in CAD objects. Computers & Graphics, 102, 133-143. arXiv: 2105.06858 [cs].
Roth, V. (1993) On three-dimensional morphometrics, and on the identification of landmark points. Contributions to Morphometrics. Museo Nacional de Ciencias Naturales, Madrid, pp. 41-61.
Rueckert, D., Frangi, A. and Schnabel, J. (2003) Automatic construction of 3-d statistical deformation models of the brain using nonrigid registra-tion. IEEE Transactions on Medical Imaging, 22 (8), 1014-1025.
Sang, Y., Yan, Y., Yao, C. and He, G. (2021) A new scanning lines dis-tribution strategy for the form error evaluation of freeform surface on CMM. Measurement, 181 (May), 109578.
Scimone, R., Taormina, T., Colosimo, B. M., Grasso, M., Menafoglio, A. and Secchi, P. (2022 October) Statistical modeling and monitoring of geometrical deviations in complex shapes with application to additive manufacturing. Technometrics, 64 (4), 437-456.
Shapira, L., Shamir, A. and Cohen-Or, D. (2008) Consistent mesh par-titioning and skeletonisation using the shape diameter function. Vision Computer, 24 (4), 249.
Sharma, P. and Suji, J. (2016) A review on image segmentation with its clustering techniques. International Journal of Signal Processing, Image Processing and Pattern Recognition, 9 (5), 209-218.
Shmukler, A. and Fischer, A. (2010) Verification of 3d freeform parts by registration of multiscale shape descriptors. The International Journal of Advanced Manufacturing Technology, 49 (9), 1093-1106.
Spitz, S. N. (1999) Dimensional inspection planning for coordinate measuring machines. University of Southern California.
Surazhsky, V., Surazhsky, T., Kirsanov, D., Gortler, S. J. and Hoppe, H. (2005) Fast exact and approximate geodesics on meshes. ACM Transactions on Graphics, 24 (3), 553-560.
Taghizadeh, E., Terrier, A., Becce, F., Farron, A. and Buechler, P. (2019) Automated CT bone segmentation using statistical shape modelling and local template matching. Computer Methods in Biomechanics and Biomedical Engineering, 22 (16), 1303-1310.
Theologou, P., Pratikakis, I. and Theoharis, T. (2015) A comprehensive overview of methodologies and performance evaluation frameworks in 3d mesh segmentation. Computer Vision and Image Understanding, 135, 49-82.
Tong, K., Amine Lehtihet, E. and Joshi, S. (2003) Parametric error modeling and software error compensation for rapid prototyping. Rapid Prototyping Journal, 9 (5), 301-313.
Tong, K., Joshi, S. and Amine Lehtihet, E. (2008) Error compensation for fused deposition modeling (fdm) machine by correcting slice files. Rapid Prototyping Journal, 14 (1), 4-14.
van Kaick, O., Zhang, H., Hamarneh, G. and Cohen-Or, D. (2011) A survey on shape correspondence. Eurographics Symposium on Geometry Processing, 30 (6), 1681-1707.
Woo, H., Kang, E., Wang, S. and Lee, K. H. (2002) A new segmentation method for point cloud data. International Journal of Machine Tools and Manufacture, 42 (2), 167-178.
Xu, K., Kwok, T.-H., Zhao, Z. and Chen, Y. (2017) A reverse compen-sation framework for shape deformation control in additive manu-facturing. Journal of Computing and Information Science in Engineering, 17 (2), 021012.
Yamauchi, H., Lee, S., Lee, Y., Ohtake, Y., Belyaev, A. and Seidel, H.-P. (2005) Feature sensitive mesh segmentation with mean shift, in International Conference on Shape Modeling and Applications 2005 (SMI′05), IEEE Press, Piscataway, NJ, pp. 236-243.
Yang, Y., McGregor, D. J., Tawfick, S., King, W. P. and Shao, C. (2022 March) Hierarchical data models improve the accuracy of feature level predictions for additively manufactured parts.
Additive Manufacturing, 51, 102621.
Zelditch, M. L., Swiderski, D. L. and Sheets, H. D. (2012) Geometric Morphometrics for Biologists: A Primer, Academic Press, Cambridge, Massachusetts.
Zeng, W. and Gu, X. D. (2011) Registration for 3d surfaces with large deformations using quasi-conformal curvature flow, in CVPR 2011, IEEE, Colorado Springs, CO, USA, pp. 2457-2464.
Zeng, Y., Wang, C., Wang, Y., Gu, X., Samaras, D. and Paragios, N. (2010 June) Dense non-rigid surface registration using high-order graph matching, in 2010 IEEE Computer Society Conference on Computer Vision and Pattern Recognition, IEEE Press, Piscataway, NJ, pp. 382-389.
Zhang, A., Qi, B., Shi, B. and Li, D. (2015 July) Effect of curvature radius on the residual stress of thin-walled parts in laser direct forming. The International Journal of Advanced Manufacturing Technology, 79 (1-4), 81-88.
Zhu, Z., Anwer, N., Huang, Q. and Mathieu, L. (2018) Machine learn-ing in tolerancing for additive manufacturing. CIRP Annals, 67 (1), 157-160. Zang, Y. and P. Qiu (2018). Phase I Monitoring of Spatial Surface Data from 3D Printing.
Technometrics 60 (2), 169-180.
Zhang, X., J. Wang, K. Yamazaki, and M. Mori (2004). A Surface Based Approach to Recognition of Geometric Features for Quality Freeform Surface Machining. Computer-Aided Design 36 (8), 735-744.
Zhao, X. and E. del Castillo (2021). An Intrinsic Geometrical Approach for Statistical Process Control of Surface and Manifold Data. Technometrics 63 (3), 295-312.

1. A computer implemented method of assessing accuracy of a three-dimensional (3D) print from a design file representing the 3D print, the method comprising:
identifying geometric feature correspondences between the 3D print and the design file by utilizing a computer with a processor to implement software steps comprising:
representing the 3D print and the design file in a respective actual print digital mesh and a design digital mesh;
parsing the design digital mesh into respective sets of tentative segments having tentative boundaries;
determining respective centers of the tentative segments;
defining the tentative boundaries of the tentative segments to incorporate respective regions of high curvature along surfaces of the respective meshes, wherein the tentative boundaries meet a density threshold of vertices on the surface;
defining design segments by modifying the tentative boundaries to encompass circular boundaries with a geodesic radius that minimizes a sum of distances between points within the tentative boundaries to a respective center of a respective tentative segment;
locating corresponding segments in the actual print digital mesh and defining print boundaries with the geodesic radius from the circular boundaries; and
calculating diffeomorphisms between the design segments and the corresponding segments on the actual print digital mesh to complete non-rigid registration between the actual print digital mesh and the design digital mesh; and
identifying deviations between the digital meshes by calculating a dissimilarity metric between the meshes.

2. The method of claim 1, further comprising pre-aligning the actual print digital mesh and the design digital mesh before parsing the design digital mesh.

3. The method of claim 1, further comprising determining tentative segments by clustering vertices according to a concentration of the vertices on the mesh.

4. The method of claim 1, wherein modifying the tentative boundaries comprises allowing overlapping of the circular boundaries.

5. The method of claim 1, wherein determining regions of high curvature comprises a curvature-sensitive remeshing to determine total curvature of a segment.

6. method of claim 5, wherein the total curvature is calculated on a triangle mesh.

7. The method of claim 1, wherein locating corresponding segments in the actual print digital mesh comprises comparing segments from the design digital mesh with the actual print digital mesh according to wave kernel signature comparison.

8. The method of claim 7, further comprising computing the respective signatures of the meshes by calculating a curvature signature formed by averaging a Gaussian curvature and mean curvature.

9. The method of claim 1, wherein calculating the diffeomorphism comprises utilizing an intrinsic registration process comprising steps including converting the respective actual print digital mesh and a design digital mesh to canonical 2D domains.

10. The method of claim 9, further comprising calculating the diffeomorphism with conformal mapping to achieve surface parameterization of the meshes.

11. The method of claim 10, wherein the conformal mapping further comprises iteratively minimizing at least one of area, distance, or angles between the meshes and the 2D domains.

12. The method of claim 1, wherein calculating the diffeomorphism comprises applying landmark constraints to the non-rigid registration.

13. The method of claim 12, wherein assessing accuracy between the three-dimensional (3D) print and the design file representing the 3D print comprises iteratively calculating the diffeomorphism with the landmark constraints to form a Teichmuiller map (T-map).

14. The method of claim 13, wherein the T-map comprises conformality distortion represented by a Beltrami coefficient calculated for the T-map.

15. The method of claim 12, wherein identifying the regions of high curvature comprises identifying local maxima of vertex density with the highest dispersion of vertices.

16. The method of claim 1, wherein defining the tentative boundaries of the tentative segments comprises assigning respective vertices of the design digital mesh to a cluster of vertices having the shortest geodesic distance from the center of the respective tentative boundary.

17. The method of claim 12, wherein identifying landmark constraints comprises compiling a covariance matrix of a feature vector having elements representing vectors of density characteristics of incremental clusters of vertices.

18. The method of claim 17, wherein the density characteristics comprise rho and delta, wherein rho is defined as the number of vertices within a fixed cut-off geodesic distance from a cluster center to a given vertex and delta is defined as a radius within which the given vertex maximizes a vertex density within a tentative segment.

19. The method of claim 12, wherein identifying the landmark constraints comprises iteratively identifying the landmark constraints until a variability value among density characteristics meets a threshold value to stop incrementing the iterative process calculating the diffeomorphism with the landmark constraints to form a Teichmuiller map (T-map).

20. A computer implemented method of electronically modeling a surface of an object with a plurality of virtual surface patches, the method comprising:
assigning to the object a plurality of geometric descriptors implemented in software stored in memory of a computer, by which the computer evaluates smoothness of respective groups of surface points on a surface of the object;
using a processor having access to the memory of the computer to identify the respective groups of surface points as bounded surface patches by performing steps comprising:
identifying critical points across the surface of the object as local extremes of curvature on the surface;
using the critical points as geometric centers of potential surface patches to be evaluated by the software;
adding new surface points to a respective potential surface patch by evaluating neighboring surface points relative to a respective geometric center;
continuing to add the new surface points to the respective potential surface patch until neighboring surface points indicate changes in smoothness according to the geometric descriptors, wherein the changes in smoothness define corresponding perimeters of the bounded surface patches; and
iteratively evaluating the groups of surface points for potential surface patches until the the object has been modeled with bounded surface patches.
